(19) United States
(12) Patent Application Publication
(10) Pub. No.: US 2026/0253612 A1
(43) Pub. Date: Aug. 27, 2026

(54) MAGNETIC RECORDING MEDIUM

(71) Applicant: Sony Group Corporation, Tokyo (JP)

(72) Inventors: Minoru YAMAGA, Tokyo (JP); Takahiro TAKAYAMA, Tokyo (JP); Hiroshi MORITA, Tokyo (JP)

(21) Appl. No.: 18/875,867

(22) PCT Filed: Aug. 31, 2023
(86) PCT No.: PCT/JP2023/031765

§ 371 Date: Dec. 17, 2024

(30) Foreign Application Priority Data
Sep. 14, 2022 (JP) 2022-146082

(51) Int. Cl. G11B 5/706; G11B 5/592; G11B 5/714; G11B 5/78

(52) U.S. Cl. CPC G11B 5/70678; G11B 5/5928; G11B 5/714; G11B 5/78

(57) ABSTRACT

Provided are a magnetic recording medium and a magnetic recording cartridge. An average thickness of the magnetic recording medium t_{T} is t_{T}≤5.3 μm, and a width of the magnetic recording medium is stabilized in 24 minutes or less a temperature of 60° C. after a change of a humidity from 10% RH to 40% RH at. The magnetic recording cartridge includes the magnetic recording medium, a memory and a case that accommodates the magnetic recording medium and the memory.

### CROSS REFERENCE TO RELATED APPLICATIONS

This application claims the benefit of Japanese Priority Patent Application JP 2022-146082 filed on Sep. 14, 2022, the entire contents of which are incorporated herein by reference.

### TECHNICAL FIELD

The present technology relates to a magnetic recording medium.

### BACKGROUND ART

In recent years, magnetic recording media have been widely used for applications such as backup of electronic data and the like. As one of the magnetic recording media, for example, a magnetic tape cartridge can be stored in a large capacity for a long period of time, and thus has been attracting more attention as a storage medium for big data or the like.

In order to improve a recording density of data, in a magnetic tape, a total thickness of the magnetic tape is extremely thin, and a data recording track width is extremely narrow. As described above, when the total thickness is extremely thin and the data recording track width becomes narrower, for example, the maximum acceptable variation as a variation in the magnetic tape in a width direction due to environmental factors such as changes in temperature and humidity, and the like becomes smaller.

Several technologies for reducing the variation in the magnetic tape in the width direction have been proposed so far. For example, in a magnetic tape disclosed in PTL 1 below, when a Young's modulus of a non-magnetic support in a width direction is represented by X and a Young's modulus of a back layer in the width direction is represented by Y, X×Y is 6×10⁵ or more in a case where X is 850 kg/mm² or more or less than 850 kg/mm², and when a Young's modulus of a layer including a magnetic layer in a width direction is represented by Z, Y/Z is 6.0 or less.

Furthermore, several technologies for adjusting a recording and reproducing apparatus to cope with the change in the magnetic tape in the width direction have been proposed so far. For example, PTL 2 below proposes a technology in which, in a recording and reproducing apparatus, positioning (tracking) control of a recording and reproducing head with respect to each recording track is executed, and regarding a servo band in which a servo pattern having a predetermined shape in which servo band identification information for specifying tape information or a data band is embedded is recorded, tension applied during running of a magnetic tape is changed in order to cope with a change in intervals (servo band pitches) between adjacent servo bands. In the technology proposed in PTL 2, initial width information of a magnetic tape as a reference is stored in a memory, and tension applied to the magnetic tape is changed on the basis of the initial width information of the magnetic tape during reproduction. Furthermore, PTL 3 below proposes a technology in which a data write head of a recording and reproducing apparatus is arranged so as to be inclined with respect to a width direction of a magnetic tape.

### CITATION LIST

### Patent Literature

PTL 1: JP 2005-332510A
PTL 2: JP 2005-285268A
PTL 3: JP 2005-259198A

### SUMMARY

### Technical Problem

However, when data is recorded or reproduced by the recording and reproducing apparatus, a width of the magnetic tape at the start of running of the magnetic tape is deformed by tension or winding pressure in a longitudinal direction of the magnetic tape, and it takes time to stabilize a change in the width direction. Therefore, there is a problem that a time to store the initial magnetic tape width information as a reference in the memory is delayed due to the time needed for stabilization of the width of the magnetic tape.

In view of the above circumstances, an object of the present technology is to provide a magnetic recording medium capable of shortening a time for determining a width of the magnetic recording medium at the beginning of use of the magnetic recording medium and making the width of the magnetic recording medium at the beginning of use clear.

### Solution to Problem

According to an embodiment of the present technology, a magnetic recording medium is provided. An average thickness of the magnetic recording medium t_{T} is t_{T}≤5.3 μm, and a width of the magnetic recording medium is stabilized in 24 minutes or less after a change of a humidity from 10% RH to 40% RH at a temperature of 60° C.

According to another embodiment of the present technology, a magnetic recording cartridge is provided.

The magnetic recording cartridge includes a magnetic recording medium, a memory, and a case that accommodates the magnetic recording medium and the memory. An average thickness of the magnetic recording medium t_{T} is t_{T}≤5.3 μm, and a width of the magnetic recording medium is stabilized in 24 minutes or less at a temperature of 60° C. after a change of a humidity from 10% RH to 40% RH.

### BRIEF DESCRIPTION OF DRAWINGS

FIG. 1 is a cross-sectional view illustrating a configuration of a magnetic recording medium according to a first embodiment.

FIG. 2 is a schematic view of the magnetic recording medium according to the first embodiment as viewed from above (magnetic layer side).

FIG. 3 is an enlarged view illustrating recording tracks in a data band of the magnetic recording medium according to the first embodiment.

FIG. 4 is an enlarged view illustrating a part of a servo pattern written in a servo band of the magnetic recording medium according to the first embodiment.

FIG. 5A is a perspective view illustrating a configuration of a measurement apparatus for a variation in width of the magnetic recording medium.

FIG. 5B is a schematic view illustrating a detail of the measurement apparatus for a variation in width of the magnetic recording medium.

FIG. 6 is a view illustrating setting states of temperature and humidity in width variation measurement.

FIG. 7 is a view illustrating a relationship between a measurement time and a width of a sample 10S in a case where a relative humidity is increased from 10% RH % RH to 40% RH % RH while the temperature is maintained at 10° C.

FIG. 8 is a view obtained by enlarging a dotted line portion of FIG. 7.

FIG. 9 is a view obtained by further enlarging the dotted line portion of FIG. 7.

FIG. 10 is a schematic view illustrating a configuration of an example of a recording and reproducing apparatus.

FIG. 11 is a schematic view of a drive head in the recording and reproducing apparatus described above as viewed from below (tape running surface).

FIG. 12 is a view illustrating a state when a first drive head part in the drive head described above performs recording and reproducing of a data signal.

FIGS. 13A and 13B are a schematic plan view illustrating an arrangement example of servo patterns and a view illustrating a reproduction waveform thereof, respectively.

FIGS. 14A and 14B are schematic views illustrating configuration examples of a servo pattern in which first servo band identification information is embedded and a servo pattern in which second servo band identification information is embedded, respectively.

FIGS. 15A and 15B are views illustrating a reproduction waveform of a first servo pattern and a reproduction waveform of a second servo pattern, respectively.

FIG. 16 is an explanatory view in which the drive head tracks the data band.

FIG. 17 is a view for explaining a method of measuring a servo trace line.

FIG. 18 is a schematic front view illustrating a servo pattern recording apparatus according to an embodiment of the present technology.

FIG. 19 is a partially enlarged view of a part of the servo pattern recording apparatus described above.

FIG. 20 is a perspective view schematically illustrating a configuration of a servo write head in the servo pattern recording apparatus described above.

FIG. 21 is a schematic cross-sectional view of a main part of the servo write head described above.

FIG. 22 is a schematic plan view of the main part of the servo write head described above.

FIG. 23 is a block diagram illustrating a configuration of a drive unit in the servo pattern recording apparatus described above.

FIGS. 24A and 24B are schematic views illustrating a recording signal waveform (A) of a first servo sub-frame in a first pulse signal and a recording signal waveform (B) of the first servo sub-frame in a second pulse signal, respectively.

FIG. 25 is a schematic view illustrating a configuration of another example of a recording and reproducing apparatus.

FIG. 26 is a schematic view of a data write head as viewed from below (back layer side).

FIG. 27 is a view illustrating a relationship between an angular range Refθ±x° of an azimuth angle and an azimuth loss Lθ of the data write head (recording wavelength: 0.1 μm).

FIG. 28 is a view illustrating a relationship between an angular range Refθ±x° at an azimuth angle θ of the data write head and a correction amount with respect to a servo band pitch difference based on a variation in width of a magnetic recording medium 501.

FIG. 29 is a view illustrating a correction amount with respect to a servo band pitch difference based on a variation in width of the magnetic recording medium.

FIG. 30 is a view illustrating a relationship between an angular range Refθ±x° of an azimuth angle θ and an azimuth loss Lθ of the data write head (recording wavelength: 0.07 μm).

FIG. 31 is a view illustrating the servo pattern recording apparatus according to the first embodiment of the present technology.

FIG. 32 is a view illustrating a servo write head and pulse signals input to the servo write head according a first example.

FIG. 33 is an enlarged view of a servo element included in the servo write head according to the first example.

FIG. 34 is a view illustrating a state when servo patterns are written on a magnetic recording medium by the servo write head according to the first example.

FIG. 35 is an enlarged view of a servo write head and a servo element included in the servo write head according to a second example.

FIG. 36 is a view illustrating a state when servo patterns are written on a magnetic tape by the servo write head according to the second example.

FIG. 37 is a view illustrating the servo write head based on a coordinate system of the servo write head in the second example.

FIG. 38 is a view illustrating a state when low fraction processing is performed on a facing surface of the servo write head.

FIG. 39 is an enlarged view of the view of the right side of FIG. 35, and is a view illustrating an example of specific dimensions of a first servo element and a second servo element (based on an XYZ coordinate system).

FIG. 40 is an enlarged view of the view of the right side of FIG. 37, and illustrates an example of specific dimensions of the first servo element and the second servo element (based on an X″Y″Z″ coordinate system).

FIG. 41 is a cross-sectional view illustrating a configuration of a magnetic recording medium in a modified example.

FIG. 42 is a cross-sectional view illustrating a configuration of a magnetic recording medium according to a second embodiment.

FIG. 43 is a schematic view illustrating a configuration of a sputtering apparatus.

FIG. 44 is a cross-sectional view illustrating a configuration of a magnetic recording medium according to a third embodiment.

FIG. 45 is an exploded perspective view illustrating an example of a configuration of a magnetic recording cartridge.

FIG. 46 is an exploded perspective view illustrating an example of a configuration of a magnetic recording cartridge of a modified example.

FIG. 47 is a view illustrating a variation in servo track width of a magnetic recording medium in which in a temperature environment of 60° C., when humidity is increased from 10% RH % RH to 40% RH % RH, a time until a width of the magnetic recording medium is stabilized is within 24 minutes.

### DESCRIPTION OF EMBODIMENTS

Hereinafter, preferred modes for implementing the present technology will be described. Note that embodiments described below illustrate representative embodiments of the present technology, and the scope of the present technology is not limited only to these embodiments.

The present technology will be described in the following order.
1. Description of Present Technology
2. First Embodiment (Example of Coating Type Magnetic Recording Medium)
(1) Configuration of Magnetic Recording Medium
(2) Description of Each Layer
(3) Physical Properties and Structure
(4) Method of Manufacturing Magnetic Recording Medium
(5) Example of Recording and Reproducing Apparatus
(6) Example of Servo Pattern Recording Apparatus
(7) Other Examples of Recording and Reproducing Apparatus
(8) Other Examples of Servo Pattern Recording Apparatus
(9) Modified Example
3. Second Embodiment (Example of Vacuum Thin Film Type Magnetic Recording Medium)
(1) Configuration of Magnetic Recording Medium
(2) Description of Each Layer
(3) Physical Properties and Structure
(4) Configuration of Sputtering Apparatus
(5) Method of Manufacturing Magnetic Recording Medium
(6) Modified Example
4. Third Embodiment (Example of Vacuum Thin Film Type Magnetic Recording Medium)
(1) Configuration of Magnetic Recording Medium
(2) Description of Each Layer
5. Embodiment of Magnetic Recording Cartridge According to Present Technology
6. Modified Example of Magnetic Recording Cartridge According to Present Technology
7. Example

### 1. Description of Present Technology

A next-generation magnetic recording tape requiring a high recording density is extremely thin, and it becomes very difficult to stabilize a width dimension of the magnetic recording tape against environmental changes in temperature and humidity. Therefore, the change in width dimension is adjusted by inputting initial width information of the magnetic recording tape at the beginning of use into a memory of a recording and reproducing apparatus, and controlling a tension of the magnetic recording tape in a longitudinal direction when the magnetic recording tape is caused to run in the recording and reproducing apparatus (in a drive) with reference to the width information of the magnetic recording tape during reproduction.

However, when data is recorded or reproduced by the recording and reproducing apparatus, an initial width of the magnetic recording tape at the start of running of the magnetic recording tape is deformed by tension or winding pressure in a longitudinal direction of the magnetic recording tape, and it takes time to stabilize a change in width direction. Therefore, there is a problem that a time to store the initial width information of the magnetic recording tape as a reference in the memory is delayed.

The present inventors have found that a speed of following a change in humidity of the magnetic recording medium is increased under a predetermined temperature environment, such that a change in width of the magnetic recording medium when the magnetic recording tape starts to run can be reduced, and the width of the magnetic recording medium can be determined in a short time.

That is, in a magnetic recording medium according to the present technology, in a temperature environment of 60° C., when humidity is increased from 10% RH % RH to 40% RH % RH, a time until a width of the magnetic recording medium is stabilized is within 24 minutes, and can be preferably within 22 minutes, more preferably within 20 minutes, and still more preferably within 18 minutes. By keeping the time until the width of the magnetic recording medium is stabilized within the numerical range described above, the width of the magnetic recording medium can be determined in a short time.

Furthermore, in the magnetic recording medium according to the present technology, in a temperature environment of 35° C., when the humidity is increased from 10% RH % RH to 40% RH % RH, the time until the width of the magnetic recording medium is stabilized is within 24 minutes, and can be preferably within 10 minutes, more preferably within 9 minutes, and still more preferably within 8 minutes.

Moreover, in the magnetic recording medium according to the present technology, in a temperature environment of 10° C., when the humidity is increased from 10% RH % RH to 40% RH % RH, the time until the width of the magnetic recording medium is stabilized is within 24 minutes, and can be preferably within 9 minutes, more preferably within 8 minutes, and still more preferably within 7 minutes. A method of measuring the time until the width of the magnetic recording medium is stabilized under each temperature environment will be described in (3) of 2 below.

In the magnetic recording medium according to the present technology, in the temperature environment of 60° C., a variation in width ΔW of the magnetic recording medium is preferably 680 ppm or more, and can be more preferably 700 ppm or more, and still more preferably 720 ppm or more. When the variation in width ΔW is within the range of 680 ppm or more, the variation in width due to the tension of the magnetic recording medium can be increased, and the change in width due to the environment can be followed. A method of measuring the variation in width ΔW will be described in (3) of 2 below.

The magnetic recording medium according to the present technology is preferably an elongated magnetic recording medium, and can be, for example, a magnetic recording tape (particularly an elongated magnetic recording tape).

The magnetic recording medium according to the present technology may include a magnetic layer, a non-magnetic layer, a base layer, and a back layer in this order, and may include other layers in addition to these layers. The other layers may be appropriately selected according to the type of the magnetic recording medium. The magnetic recording medium may be, for example, a coating type magnetic recording medium or a vacuum thin film type magnetic recording medium. The coating type magnetic recording medium will be described in more detail in 2. below. The vacuum thin film type magnetic recording medium will be described in more detail in 3. below. For the layers included in the magnetic recording medium other than the four layers described above, these descriptions may be referred to.

An average thickness (average total thickness) of the magnetic recording medium according to the present technology is 5.3 μm or less, and can be preferably 5.1 μm or less, more preferably 4.9 μm or less, and still more preferably 4.6 μm or less. Since the magnetic recording medium is thin as described above, for example, a length of the magnetic recording medium (tape) wound in one magnetic recording cartridge can be made longer, and therefore, a recording capacity per magnetic recording cartridge can be increased. A lower limit value of a thickness t_{T} of the magnetic recording medium is not particularly limited, but is, for example, 3.5 μm≤t_{T}. A method of measuring the average thickness (average total thickness) will be described in (3) of 2 below.

A thickness of the non-magnetic layer of the magnetic recording medium according to the present technology can be preferably 1.2 μm or less, more preferably 0.9 μm or less, and still more preferably 0.6 μm or less. Furthermore, a lower limit value of the thickness of the non-magnetic layer is not particularly limited, but can be preferably 0.3 μm or more.

A method of measuring thickness of the non-magnetic layer will be described in (3) of 2 below.

A thickness of the base layer of the magnetic recording medium according to the present technology can be preferably 4.4 μm or less, more preferably 4.2 μm or less, and still more preferably 4.0 μm or less. A lower limit value of the thickness of the base layer is not particularly limited, but can be preferably 3 μm or more. A method of measuring thickness of the base layer will be described in (3) of 2 below.

A thickness of the back layer of the magnetic recording medium according to the present technology can be preferably 0.6 μm or less, more preferably 0.5 μm or less, and still more preferably 0.4 μm or less. A lower limit value of the thickness of the back layer is not particularly limited, but can be preferably 0.2 μm or more. A method of measuring thickness of the back layer will be described in (3) of 2 below.

### 2. First Embodiment (Example of Coating Type Magnetic Recording Medium)

### (1) Configuration of Magnetic Recording Medium

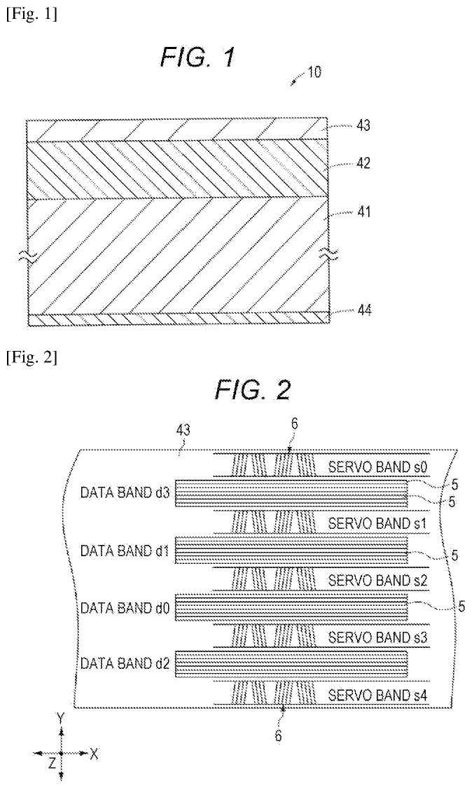

First, a configuration of a magnetic recording medium 10 according to a first embodiment will be described with reference to FIGS. 1 and 2. FIG. 1 is a cross-sectional view illustrating the configuration of the magnetic recording medium according to the first embodiment. The magnetic recording medium 10 is, for example, a magnetic recording medium subjected to vertical orientation processing, and includes an elongated base layer (also referred to as a substrate) 41, an underlayer (non-magnetic layer) 42 provided on one principal plane of the base layer 41, a magnetic layer (also referred to as a recording layer) 43 provided on the underlayer 42, and a back layer 44 provided on the other principal plane of the base layer 41 as illustrated in FIG. 1. Hereinafter, among the both principal planes of the magnetic recording medium 10, the plane on which the magnetic layer 43 is provided will be referred to as a magnetic surface, and the plane opposite to the magnetic surface (the plane on which the back layer 44 is provided) will be referred to as a back surface.

The magnetic recording medium 10 has an elongated shape and runs in a longitudinal direction during recording and reproducing. Furthermore, the magnetic recording medium 10 may be configured to be able to record a signal at the shortest recording wavelength of preferably 100 nm or less, more preferably 75 nm or less, still more preferably 60 nm or less, and particularly preferably 50 nm or less, and may be used for, for example, a recording and reproducing apparatus whose shortest recording wavelength is in the range described above. The recording and reproducing apparatus may include a ring type head as a recording head. A recording track width is, for example, 2 μm or less.

FIG. 2 is a schematic view of the magnetic recording medium according to the first embodiment as viewed from above (magnetic layer side). As illustrated in FIG. 2, the magnetic layer 43 has a plurality of data bands d (data bands d0 to d3) elongated in a longitudinal direction (X-axis direction) in which data is written and a plurality of servo bands s (servo bands s0 to s4) elongated in a longitudinal direction in which a servo pattern 6 is written. The servo bands s are arranged at positions at which each data band d is interposed therebetween in a width direction (Y-axis direction).

In the present technology, a ratio of an area of the servo bands s to an area of the entire surface of the magnetic layer 43 is typically 4.0% or less. Note that a width of the servo band s is a tape width of ½ inches, and is, for example, 96 μm or less. The ratio of the area of the servo bands s to the area of the entire surface of the magnetic layer 43 can be measured, for example, by developing the magnetic recording medium 10 using a developer such as a ferricolloid developer or the like, and then observing the developed magnetic recording medium 10 with an optical microscope.

In the example illustrated in FIG. 2, an example in a case where the number of data bands d is four and the number of servo bands s is five is shown. Note that the number of data bands d and the number of servo bands s can be appropriately changed.

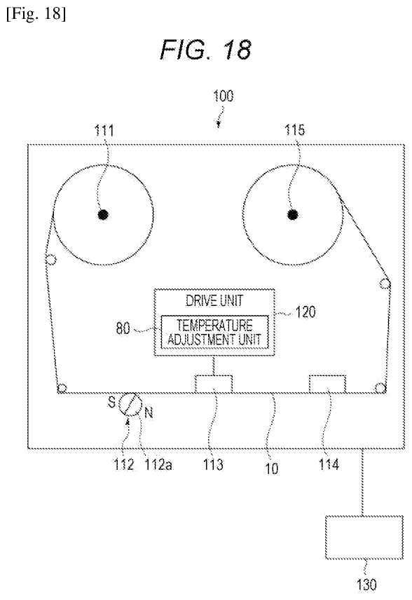

The data band d is long in the longitudinal direction and includes a plurality of recording tracks 5 aligned in the width direction. The number of recording tracks 5 included in one data band d is, for example, about 1,000 to 2,500. The data is recorded in the recording track 5 along the recording track 5. A 1-bit length of the data recorded in the data band d in the longitudinal direction is, for example, 48 nm or less. The servo band s includes a servo pattern 6 having a predetermined shape to be recorded by a servo pattern recording apparatus (see FIG. 18) as described later.

Here, in the magnetic recording medium 10 of the linear tape-open (LTO) standard, the number of recording tracks 5 is increased for each generation, and the recording capacity is dramatically improved. As an example, the number of recording tracks 5 is 384 in the primary LTO-1, and the numbers of recording tracks 5 are 512, 704, 896, 1,280, 2,176, 3,584, and 6,656 in order from LTO-2 to LTO-8, respectively. Similarly, the data recording capacity is 100 gigabyte (GB) in LTO-1, and the data recording capacities are 200 GB, 400 GB, 800 GB, 1.5 terabyte (TB), 2.5 TB, 6.0 TB, and 12 TB in order from LTO-2 to LTO-8, respectively.

In the present embodiment, the number of recording tracks 5 and the recording capacity are not particularly limited, and can be appropriately changed. However, for example, it is advantageous to apply the present technology to the magnetic recording medium 10 that has the number of recording tracks 5 and the recording capacity are large (for example, 6,656 or more, 12 TB or more: LTO8 or later) and is susceptible to the influence of the variation in width of the magnetic recording medium 10. For example, a magnetic tape in which a Young's modulus (Young's modulus in a tape longitudinal direction) of the entire tape is 8 GPa or less is applied as the magnetic recording medium 10.

### (Data Band and Servo Band)

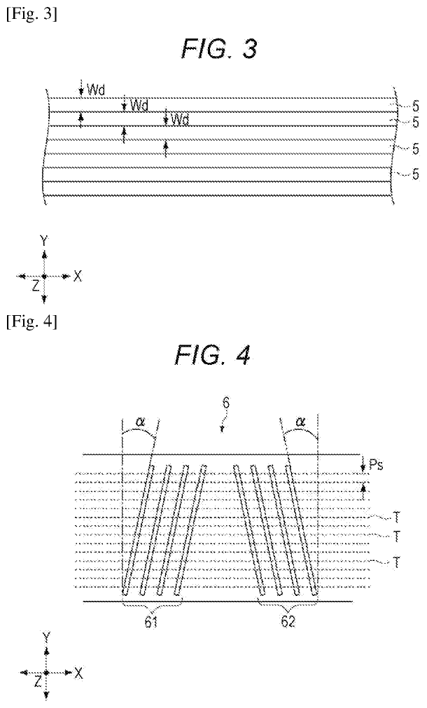

FIG. 3 is an enlarged view illustrating the recording tracks 5 in the data band d. As illustrated in FIG. 3, the recording track 5 is elongated in the longitudinal direction, is aligned in the width direction, and furthermore, has a predetermined data recording track width (track pitch) Wd for each track in the width direction. The data recording track width Wd may be 2.0 μm or less, and preferably 1,000 nm or less, in LTO-8. Note that such a data recording track width Wd can be measured, for example, by observing the magnetic recording medium 10 on which data is recorded using a magnetic force microscope (MFM). Alternatively, as a measurement method using the drive head, the data recording track width Wd can be measured from an output change in a case where the drive head is set to the Read While Write (reproduction at the time of recording) state and Azimuth of the drive head is changed in order to ignore the fluctuation during running of the tape. (IEEE_Sept1996_Crosstrack Profiles of Thin Film MR Tape Heads Using the Azimuth Displacement Method)

FIG. 4 is an enlarged view illustrating a part of the servo pattern 6 written in the servo band s. As illustrated in FIG. 4, the servo pattern 6 includes a plurality of stripes inclined at a predetermined azimuth angle α with respect to the width direction (Y-axis direction), which will be described later in detail. In the present embodiment, for example, the azimuth angle α may be preferably 5 to 20°. The plurality of stripes are classified into a first stripe group 61 inclined clockwise with respect to the width direction (Y-axis direction) and a second stripe group 62 inclined counterclockwise with respect to the width direction. The first stripe group 61 and the second stripe group 62 typically include four or five stripes. Note that the shape and the like of the servo pattern 6 can be measured by, for example, developing the magnetic layer 43 of the magnetic recording medium 10 using a developer such as a ferricolloid developer, and then observing the developed magnetic layer 43 of the magnetic recording medium 10 with an optical microscope.

In FIG. 4, a servo trace line T which is a line traced by a servo read head 132 (see FIG. 7) as described later on the servo pattern 6 is indicated by a broken line. The servo trace line T is set in the longitudinal direction (X-axis direction) and is set at a predetermined interval Ps in the width direction.

The number of servo trace lines T per servo band s is, for example, about 30 to 60. An interval Ps between two adjacent servo trace lines T is the same as a value of the data recording track width Wd, and is, for example, 2.0 μm or less. Here, the interval Ps between the two adjacent servo trace lines T is a value that determines the data recording track width Wd. That is, when the interval Ps between the servo trace lines T is narrowed, the data recording track width Wd is decreased, and the number of recording tracks 5 included in one data band d is increased. As a result, the data recording capacity is increased.

### (2) Description of Each Layer

### (Base Layer)

The base layer 41 can function as a support of the magnetic recording medium 10, and is, for example, an elongated flexible non-magnetic substrate, and particularly, can be a non-magnetic film. The thickness of the base layer 41 can be, for example, preferably 4.5 μm or less, more preferably 4.2 μm or less, and still more preferably 3.6 μm or less. Note that a lower limit of the thickness of the base layer 41 may be determined, for example, from the viewpoint of a limit of film formation, a function of the base layer 41, or the like. The base layer 41 can contain, for example, at least one of a polyester-based resin, a polyolefin-based resin, a cellulose derivative, a vinyl-based resin, an aromatic polyetherketone resin, or other polymer resins. In a case where the base layer 41 contains two or more of the materials described above, the two or more materials may be mixed, copolymerized, or laminated.

As the polyester-based resin, for example, one or a mixture of two or more of polyethylene terephthalate (PET), polyethylene naphthalate (PEN), polybutylene terephthalate (PBT), polybutylene naphthalate (PBN), polycyclohexylenedimethylene terephthalate (PCT), polyethylene-p-oxybenzoate (PEB), and polyethylenebisphenoxy-carboxylate may be used. According to a preferred embodiment of the present technology, the base layer 41 may include PET or PEN.

The polyolefin-based resin may be, for example, one or a mixture of two or more of polyethylene (PE) and polypropylene (PP).

The cellulose derivative may be, for example, one or a mixture of two or more of cellulose diacetate, cellulose triacetate, cellulose acetate butyrate (CAB), and cellulose acetate propionate (CAP).

The vinyl-based resin may be, for example, one or a mixture of two or more of polyvinyl chloride (PVC) and polyvinylidene chloride (PVDC).

The aromatic polyether ketone resin may be, for example, one or a mixture of two or more of polyether ketone (PEK), polyether ether ketone (PEEK), polyether ketone ketone (PEKK), and polyether ether ketone ketone (PEEKK). According to a preferred embodiment of the present technology, the base layer 41 may include PEEK.

Examples of the other polymer resins may be, for example, one or a mixture of two or more of polyamide (PA, nylon), aromatic PA (aromatic polyamide, aramid), polyimide (PI), aromatic PI, polyamide imide (PAI), aromatic PAI, polybenzoxazole (PBO) (for example, Zylon (registered trademark)), polyether, polyether ester, polyether sulfone (PES), polyether imide (PEI), polysulfone (PSF), polyphenylene sulfide (PPS), polycarbonate (PC), polyarylate (PAR), and polyurethane (PU).

### (Magnetic Layer)

The magnetic layer 43 can be, for example, a perpendicular recording layer. The magnetic layer 43 can contain magnetic powder. The magnetic layer 43 can further contain, for example, a binder and conductive particles in addition to the magnetic powder. The magnetic layer 43 can further contain, for example, additives such as a lubricant, an abrasive, a corrosion inhibitor, and the like, as needed.

A thickness tₘ of the magnetic layer 43 can be preferably 35 nm≤tₘ≤120 nm, more preferably 35 nm≤tₘ≤100 nm, and particularly preferably 35 nm≤tₘ≤90 nm. The thickness tₘ of the magnetic layer 43 within the numerical range described above contributes to improvement of electromagnetic conversion characteristics.

The magnetic layer 43 is preferably a vertically oriented magnetic layer. In the present specification, vertical orientation refers to that a squareness ratio S1 measured in the longitudinal direction (running direction) of the magnetic recording medium 10 is 35% or less.

Note that the magnetic layer 43 may be a magnetic layer which is in-plane oriented (longitudinal orientation). That is, the magnetic recording medium 10 may be a horizontal recording type magnetic recording medium. However, vertical orientation is more preferable in terms of a higher recording density.

### (Magnetic Powder)

Examples of magnetic particles forming the magnetic powder contained in the magnetic layer 43 can include epsilon type iron oxide (ε-iron oxide), gamma hematite, magnetite, chromium dioxide, cobalt-coated iron oxide, hexagonal ferrite, barium ferrite (BaFe), Co ferrite, strontium ferrite, a metal, and the like, but are not limited thereto. The magnetic powder may be one or a combination or two or more thereof. Particularly preferably, the magnetic powder can include ε-iron oxide magnetic powder, barium ferrite magnetic powder, cobalt ferrite magnetic powder, or strontium ferrite magnetic powder. Note that ε-iron oxide may contain Ga and/or Al. These magnetic particles may be appropriately selected by those skilled in the art on the basis of factors such as, for example, the method of manufacturing the magnetic layer 43, specifications of the tape, a function of the tape, and the like.

An average particle size (average maximum particle size) D of the magnetic powder can be preferably 22 nm or less, more preferably 8 nm or more and 22 nm or less, and still more preferably 10 nm or more and 20 nm or less.

The average particle size D of the magnetic powder described above is obtained as follows. First, the magnetic recording medium 10 to be measured is processed by a focused ion beam (FIB) method or the like to prepare a thin piece, and a cross-section of the thin piece is observed by a transmission electron microscope (TEM). Next, 500 ε-iron oxide particles are randomly selected from the imaged TEM photo, a maximum particle size dₘₐₓ of each particle is measured, and a particle size distribution of the maximum particle size dₘₐₓ of the magnetic powder is obtained. Here, the “maximum particle size dₘₐₓ” means a so-called maximum Feret diameter, and specifically, refers to a maximum distance among distances between two parallel lines drawn from all angles so as to be in contact with outline of the ε-iron oxide particle. Thereafter, a median diameter (50% diameter, D50) of the maximum particle size dₘₐₓ is obtained from the particle size distribution of the obtained maximum particle size dₘₐₓ, and is determined as an average particle size (average maximum particle size) D of the magnetic powder.

A shape of the magnetic particles depends on a crystal structure of the magnetic particles. For example, BaFe and strontium ferrite can have a hexagonal plate shape. The ε-iron oxide can have a spherical shape. The cobalt ferrite can have a cubic shape. The metal can have a spindle shape. These magnetic particles are oriented in a manufacturing process of the magnetic recording medium 10.

According to a preferred embodiment of the present technology, the magnetic powder can include powder of nanoparticles preferably containing ε-iron oxide (hereinafter, referred to as “ε-iron oxide particles”). The ε-iron oxide particles can obtain high coercive force even when the ε-iron oxide particles are fine particles. It is preferable that ε-iron oxide contained in the ε-iron oxide particles is preferentially crystal-oriented in a thickness direction (vertical direction) of the magnetic recording medium 10.

The ε-iron oxide particles are hard magnetic particles that can obtain high coercive force even when the iron oxide particles are fine particles. The ε-iron oxide particles have a spherical shape or have a cubic shape. In the present specification, the spherical shape includes a substantially spherical shape. Furthermore, the cubic shape includes a substantially cubic shape. Since the ε-iron oxide particles have the shape as described above, in a case where ε-iron oxide particles are used as the magnetic particles, a contact area between the particles in the thickness direction of the magnetic recording medium 10 can be reduced and aggregation of the particles can be suppressed as compared with a case where barium ferrite particles having a hexagonal plate shape are used as magnetic particles. Therefore, dispersibility of the magnetic powder is increased, and a more excellent electromagnetic conversion characteristic (for example, a signal-to-noise ratio (SNR)) can thus be obtained.

The ε-iron oxide particles may have a structure of composite particles. More specifically, the ε-iron oxide particle includes an ε-iron oxide portion and a portion having soft magnetism or a portion having magnetism in which a saturation magnetization amount σs is higher than that of ε-iron oxide and a coercive force Hc is smaller than that of ε-iron oxide (hereinafter, referred to as a “portion having soft magnetism or the like”).

The ε-iron oxide portion contains ε-iron oxide. The ε-iron oxide contained in the ε-iron oxide portion preferably includes an ε-Fe₂O₃ crystal as a main phase, and more preferably includes a single-phase ε-Fe₂O₃.

The portion having soft magnetism and the like are in contact with at least a part of the ε-iron oxide portion. Specifically, the portion having soft magnetism and the like may partially cover the ε-iron oxide portion, and may partially cover an entire periphery of the ε-iron oxide portion.

The portion having soft magnetism (portion having magnetism in which the saturation magnetization amount (s is higher than that of ε-iron oxide and the coercive force Hc is smaller than that of ε-iron oxide) includes, for example, a soft magnetic material such as α-Fe, a Ni—Fe alloy, an Fe—Si—Al alloy, or the like. α-Fe may also be obtained by reducing ε-iron oxide contained in the ε-iron oxide portion.

Furthermore, the portion having soft magnetism may contain, for example, Fe₃O₄, γ-Fe₂O₃, spinel ferrite, or the like.

The ε-iron oxide particle includes the portion having soft magnetism described above or the like, such that the coercive force Hc of the ε-iron oxide particles (composite particles) as a whole can be adjusted to a coercive force Hc suitable for recording while maintaining the coercive force Hc of the ε-iron oxide portion alone at a large value in order to ensure thermal stability.

The ε-iron oxide particle may contain an additive instead of the structure of the composite particles described above, or may have the structure of the composite particles and may contain an additive as well. In this case, a part of Fe of the ε-iron oxide particle is substituted with the additive. The coercive force Hc of all the ε-iron oxide particles can be adjusted to the coercive force Hc suitable for recording also when the ε-iron oxide particle includes the additive, such that recordability can be improved. The additive is a metal element other than iron, preferably a trivalent metal element, more preferably at least one selected from the group consisting of Al, Ga, and In, and still more preferably at least one selected from the group consisting of Al and Ga.

Specifically, the ε-iron oxide containing the additive is an ε-Fe₂₋ₓMₓO₃ crystal (where M is a metal element other than iron, preferably a trivalent metal element, more preferably at least one selected from the group consisting of Al, Ga, and In, and still more preferably at least one selected from the group consisting of Al and Ga, and x is, for example, 0<x<1).

In a case where the magnetic particles are ε-iron oxide particles, an average particle size of the magnetic particles is preferably 10 nm or more and 20 nm or less, more preferably 10 nm or more and 18 nm or less, still more preferably 10 nm or more and 16 nm or less, particularly preferably 10 nm or more and 15 nm or less, and most preferably 10 nm or more and 14 nm or less. In the magnetic recording medium 10, a region having a size of ½ of a recording wavelength is an actual magnetization region. Therefore, a more excellent electromagnetic conversion characteristic (for example, SNR) can be obtained by setting the average particle size of the magnetic particles to half or smaller of the shortest recording wavelength. Accordingly, when the average particle size of the magnetic particles is 20 nm or less, in the magnetic recording medium 10 having a high recording density (for example, the magnetic recording medium 10 configured to be able to record a signal at the shortest recording wavelength of 40 nm or less), a more excellent electromagnetic conversion characteristic (for example, SNR) can be obtained. On the other hand, when the average particle size of the magnetic particles is 10 nm or more, the dispersibility of the magnetic particles is further improved, and a more excellent electromagnetic conversion characteristic (for example, SNR) can be obtained.

In a case where the magnetic particles are ε-iron oxide particles, an average aspect ratio of the magnetic particles is preferably 1.0 or more and 3.0 or less, more preferably 1.0 or more and 2.5 or less, still more preferably 1.0 or more and 2.1 or less, and particularly preferably 1.0 or more and 1.8 or less. When the average aspect ratio of the magnetic particles is within the range of 1.0 or more and 3.0 or less, aggregation of the magnetic particles can be suppressed. Furthermore, when the magnetic particles are vertically oriented in a process of forming the magnetic layer 43, resistance applied to the magnetic particles can be suppressed. Therefore, vertical orientation of the magnetic particles can be improved.

In a case where the magnetic particles are ε-iron oxide particles, an average particle size and an average aspect ratio of the magnetic particles are determined as follows. First, the magnetic recording medium 10 accommodated in a cartridge 10A is unwound, and the magnetic recording medium 10 is cut out at a position apart from 30 m to 40 m from a connection portion between the magnetic recording medium 10 and a reader tape in the longitudinal direction. Subsequently, the magnetic recording medium 10 to be measured is processed by a focused ion beam (FIB) method or the like to be thinned. In a case where the FIB method is used, a carbon layer and a tungsten layer are formed as protective layers as a pre-treatment for observing a TEM image of a cross section described later. The carbon layer is formed on a surface of the magnetic layer 43 and a surface of the back layer 44 of the magnetic recording medium 10 by a vapor deposition method, and then the tungsten layer is further formed on the surface of the magnetic layer 43 by a vapor deposition method or a sputtering method. The thinning is performed in the length direction (longitudinal direction) of the magnetic recording medium 10. That is, a cross section parallel to both the longitudinal direction and the thickness direction of the magnetic recording medium 10 is formed by the thinning.

Using a transmission electron microscope (H-9500 manufactured by Hitachi High-Technologies Corporation), the cross section described above of the obtained thin piece sample is observed at an acceleration voltage of 200 kV and a total magnification of 500,000 times so that the entire magnetic layer 43 is included in the thickness direction of the magnetic layer 43, and a TEM image is captured. Next, 50 particles whose shapes can be clearly confirmed are selected from the captured TEM image, and a long axis length DL and a short axis length DS of each particle are measured. Here, the long axis length DL means the largest one of the distances between two parallel lines drawn from all angles so as to be in contact with a contour of each particle (so-called maximum Feret's diameter). On the other hand, the short axis length DS means the largest one of the lengths of the particles in a direction orthogonal to a long axis (DL) of the particle. Subsequently, the measured long axis lengths DLs of the 50 particles are simply averaged (arithmetically averaged) to determine an average long axis length DLₐᵥₑ. The average long axis length DLₐᵥₑ obtained as described above is defined as the average particle size of the magnetic particles. Furthermore, the measured short axis lengths DSs of the 50 particles are simply averaged (arithmetically averaged) to determine an average short axis length DSₐᵥₑ. Then, an average aspect ratio (DLₐᵥₑ/DSₐᵥₑ) of the particles is determined from the average long axis length DLₐᵥₑ and the average short axis length DSₐᵥₑ.

In a case where the magnetic particles are ε-iron oxide particles, an average particle volume of the magnetic particles is preferably 500 nm³ or more and 4,000 nm³ or less, more preferably 500 nm³ or more and 3,000 nm³ or less, still more preferably 500 nm³ or more and 2,000 nm³ or less, particularly preferably 600 nm³ or more and 1,600 nm³ or less, and most preferably 600 nm³ or more and 1,300 nm³ or less. In general, since a noise of the magnetic recording medium 10 is inversely proportional to a square root of the number of particles (that is, proportional to the square root of the particle volume), a more excellent electromagnetic conversion characteristic (for example, SNR) can be obtained by reducing the particle volume. Therefore, when the average particle volume of the magnetic particles is 4,000 nm³ or less, similar to a case where the average particle size of the magnetic particles is 20 nm or less, a more excellent electromagnetic conversion characteristic (for example, SNR) can be obtained. On the other hand, when the average particle volume of the magnetic particles is 500 nm³ or more, the effect similar to that in a case where the average particle size of the magnetic particles is 10 nm or more is obtained.

In a case where the ε-iron oxide particle has a spherical shape, the average particle volume of the magnetic particles is determined as follows. First, the average long axis length DLₐᵥₑ is determined in a manner similar to the method of calculating the average particle size of the magnetic particles described above. Next, an average volume V of the magnetic particles is determined by the following equation.

V=(π/6)×DLₐᵥₑ₃

In a case where the ε-iron oxide particle has a cubic shape, the average volume of the magnetic particles is determined as follows. First, the magnetic recording medium 10 accommodated in a cartridge 10A is unwound, and the magnetic recording medium 10 is cut out at a position apart from 30 m to 40 m from a connection portion between the magnetic recording medium 10 and a reader tape LT in the longitudinal direction. Subsequently, the cut magnetic recording medium 10 is processed by a focused ion beam (FIB) method or the like to be thinned. In a case where the FIB method is used, a carbon film and a tungsten thin film are formed as protective films as a pre-treatment for observing a TEM image of a cross section described later. The carbon film is formed on a surface of the magnetic layer 43 and a surface of the back layer 44 of the magnetic recording medium 10 by a vapor deposition method, and then the tungsten thin film is further formed on the surface of the magnetic layer 43 by a vapor deposition method or a sputtering method. The thinning is performed in the length direction (longitudinal direction) of the magnetic recording medium 10. That is, a cross section parallel to both the longitudinal direction and the thickness direction of the magnetic recording medium 10 is formed by the thinning.

Using a transmission electron microscope (H-9500 manufactured by Hitachi High-Technologies Corporation), the obtained thin piece sample is observed at an acceleration voltage of 200 kV and a total magnification of 500,000 times so that the entire magnetic layer 43 is included in the thickness direction of the magnetic layer 43, and a TEM image is obtained. Note that the magnification and the acceleration voltage may be appropriately adjusted according to the type of the apparatus. Next, 50 particles whose shapes can be clearly confirmed are selected from the captured TEM image, and a side length DC of each particle is measured. Subsequently, the measured side lengths DCs of the 50 particles are simply averaged (arithmetically averaged) to determine an average side length DCₐᵥₑ.

Next, an average volume Vₐᵥₑ of the magnetic particles (particle volume) is determined from the following equation using the average side length DCₐᵥₑ.

$${V}_{ave} = {DC}_{{ave}^{3}}$$

According to another preferred embodiment of the present technology, the magnetic powder may be a barium ferrite (BaFe) magnetic powder. The barium ferrite magnetic powder contains iron oxide magnetic particles having barium ferrite as a main phase (hereinafter, referred to as “barium ferrite particles”). The barium ferrite magnetic powder has high reliability of data recording, for example, the coercive force is not decreased even in a high-temperature and high-humidity environment, and the like. From such a viewpoint, the barium ferrite magnetic powder is preferable as the magnetic powder.

An average particle size of the barium ferrite magnetic powder is 50 nm or less, more preferably 10 nm or more and 40 nm or less, and still more preferably 12 nm or more and 25 nm or less.

In a case where the magnetic layer 43 contains barium ferrite magnetic powder as the magnetic powder, the thickness tₘ [nm] of the magnetic layer 43 is preferably 35 nm tₘ≤120 nm. Furthermore, the coercive force Hc measured in the thickness direction (vertical direction) of the magnetic recording medium 10 is preferably 160 kA/m or more and 280 kA/m or less, more preferably 165 kA/m or more and 275 kA/m or less, and still more preferably 170 kA/m or more and 270 kA/m or less.

According to still another preferred embodiment of the present technology, the magnetic powder can be cobalt ferrite magnetic powder. The cobalt ferrite magnetic powder contains iron oxide magnetic particles having cobalt ferrite as a main phase (hereinafter, referred to as “cobalt ferrite magnetic particles”). The cobalt ferrite magnetic particle preferably has uniaxial anisotropy. The cobalt ferrite magnetic particle has, for example, a cubic shape or a substantially cubic shape. The cobalt ferrite is cobalt ferrite containing Co. The cobalt ferrite may further contain one or more selected from the group consisting of Ni, Mn, Al, Cu, and Zn in addition to Co.

The cobalt ferrite has, for example, an average composition represented by the following Formula (1).

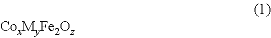

(Here, in Formula (1), M is, for example, one or more metals selected from the group consisting of Ni, Mn, Al, Cu, and Zn, x is a value within a range of 0.4≤x≤1.0, y is a value within a range of 0≤y≤0.3, where x and y satisfy a relationship of (x+y)≤1.0, z is a value within a range of 3≤z≤4, and a part of Fe may be substituted with another metal element.)

An average particle size of the cobalt ferrite magnetic powder is preferably 25 nm or less and more preferably 23 nm or less. A coercive force Hc of the cobalt ferrite magnetic powder is preferably 2,500 Oe or more and more preferably 2,600 Oe or more and 3,500 Oe or less.

According to still another embodiment of the present technology, the magnetic powder can include powder of nanoparticles containing hexagonal ferrite (hereinafter, referred to as “hexagonal ferrite particles”). The hexagonal ferrite particle has, for example, a hexagonal plate shape or a substantially hexagonal plate shape. The hexagonal ferrite can preferably contain at least one of Ba, Sr, Pb and Ca, and more preferably at least one of Ba and Sr. Specifically, the hexagonal ferrite may be, for example, barium ferrite or strontium ferrite. The barium ferrite may further contain at least one of Sr, Pb, and Ca in addition to Ba. The strontium ferrite may further contain at least one of Ba, Pb, and Ca in addition to Sr.

More specifically, the hexagonal ferrite can have an average composition represented by a general formula MFe₁₂O₁₉. Here, M is, for example, at least one metal of Ba, Sr, Pb, and Ca, and preferably at least one metal of Ba and Sr. M may be a combination of Ba and one or more metals selected from the group consisting of Sr, Pb, and Ca. Furthermore, M may be a combination of Sr and one or more metals selected from the group consisting of Ba, Pb, and Ca. In the general formula described above, a part of Fe may be substituted by another metal element.

In a case where the magnetic powder includes powder of hexagonal ferrite particles, an average particle size of the magnetic powder is preferably 50 nm or less, more preferably 10 nm or more and 40 nm or less, and still more preferably 15 nm or more and 30 nm or less.

### (Binder)

As the binder, a resin having a structure in which a crosslinking reaction is imparted to a polyurethane-based resin, a vinyl chloride-based resin, or the like is preferable. However, the binder is not limited thereto, and other resins may be appropriately blended according to a physical property and the like required for the magnetic recording medium 10. The resin to be blended is not particularly limited as long as it is usually used in a coating type magnetic recording medium 10.

Examples of the binder include polyvinyl chloride, polyvinyl acetate, a vinyl chloride-vinyl acetate copolymer, a vinyl chloride-vinylidene chloride copolymer, a vinyl chloride-acrylonitrile copolymer, an acrylic acid ester-acrylonitrile copolymer, an acrylic acid ester-vinyl chloride-vinylidene chloride copolymer, an acrylic acid ester-vinylidene chloride copolymer, a methacrylic acid ester-vinylidene chloride copolymer, a methacrylic acid ester-vinyl chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, or nitrocellulose), a styrene-butadiene copolymer, a polyester resin, an amino resin, synthetic rubber, and the like.

Furthermore, as the binder, a thermosetting resin or a reactive resin may be used, and examples thereof include a phenol resin, an epoxy resin, a urea resin, a melamine resin, an alkyd resin, a silicone resin, a polyamine resin, a urea-formaldehyde resin, and the like.

Furthermore, a polar functional group such as —SO₃M, —OSO₃M, —COOM, P═O(OM)₂, or the like may be introduced into each binder described above in order to improve dispersibility of the magnetic powder. Here, in the formula, M is a hydrogen atom or an alkali metal such as lithium, potassium, sodium, or the like.

Moreover, examples of the polar functional group include a side chain type having an end group of —NR1R2 and —NR1R2R3⁺X⁻, a main chain type of >NR1R2⁺X⁻, and the like. Here, in the formulas, each of R1, R2 and R3 is a hydrogen atom or a hydrocarbon group, and X⁻ is a halogen element ion such as fluorine, chlorine, bromine, iodine, or the like, or an inorganic or organic ion. Furthermore, examples of the polar functional group include OH, —SH, —CN, an epoxy group, and the like.

### (Additives)

The magnetic layer 43 may further contain aluminum oxide (α, β, or γ alumina), chromium oxide, silicon oxide, diamond, garnet, emery, boron nitride, titanium carbide, silicon carbide, titanium carbide, titanium oxide (rutile type or anatase type titanium oxide), or the like, as non-magnetic reinforcing particles.

### (Underlayer)

The underlayer 42 is a non-magnetic layer containing non-magnetic powder and a binder as main components. The description regarding the binder contained in the magnetic layer 43 is also applied to the binder contained in the underlayer 42. The underlayer 42 may further contain at least one additive of conductive particles, a lubricant, a curing agent, a corrosion inhibitor, and the like, as needed.

A thickness of the underlayer 42 can be preferably 1.2 μm or less, more preferably 1.0 μm or less, and still more preferably 0.8 μm or less. Furthermore, a lower limit value of the thickness of the underlayer 42 is not particularly limited, and is preferably 0.2 μm or more and more preferably 0.4 μm or more.

### (Non-Magnetic Powder)

The non-magnetic powder contained in the underlayer 42 can contain, for example, at least one selected from inorganic particles and organic particles. One kind of non-magnetic powder may be used alone, or two or more kinds of non-magnetic powders may be used in combination. The inorganic particles include, for example, one or a combination of two or more selected from a metal, metal oxide, metal carbonate, metal sulfate, metal nitride, metal carbide, and metal sulfide. More specifically, the inorganic particles can be, for example, one or two or more selected from iron oxyhydroxide, hematite, titanium oxide, and carbon black. Examples of a shape of the non-magnetic powder include various shapes such as a needle shape, a sphere shape, a cubic shape, a plate shape, and the like, but are not particularly limited thereto.

### (Back Layer)

The back layer 44 can contain a binder and non-magnetic powder. The back layer 44 may contain various additives such as a lubricant, a curing agent, an antistatic agent, and the like, as needed. The descriptions of the binder and the non-magnetic powder contained in the underlayer 42 described above are also applied to the binder and the non-magnetic powder contained in the back layer 44.

An average particle size of the inorganic particles contained in the back layer 44 is preferably 10 nm or more and 150 nm or less and more preferably 15 nm or more and 110 nm or less. The average particle size of the inorganic particles is determined in a manner similar to that of the average particle size D of the magnetic powder described above.

A thickness t_{b} of the back layer 44 is preferably t_{b}≤0.6 μm. When the thickness t_{b} of the back layer 44 is within the range described above, even in a case where the thickness t_{T} of the magnetic recording medium 10 is t_{T}≤5.6 μm, the thicknesses of the underlayer 42 and the base layer 41 can be kept thick, and therefore, running stability of the magnetic recording medium 10 in the recording and reproducing apparatus can be maintained.

### (3) Physical Properties and Structure

### (Variation in Width ΔW of Magnetic Recording Medium at 60° C.)

In the present technology, the variation in width ΔW of the magnetic recording medium at 60° C. is measured by the following procedure. Note that the measured temperature 60° C. is a temperature close to an upper limit value of the temperature in the drive in the recording and reproducing apparatus.

First, the magnetic recording medium 10 accommodated in the magnetic recording cartridge 10A is unwound, and the magnetic recording medium 10 is cut out to a length of 250 mm from each of three positions apart from 10 m to 20 m, 30 m to 40 m, and 50 m to 60 m from the connection portion between the magnetic recording medium 10 and the reader tape, thereby preparing three samples 10S.

Next, loads are applied in the order of 0.2 N, 0.6 N, and 1.0 N in a longitudinal direction of each of the samples 10S in an environment of 60° C., and widths of the samples 10S at the loads of 0.2 N, 0.6 N, and 1.0 N are measured at three points. Subsequently, the variation in width Δw of the sample 10S measured by the following equation is determined. Note that the measurement in a case where a load of 0.6 N is applied is performed in order to confirm whether or not an abnormality has not occurred in the measurement (particularly, in order to confirm that these three measurement results are linear), and the measurement result is not used in the following equation. The measurement described above is performed on the three samples 10S having different cut positions, and an average value obtained by simply averaging (arithmetically averaging) the obtained measured values of the variations in width Δw of the respective samples 10S is defined as a variation in width Δw of the magnetic recording medium 10.

$$Δ w [ ppm / N ] = \frac{D ( 0.2 N ) [ mm ] - D ( 1. N ) [ mm ]}{D ( 0.2 N ) [ mm ]} \times \frac{1 , 000 , 000}{( 1. [ N ] ) - ( 0.2 [ N ] )} \qquad [ Math . 1 ]$$

(Here, in the equation, D (0.2 N) and D (1.0 N) represent widths of the sample 10S when loads of 0.2 N and 1.0 N are applied in a longitudinal direction of the sample 10S, respectively.)

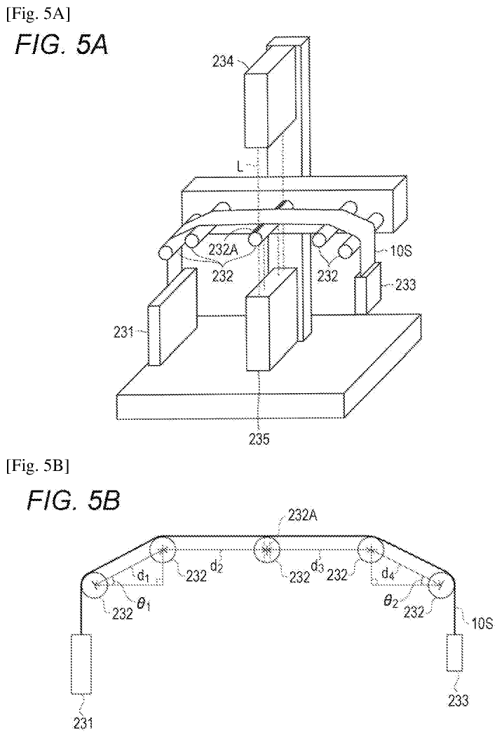

The width of the sample 10S when each load is applied is measured as follows. First, as a measurement apparatus, a measurement apparatus illustrated in FIG. 5A into which a digital dimension measuring instrument LS-7000 manufactured by Keyence Corporation is incorporated is prepared, and the sample 10S is set in the measurement apparatus. Specifically, one end of an elongated sample (magnetic recording medium) 10S is fixed by a fixing unit 231. Next, as illustrated in FIG. 5A, the sample 10S is set on five substantially cylindrical and rod-shaped support members 232. The sample 10S is set on these support members so that a back surface thereof is in contact with the five support members 232. The five support members 232 (particularly, surfaces thereof) all include stainless steel SUS304, and have a surface roughness Rz (maximum height) of 0.15 μm to 0.3 μm.

The arrangement of the five rod-shaped support members 232 will be described with reference to FIG. 5B. As illustrated in FIG. 5B, the sample 10S is set on the five support members 232. Hereinafter, the five support members 232 are referred to as, starting from the side closest to the fixing unit 231, a “first support member”, a “second support member”, a “third support member” (having a slit 232A), a “fourth support member”, and a “fifth support member” (closest to a weight 233). A diameter of each of these five support members is 7 mm. A distance d₁ between the first support member and the second support member (in particular, a distance between the centers of these support members) is 20 mm. A distance d₂ between the second support member and the third support member is 30 mm. A distance d₃ between the third support member and the fourth support member is 30 mm. A distance d₄ between the fourth support member and the fifth support member is 20 mm. Furthermore, these three support members are arranged so that portions of the sample 10S set between the second support member, the third support member, and the fourth support member form a substantially perpendicular plane with respect to the direction of gravity. Furthermore, the first support member and the second support member are arranged so that the sample 10S forms an angle of θ₁=300 with respect to the substantially perpendicular plane between the first support member and the second support member. Moreover, the fourth support member and the fifth support member are arranged so that the sample 10S forms an angle of θ₂=300 with respect to the substantially perpendicular plane between the fourth support member and the fifth support member.

Furthermore, among the five support members 232, the third support member is fixed so as not to rotate, while the other four support members are all rotatable.

The sample 10S is held on the support members 232 so as not to move in a width direction of the sample 10S. Note that, among the support members 232, the support member 232 positioned between a light emitter 234 and a light receiver 235 and positioned substantially at the center between the fixing unit 231 and the portion at which a load is applied is provided with the slit 232A. Light L is radiated from the light emitter 234 to the light receiver 235 through the slit 232A. A slit width of the slit 232A is 1 mm and the light L may pass through the width, without being blocked by a frame of the slit 232A.

Subsequently, after the measurement apparatus is accommodated in a chamber (manufactured by ESPEC Corp., model number: PDR-3J) controlled under a predetermined environment at a constant environment of a temperature of 60° C. and a relative humidity of 40% RH % RH, the weight 233 for applying a load of 0.2 N is attached to the other end of the sample 10S, and the sample 10S is allowed to stand in the environment described above for 3 hours. After standing for 3 hours, a width of the sample 10S is measured. Next, the weight for applying the load of 0.2 N is changed to a weight for applying a load of 0.6 N, and the width of the sample 10S is measured 5 minutes after the change. Finally, the weight is changed to a weight for applying a load of 1.0 N, and the width of the sample 10S is measured 5 minutes after the change. As described above, the load applied in the longitudinal direction of the sample 10S may be changed by adjusting the weight of the weight 233. In a state where each load applied, light L is radiated from the light emitter 234 toward the light receiver 235, and the width of the sample 10S to which the load is applied in the longitudinal direction is measured. The measurement of the width is performed in a state where the sample 10S is not curled. The light emitter 234 and the light receiver 235 are provided in the digital dimension measuring instrument LS-7000.

### (Time Until Width of Magnetic Recording Medium Is Stabilized (Tape Following Time))

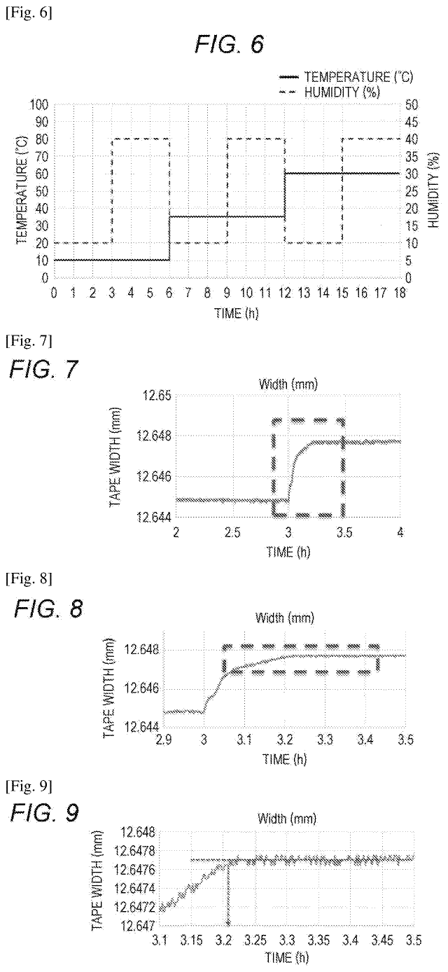

As illustrated in FIG. 6, a time until the width of the sample 10S is stabilized after the humidity is changed under a predetermined temperature environment (also referred to as a tape following time) is determined, and the time until the width of the sample 10S is stabilized from the humidity change start time is defined as a time until the width of the sample 10S is stabilized. The time during which the width of the sample 10S is stabilized is also referred to as a time during which the sample 10S follows the humidity change. A method of determining the time until the width is stabilized will be described.

First, the magnetic recording medium 10 accommodated in the magnetic recording cartridge 10A is unwound, and the magnetic recording medium 10 is newly cut out to a length of 250 mm from each of three positions apart from 10 m to 20 m, 30 m to 40 m, and 50 m to 60 m from the connection portion between the magnetic recording medium 10 and the reader tape, thereby preparing three samples 10S. That is, when the variation in width ΔW is measured, a sample 10S different from the cut sample 10S is newly cut out. A measuring apparatus used for the measurement is the same as that used for the measurement of the variation in width ΔW of the magnetic recording medium described above. Similar to the calculation of the measured value of the variation in width ΔW, the measurement is performed on each of the three samples 10S having different cut positions, and an average value obtained by simply averaging (arithmetically averaging) the obtained measured values of the respective samples 10S is defined as the time until the width of the magnetic recording medium 10 is stabilized (tape following time).

FIG. 6 is a view illustrating setting states of temperature and humidity in width variation measurement ΔW. The measuring apparatus is accommodated in a chamber (Manufactured by ESPEC Corp., model number: PDR-3J) controlled to a constant environment of a temperature of 10° C. and a relative humidity of 10% RH % RH. Next, a load is applied in the longitudinal direction of the sample 10S, and the sample 10S is placed in the environment described above for 3 hours so as to be pulled at 0.55 N in the longitudinal direction. As illustrated in FIG. 6, the relative humidity is increased from 10% RH % RH to 40% RH % RH while the temperature is maintained at 10° C., and the width of the sample 10S is measured for 3 hours. A relative humidity increase rate is not set, and the relative humidity increase rate is left to the function of a thermostatic bath, but is about 4.3% RH % RH/min at the maximum. Thereafter, as illustrated in FIG. 6, the inside of the chamber is controlled to an environment of a temperature of 35° C. and a relative humidity of 10% RH % RH, and the sample 10S is placed in the environment described above for 3 hours. The relative humidity is increased from 10% RH % RH to 40% RH % RH while the temperature is maintained at 35° C., and the width of the sample 10S is measured for 3 hours. A relative humidity increase rate is not set, and the relative humidity increase rate is left to the function of a thermostatic bath, but is about 4.3% RH % RH/min at the maximum. Thereafter, as illustrated in FIG. 6, the inside of the chamber is controlled to an environment of a temperature of 60° C. and a relative humidity of 10% RH % RH, and the sample 10S is placed in the environment described above for 3 hours. The relative humidity is increased from 10% RH % RH to 40% RH % RH while the temperature is maintained at 60° C., and the width of the sample 10S is measured for 3 hours. A relative humidity increase rate is not set, and the relative humidity increase rate is left to the function of a thermostatic bath, but is about 4.3% RH % RH/min at the maximum.

FIGS. 7 to 9 are views illustrating a relationship between the measurement time and the width of the sample 10S in a case where the relative humidity is increased from 10% RH % RH to 40% RH % RH while the temperature is maintained at 10° C. FIG. 7 is a view illustrating the relationship between the measurement time and the width of the sample 10S in a case where the relative humidity is increased from 10% RH % RH to 40% RH % RH while the temperature is maintained at 10° C., FIG. 8 is an enlarged view of a portion surrounded by a dotted line, and FIG. 9 is a view obtained by further enlarging the dotted line portion.

In the measurement of the width of the sample 10S, at a time point when the width change is continued within ±0.05 μm for 6 minutes, the first time point at which the width is stabilized is defined as a time required for the width to be stabilized, and a time from the first time point (0 minutes) when the humidity is switched from 10% RH % RH to the time required for the width to be stabilized is defined as a time until the width of the sample 10S (magnetic recording medium) (tape following time) is stabilized. For example, in a case where the relative humidity is increased from 10% RH % RH to 40% RH % RH while the temperature is maintained at 10° C., as illustrated in FIGS. 7 to 9, the first time point at which the humidity is switched from 10% RH % RH is 3.0 hours, and the first time point at which the width change is within ±0.05 μm becomes 3.2 hours. Therefore, the time until the width is stabilized is 12 minutes according to the following equation.

$$Time until width is stabilized = ( 3.2 - 3. ) \times 60 = 12 minutes$$

### (Average Thickness (Average Total Thickness) t_{T} of Magnetic Recording Medium)

The average thickness (average total thickness) t_{T} of the magnetic recording medium 10 is determined as follows. First, the magnetic recording medium 10 accommodated in the magnetic recording cartridge 10A is unwound, and the magnetic recording medium 10 is cut out to a length of 250 mm from each of three positions apart from 10 m to 20 m, 30 m to 40 m, and 50 m to 60 m from the connection portion between the magnetic recording medium 10 and the reader tape LT, thereby preparing samples. Next, thicknesses of the sample are measured at five or more locations using a laser holo gauge manufactured by Mitutoyo Corporation as the measuring apparatus, and these measured values are simply averaged (arithmetically averaged) to calculate an average value t_{T} [μm].

### (Thickness of Non-Magnetic Layer)

The magnetic recording medium 10 is thinly processed perpendicularly to a principal plane thereof to prepare a test piece, and a cross section of the test piece is observed with a transmission electron microscope (TEM) under the following conditions.
Device: TEM (H9000NAR manufactured by Hitachi, Ltd.)
Acceleration voltage: 300 kV magnification: 100,000 times

Next, the thickness of the non-magnetic layer (underlayer) 42 is measured at 10 or more positions in the longitudinal direction of the magnetic recording medium 10 using the obtained TEM image, and then these measured values are simply averaged (arithmetically averaged) to obtain the thickness (m) of the non-magnetic layer (underlayer) 42.

### (Thickness of Base Layer)

The thickness of the base layer 41 can be determined as follows. First, the magnetic recording medium 10 accommodated in the magnetic recording cartridge 10A is unwound, and the magnetic recording medium 10 is cut out to a length of 250 mm from each of three positions apart from 10 m to 20 m, 30 m to 40 m, and 50 m to 60 m from the connection portion between the magnetic recording medium 10 and the reader tape LT, thereby preparing samples. Subsequently, the layers of the sample other than the base layer 41 are removed with, for example, a solvent such as methyl ethyl ketone (MEK) or the like, dilute hydrochloric acid, or the like. Next, a thickness of the sample (base layer 41) is measured at five or more positions using a laser holo gauge manufactured by Mitutoyo Corporation as a measuring device, and these measured values are simply averaged (arithmetically averaged) to calculate the thickness [μm] of the base layer 41.

### (Thickness of Back Layer)

The thickness t_{b} of the back layer 44 is determined as follows. First, the magnetic recording medium 10 accommodated in the magnetic recording cartridge 10A is unwound, and the magnetic recording medium 10 is cut out to a length of 250 mm from each of three positions apart from 10 m to 20 m, 30 m to 40 m, and 50 m to 60 m from the connection portion between the magnetic recording medium 10 and the reader tape LT, thereby preparing samples. Next, thicknesses of the sample are measured at five or more locations using a laser holo gauge manufactured by Mitutoyo Corporation as the measuring apparatus, and these measured values are simply averaged (arithmetically averaged) to calculate an average value t_{T} [μm]. Subsequently, after the back layer 44 of the sample is removed with a solvent such as methyl ethyl ketone (MEK) or the like, dilute hydrochloric acid, or the like, 5 or more thicknesses are measured at different locations of the sample using the laser holo gauge described above again, and these measured values are simply averaged (arithmetically averaged) to calculate an average thickness t_{B} [μm]. Thereafter, a thickness t_{b} [μm] of the back layer 44 is determined by the following equation.

$${t}_{b} [ μm ] = {t}_{T} [ μm ] - {t}_{B} [ μm ]$$

### (Thickness tₘ of Magnetic Layer)

The thickness tₘ of the magnetic layer 43 is determined as follows. First, the magnetic recording medium 10 is thinly processed perpendicularly to a principal plane thereof to prepare a test piece, and a cross section of the test piece is observed with a transmission electron microscope (TEM) under the following conditions.
Device: TEM (H9000NAR manufactured by Hitachi, Ltd.)
Acceleration voltage: 300 kV magnification: 100,000 times

Next, the thickness of the magnetic layer 43 is measured at 10 or more positions in the longitudinal direction of the magnetic recording medium 10 using the obtained TEM image, and then these measured values are simply averaged (arithmetically averaged) to obtain the thickness tₘ (nm) of the magnetic layer 43.

### (4) Method of Manufacturing Magnetic Recording Medium

Next, a method of manufacturing the magnetic recording medium 10 having the configuration described above will be described. First, a non-magnetic layer (underlayer) forming coating material is prepared by kneading and/or dispersing non-magnetic powder, a binder, or the like, in a solvent. Next, a magnetic layer forming coating material is prepared by kneading and/or dispersing magnetic powder, a binder, or the like in a solvent. For the preparation of the magnetic layer forming coating material and the non-magnetic layer (underlayer) forming coating material, for example, the following solvents, dispersing device, and kneading device can be used.

Examples of the solvents used in the preparation of the coating material described above include ketone solvents such as acetone, methyl ethyl ketone, methyl isobutyl ketone, cyclohexanone, and the like; alcohol solvents such as methanol, ethanol, propanol, and the like; ester-based solvents such as methyl acetate, ethyl acetate, butyl acetate, propyl acetate, ethyl lactate, ethylene glycol acetate, and the like; ether-based solvents such as diethylene glycol dimethyl ether, 2-ethoxyethanol, tetrahydrofuran, dioxane, and the like; aromatic hydrocarbon solvents such as benzene, toluene, xylene, and the like; and halogenated hydrocarbon-based solvents such as methylene chloride, ethylene chloride, carbon tetrachloride, chloroform, chlorobenzene, and the like. One of these solvents may be used, or a mixture of two or more thereof may be used.

As the kneading device used in the preparation of the coating material described above, for example, a kneading device such as a continuous biaxial kneader, a continuous biaxial kneader capable of diluting in multiple steps, a kneader, a press kneader, a roll kneader, or the like can be used, but the present technology is not particularly limited thereto. Furthermore, as the dispersing device used in the preparation of the coating material described above, for example, a roll mill, a ball mill, a horizontal sand mill, a vertical sand mill, a spike mill, a pin mill, a tower mill, a pearl mill (for example, DCP Mill, manufactured by Nippon Eirich Co., Ltd., or the like), a homogenizer, an ultrasonic dispersing device, or the like can be used, but the present technology is not particularly limited thereto.

Next, the non-magnetic layer (underlayer) forming coating material is applied to one principal plane of the base layer 41 and dried to form the underlayer 42. Subsequently, the magnetic layer forming coating material is applied onto the underlayer 42 and dried to form the magnetic layer 43 on the underlayer 42. Note that, at the time of drying, magnetic powder is magnetically oriented in the thickness direction of the base layer 41 by, for example, a solenoid coil. Furthermore, at the time of drying, for example, the magnetic powder may be magnetically oriented in the longitudinal direction (running direction) of the base layer 41 and then may be magnetically oriented in the thickness direction of the base layer 41 by a solenoid coil. By performing such magnetic orientation processing, a ratio Hc2/Hc1 of a holding force “Hc1” in the vertical direction to a holding force “Hc2” in the longitudinal direction can be reduced, and a degree of vertical orientation of the magnetic powder can be improved. After the magnetic layer 43 is formed, the back layer 44 is formed on the other principal plane of the base layer 41. Therefore, the magnetic recording medium 10 can be obtained.

The ratio Hc2/Hc1 is, for example, set to a desired value by adjusting strength of the magnetic field applied to the coating film of the magnetic layer forming coating material, a concentration of a solid content in the magnetic layer forming coating material, and drying conditions of the coating film of the magnetic layer forming coating material (drying temperature and drying time). The strength of the magnetic field applied to the coating film is preferably 2 times or more and 3 times or less the holding force of the magnetic powder. In order to further increase the ratio Hc2/Hc1, it is also preferable to magnetize the magnetic powder at a stage before the magnetic layer forming coating material enters an orienting device for performing the magnetic field orientation of the magnetic powder. Note that methods of adjusting the ratio Hc2/Hc1 may be used alone or in combination of two or more thereof.

Thereafter, the obtained magnetic recording medium 10 is rewound around a large diameter core, and curing processing is performed. Finally, the magnetic recording medium 10 is calendered and then cut into a predetermined width (for example, a width of ½ inches). Thus, a target elongated magnetic recording medium 10 can be obtained.

### (5) Example of Recording and Reproducing Apparatus

### (Configuration of Recording and Reproducing Apparatus)

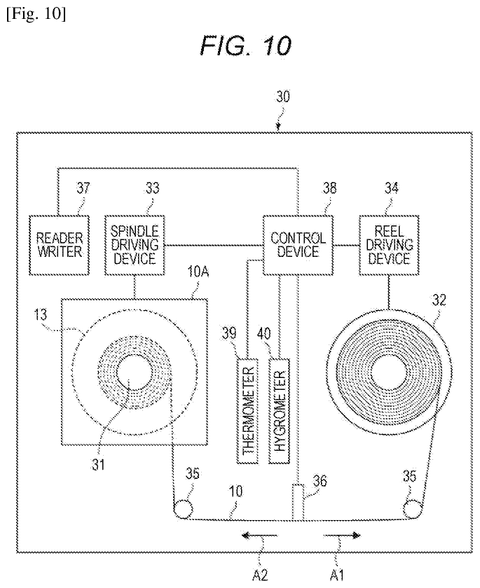

Next, an example of a configuration of a recording and reproducing apparatus 30 that performs recording and reproducing of the magnetic recording medium 10 having the configuration described above will be described with reference to FIG. 10. FIG. 10 is a view illustrating the recording and reproducing apparatus 30. The recording and reproducing apparatus 30 is a data recording/reproducing apparatus capable of recording data on the magnetic recording medium 10 or reproducing data recorded on the magnetic recording medium 10.

As illustrated in FIG. 10, the recording and reproducing apparatus 30 is configured to be able to load the cartridge 10A. The recording and reproducing apparatus 30 is configured to be able to load one cartridge 10A, but may be configured to be able to load a plurality of cartridges 10A at the same time.

The recording and reproducing apparatus 30 includes a spindle 31, a winding reel 32, a spindle driving device 33, a reel driving device 34, a plurality of guide rollers 35, a drive head 36, a reader writer 37, and a control device 38. The recording and reproducing apparatus 30 may further include a thermometer 39, a hygrometer 40, and the like.

The spindle 31 has a head portion that engages with a chucking gear of a tape reel 13 via an opening 14 formed in a lower shell 11b of the cartridge 10A. The spindle 31 raises the tape reel 13 by a predetermined distance against a biasing force of a reel spring 16 and releases a reel lock function by a reel lock member 17. Therefore, the tape reel 13 is rotatably supported inside a cartridge case 11 by the spindle 31.

The spindle driving device 33 rotates the spindle 31 according to a command from the control device 38. The winding reel 32 is configured to be able to fix a tip (reader pin 22) of the magnetic recording medium 10 pulled out from the cartridge 10A via a tape loading mechanism (not illustrated).

The plurality of guide rollers 35 guide the running of the magnetic recording medium 10 so that a tape path formed between the cartridge 10A and the winding reel 32 has a predetermined relative positional relationship with respect to the drive head 36. The reel driving device 34 rotates the winding reel 32 according to a command from the control device 38.

When data is recorded/reproduced on the magnetic recording medium 10, the spindle 31 and the winding reel 32 are rotated by the spindle driving device 33 and the reel driving device 34, and the magnetic recording medium 10 runs. As for the running direction of the magnetic recording medium 10, the magnetic recording medium 10 can reciprocate in the forward direction (direction of unwinding from the tape reel 13 to the winding reel 32) indicated by the arrow A1 and the reverse direction (direction of rewinding from the winding reel 32 to the tape reel 13) indicated by the arrow A2 in FIG. 10.

Note that, in the present embodiment, the tension in the longitudinal direction (X-axis direction) of the magnetic recording medium 10 at the time of data recording/reproduction can be adjusted by controlling the rotation of the spindle 31 by the spindle driving device 33 and the rotation of the winding reel 32 by the reel driving device 34. The adjustment of the tension of the magnetic recording medium 10 may be performed by control of the movement of the guide roller 35, a tension control unit including a dancer roller, or the like, instead of control of the rotation of the spindle 31 and the winding reel 32 (alternatively, in addition to the control).

The tension of the magnetic recording medium 10 during running is typically set to the same value as the tension when the servo pattern 6 is recorded on the magnetic recording medium 10 by a servo pattern recording apparatus 100 as described later (hereinafter, also referred to as a reference tension). Furthermore, since the recording and reproducing apparatus 30 is configured to be able to adjust tension, it is also possible to cope with a change in the width dimension of the magnetic recording medium 10 due to internal distortion of the magnetic recording medium 10 or a change over time. Specifically, the tension is adjusted to be higher than the reference tension in a case where the width dimension of the magnetic recording medium 10 is changed in a widening direction, and the tension is adjusted to be lower than the reference tension in a case where a servo band pitch is changed in a narrowing direction. Information regarding the reference tension at the time of servo pattern recording, the width dimension of the magnetic recording medium 10 at the time of reference tension, or the like is stored in a cartridge memory 9.

The reader writer 37 is configured to be able to record management information in the cartridge memory 9 in response to a command from the control device 38. Furthermore, the reader writer 37 is configured to be able to read management information from the cartridge memory 9 in response to a command from the control device 38. Examples of the management information include product information of the tape cartridge 10A and the magnetic recording medium 10, use history information, an outline of information recorded on the magnetic recording medium 10, and the like. The product information includes manufacturing information, and unique information such as the number of recording tracks 5 of the magnetic recording medium 10, ID, and the like. The use history information includes access date and time, address information, communication history with the reader writer 37, the presence or absence of abnormality at the time of loading/unloading the recording and reproducing apparatus 30, and the like. As a communication method between the reader writer 37 and the cartridge memory 9, for example, an ISO 14443 method is adopted.

The control device 38 includes, for example, a control unit, a storage unit, a communication unit, and the like. The control unit includes, for example, a central processing unit (CPU) and the like, and comprehensively controls each unit of the recording and reproducing apparatus 30 according to a program stored in the storage unit.

The storage unit includes a nonvolatile memory in which various data or various programs are recorded, and a volatile memory used as a work area of the control unit. The various programs described above may be read from a portable recording medium such as an optical disk, a semiconductor memory, or the like, or may be downloaded from a server device on a network. The storage unit temporarily or non-temporarily stores information of the cartridge memory 9 read from the reader writer 37, output of the thermometer 39 and the hygrometer 40, and the like. The communication unit is configured to be able to communicate with other devices such as a personal computer (PC), a server device, and the like.

The drive head 36 is configured to be able to record data on the magnetic recording medium 10 according to a command from the control device 38. Furthermore, the drive head 36 is configured to be able to reproduce data written in the magnetic recording medium 10 in response to a command from the control device 38.

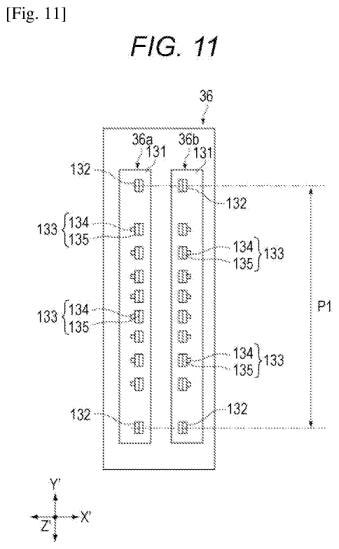

The drive head 36 includes, for example, a head unit including two servo read heads, a plurality of data write/read heads, and the like. FIG. 11 is a schematic view of the drive head 36 as viewed from below (tape running surface).

As illustrated in FIG. 11, the drive head 36 has a first drive head part 36a and a second drive head part 36b. The first drive head part 36a and the second drive head part 36b are configured symmetrically in an X′-axis direction (the running direction of the magnetic recording medium 10 (X-axis direction in FIG. 2)). The first drive head part 36a and the second drive head part 36b are configured to be able to move in a Y′-axis direction (the width direction of the magnetic recording medium 10 (Y-axis direction in FIG. 2)).

The first drive head part 36a is a drive head used when the magnetic recording medium 10 runs in the forward direction (A1 direction in FIG. 10). On the other hand, the second drive head part 36b is a drive head used when the magnetic recording medium 10 runs in the reverse direction (A2 direction in FIG. 10). Since the first drive head part 36a and the second drive head part 36b have basically similar configurations, the first drive head part 36a will be representatively described.

The first drive head part 36a includes a head body 131, two servo read heads 132, and a plurality of data write/read heads 133.

The servo read head 132 is configured to be able to reproduce a servo signal by reading magnetic flux generated from magnetic information recorded in the servo band s of the magnetic recording medium 10 with a magneto-resistive effect element (MR) or the like. That is, the servo signal is reproduced by reading the servo pattern 6 recorded in the servo band s by the servo read head 132.

Each of the servo read heads 132 is provided on each of both end sides of the head body 131 in the width direction (Y′-axis direction in FIG. 11). Examples of the MR element include an anisotropic magneto-resistive effect element (AMR), a giant magneto-resistive effect element (GMR), a tunnel magneto-resistive effect element (TMR), and the like. A servo read head pitch P1 which is an interval in the width direction (Y′-axis direction) of the two servo read heads 132 is set to a center value (2,858.8 μm) of a standard value of a distance (servo band pitch) between two adjacent servo bands s in the magnetic recording medium 10.

The data write/read heads 133 are arranged at equal intervals in the width direction (Y′-axis direction). Furthermore, the data write/read heads 133 are arranged at a position interposed between the two servo read heads 132. The number of data write/read heads 133 is, for example, about 20 to 40, but the number thereof is not particularly limited, and is 32 (32 channels) in the present embodiment.

The data write/read head 133 includes a data write head 134 and a data read head 135. The data write head 134 is configured to be able to record a data signal in the data band d of the magnetic recording medium 10 by a magnetic field generated from a magnetic gap. Furthermore, the data read head 135 is configured to be able to reproduce a data signal by reading a magnetic field generated from magnetic information recorded in the data band d of the magnetic recording medium 10 with an MR element or the like. As the MR element, an anisotropic magneto resistance effect element (AMR), a giant magneto resistance effect element (GMR), a tunnel magneto resistance effect element (TMR), and the like are included.

In the first drive head part 36a, the data write head 134 is arranged on the left side of the data read head 135 (upstream side in a case where the magnetic recording medium 10 flows in the forward direction). On the other hand, in the second drive head part 36b, the data write head 134 is arranged on the right side of the data read head 135 (upstream side in a case where the magnetic recording medium 10 flows in the reverse direction). Note that data read head 135 can reproduce a data signal immediately after the data write head 134 writes the data signal to the magnetic recording medium 10. Note that, instead of the above, the data signal written by the data write head 134 of the first drive head part 36a may be reproduced by the data read head 135 of the second drive head part 36b.

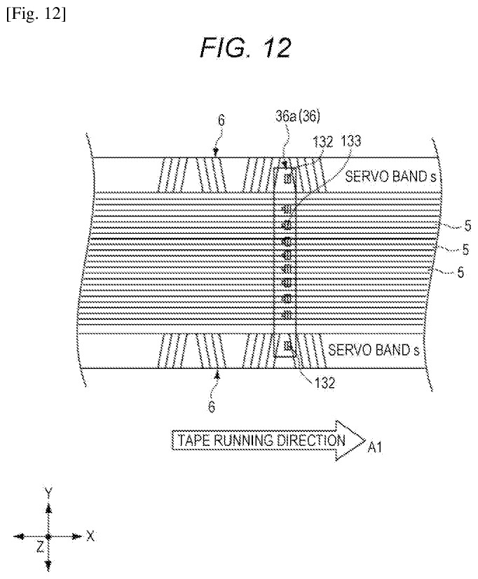

FIG. 12 is a view illustrating a state where the first drive head part 36a performs recording and reproducing of a data signal. Note that, in the example illustrated in FIG. 12, a state when the magnetic recording medium 10 runs in the forward direction (A1 direction) is illustrated.

As illustrated in FIG. 12, when the first drive head part 36a performs recording and reproducing of a data signal, one servo read head 132 of the two servo read heads 132 is positioned on one servo band s of the two adjacent servo bands s and reads the servo pattern 6 on the servo band s. Furthermore, the other servo read head 132 of the two servo read heads 132 is positioned on the other servo band s of the two adjacent servo bands s and reads the servo pattern 6 on the servo band s.

The control device 38 determines whether or not the servo read head 132 accurately traces the target servo trace line T (see FIG. 4) on the basis of the reproduction waveform of the servo pattern 6.

The principle will be described. As illustrated in FIG. 4, in the servo pattern 6, a first stripe group 61 and a second stripe group 62 are inclined in opposite directions with respect to the width direction (Y-axis direction). Therefore, in the servo trace line T on the upper side, a distance between the first stripe group 61 and the second stripe group 62 in the longitudinal direction (X-axis direction) is relatively narrow. On the other hand, on the servo trace line T on the lower side, a distance between the first stripe group 61 and the second stripe group 62 in the longitudinal direction (X-axis direction) is relatively wide. Therefore, when a difference between the time when the reproduction waveform of the first stripe group 61 is detected and the time when the reproduction waveform of the second stripe group 62 is detected is determined, it is possible to know where the servo read head 132 is currently positioned with respect to the magnetic recording medium 10 in the width direction (Y-axis direction).

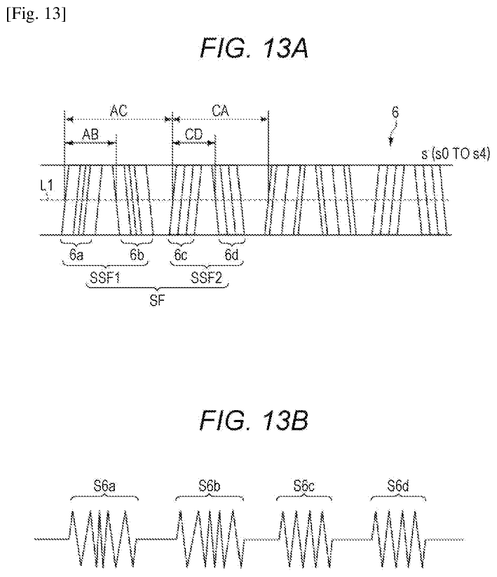

Accordingly, the control device 38 can determine whether or not the servo read head 132 accurately traces on the target servo trace line T on the basis of the reproduction waveform of the servo pattern 6. Then, in a case where the servo read head 132 does not accurately trace on the target servo trace line T, the control device 38 moves the drive head 36 in the width direction (Y′-axis direction) to adjust the position or tracking of the drive head 36. Note that a method of measuring the servo trace line T on which the servo read head 132 traces will be described later (see FIGS. 12 and 13).

Returning to FIG. 12, in a case where the magnetic recording medium 10 fluctuates in the width direction during running of the magnetic recording medium 10, the data write/read head 133 adjusts the position along the servo trace line T and records a data signal in the recording track 5.

When the entire magnetic recording medium 10 is pulled out from the tape cartridge 10A, the magnetic recording medium 10 runs in the reverse direction (A2 direction). At this time, the second drive head part 36b is used as the drive head 36. As the servo trace line T, a servo trace line T adjacent to the previous servo trace line T is used. In this case, the drive head 36 is moved by the interval Ps of the servo trace line T (=recording track width Wd) in the width direction (Y′-axis direction). In this case, the data signal is recorded by the data write head 134 of the second drive head part 36b in the recording track 5 adjacent to the recording track 5 on which the data signal is previously recorded.

As described above, in the magnetic recording medium 10, the data signal is recorded in the recording track 5 while the magnetic recording medium 10 is reciprocated several times by changing the running direction in the forward direction and the reverse direction. For example, it is assumed that the number of servo trace lines T is 100 and the number of data write/read heads 133 included in the first drive head part 36a (alternatively, the second drive head part 36b) is 32. In this case, the number of recording tracks 5 included in one data band d is 100×32, that is, 3,200, and in order to record a data signal on all the recording tracks 5, the magnetic recording medium 10 is reciprocated 50 times.

### (Servo Pattern)

Next, the servo pattern 6 will be described in detail.

The servo pattern 6 has a data structure conforming to the “ECMA-319 standard”. FIG. 13A is a schematic plan view illustrating an arrangement example of the servo patterns 6, and FIG. 13B is a view illustrating a reproduction waveform thereof.

In a timing-based servo type head tracking servo, the servo pattern includes a plurality of azimuthal slope patterns having two or more different shapes. The position of the servo read head 132 is recognized by the time interval at which two inclined patterns having different shapes are read and the time interval at which two inclined patterns having the same shape are read. On the basis of the position of the servo read head 132 thus recognized, the position of the drive head 36 in the width direction (Y-axis direction) of the magnetic recording medium 10 is controlled (see FIGS. 11 and 12).

As illustrated in FIG. 13A, the servo pattern 6 forms a servo frame SF including a first servo sub-frame SSF1 and a second servo sub-frame SSF2. The servo frames SF are arranged in the longitudinal direction of the magnetic recording medium 10 at predetermined intervals in the tape longitudinal direction. Each servo frame SF encodes a single bit of “1” or “0”. That is, one servo frame SF corresponds to one bit.

The first servo sub-frame SSF1 is constituted by an A burst 6a and a B burst 6b. The A burst 6a includes five linear patterns (corresponding to the first stripe group 61 in FIG. 4) inclined in a first direction with respect to the tape longitudinal direction, and the B burst 6b includes five linear patterns (corresponding to the second stripe group 62 in FIG. 4) inclined in a second direction opposite to the first direction described above with respect to the tape longitudinal direction.

On the other hand, the second servo sub-frame SSF2 is constituted by a C burst 6c and a D burst 6d. The C burst 6c includes four linear patterns (corresponding to the first stripe group 61 in FIG. 4) inclined in the first direction described above, and the D burst 6d includes four linear patterns (corresponding to the second stripe group 62 in FIG. 4) inclined in the second direction.

The lengths of the servo frame SF and each of the servo sub-frames SSF1 and SSF2, the arrangement intervals of the inclined portions that incline the respective bursts 6a to 6d, and the like can be arbitrarily set according to the type, specification, and the like of the magnetic recording medium.

The reproduction waveform of the servo pattern 6 typically shows a burst waveform as illustrated in FIG. 13B, and a signal S6a corresponds to the A burst 6a, a signal S6b corresponds to the B burst 6b, a signal S6c corresponds to the C burst 6c, and then a signal S6d corresponds to the D burst 6d.

In the timing-based servo type head tracking servo, a position error signal (PES) is generated by reading the servo pattern 6 on two servo bands adjacent to one data band, and a recording and reproducing head with respect to a recording track in the corresponding data band is appropriately positioned. Typically, the servo pattern 6 is read from the magnetic recording medium 10 running at a predetermined speed, a ratio of a distance (the time interval) AC between the A burst 6a and the C burst 6c that are arrays of the inclined patterns having the same shapes as each other to a distance (the time interval) AB between the A burst 6a and the B burst 6b that are arrays of the inclined patterns having the different shapes from each other (or a ratio of a distance CA between the C burst 6c and the A burst 6a to a distance CD between the C burst 6c and the D burst 6d) is calculated, and the drive head 36 is moved in the tape width direction (Y′-axis direction) so that the value is a setting value set for each recording track (see FIG. 12).

### (Identification of Data Band)

In each of the servo bands s (s0 to s4), servo band identification information in a different combination is written for each data band. For example, a combination of servo band identification information obtained from two servo bands s2 and s3 adjacent to the data band d0 is different from a combination of servo band identification information obtained from the servo bands s1 and s2 adjacent to the data band d1, a combination of servo band identification information obtained from the servo bands s3 and s4 adjacent to the data band d2, and a combination of servo band identification information obtained from two servo bands s0 and s1 adjacent to the data band d3. As described above, the servo band identification information obtained from two servo bands adjacent to one data band is set to be different from the servo band identification information obtained from two servo bands adjacent to the other data band, such that the individual data bands can be identified.

In the present embodiment, two types of servo bands are used to identify the data bands d0 to d4 to be recorded and reproduced. As described above, servo band identification information is embedded in the servo band. The servo band identification information is information of a plurality of bits, and is typically 4 bits, but may be 8 bits or a plurality of bits other than 4 bits and 8 bits.

In the present embodiment, the two types of servo bands described above include a first servo band in which first servo band identification information is recorded and a second servo band in which second servo band identification information is recorded. The first servo band identification information is 4-bit information (for example, “1001”), and the second servo band identification information is 4-bit information (for example, “0111”) different from the first servo band identification information.

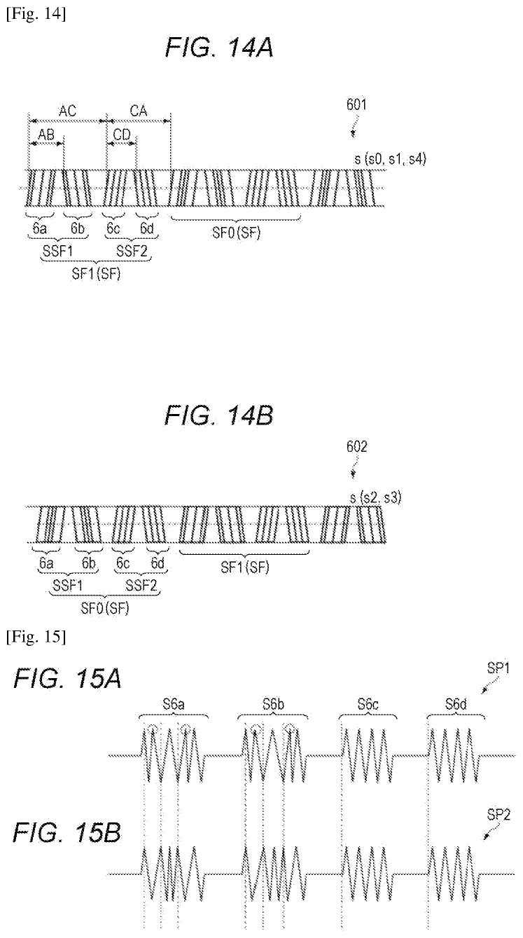

The combination of the signs “0” and “1” constituting the first and second servo band identification information is identified from the reproduction waveform of the servo pattern 6. That is, the reproduction waveform of the servo pattern 6 corresponds to modulated waves of the signs “0” and “1”, and the first and second servo band identification information are read by demodulating the reproduction waveform and combining, for example, four bits. Hereinafter, the first and second servo band identification information will be described with reference to FIGS. 14A, 14B, 15A, and 15B.

FIGS. 14A and 14B are schematic views illustrating configuration examples of a servo pattern in which first servo band identification information is embedded (hereinafter, also referred to as a first servo pattern 601) and a servo pattern in which second servo band identification information is embedded (hereinafter, also referred to as a second servo pattern 602), respectively. As illustrated in the same drawing, the first servo pattern 601 and the second servo pattern 602 are both constituted by a combination of two types of servo frames SF including a servo frame SF1 representing one sign (for example, “1”) and a servo frame SF0 representing the other sign (for example, “0”). The servo frames SF1 and SF0 are common in that the servo frame SF including the first servo sub-frame SSF1 and the second servo sub-frame SSF2 is used as a constituent unit, but the first servo sub-frames SSF1 (A burst 6a and B burst 6b) are different from each other.

As illustrated in FIG. 14A, in the servo frame SF1 indicating the sign “1”, when five inclined patterns respectively constituting the A burst 6a and the B burst 6b are defined as a first inclined portion, a second inclined portion, a third inclined portion, a fourth inclined portion, and a fifth inclined portion in order from the left side in the drawing, the second and fourth inclined portions are arranged at positions biased toward the first and fifth inclined portions, respectively. On the other hand, as illustrated in FIG. 14B, in the servo frame SF0 representing the sign “0”, the arrangement intervals of some of the inclined patterns constituting the A burst 6a and the B burst 6b are different from those of the servo frame SF1. In the illustrated example, in the five inclined patterns constituting each of the A burst 6a and the B burst 6b, the second and fourth inclined portions are arranged at positions biased toward the third inclined portion, respectively. Therefore, as for the A burst 6a and the B burst 6b in the servo frame SF0, the interval between the second inclined portion and the third inclined portion and the interval between the third inclined portion and the fourth inclined portion are shortest, and the interval between the first inclined portion and the second inclined portion and the interval between the fourth inclined portion and the fifth inclined portion are longest.

FIGS. 15A and 15B illustrate reproduction waveforms SP1 and SP2 of the first servo pattern 601 and the second servo pattern 602, respectively. The reproduction waveform of each of the servo frames SF1 and SF0 is constituted by a burst signal having a peak at a position corresponding to the inclined portion of each of the burst portions 6a to 6d. As described above, in the servo frame SF0, since the configurations of the A burst 6a and the B burst 6b are different from those of the A burst 6a and the B burst 6b of the servo frame SF1, the peak positions of the burst signals S6a and S6b are shifted corresponding to the interval between the different inclined portions. Therefore, it is possible to read the information written in the servo frame SF by detecting the portion where a deviation of the peak position occurs, a deviation amount thereof, and a deviation direction. Here, for example, the servo frame SF1 illustrated in FIG. 15A represents one bit “1”, and the servo frame SF0 illustrated in FIG. 15B represents another one bit “0”. The first and second servo band identification information can be configured by arbitrarily combining the two servo frames SF1 and SF0, for example, four bits.

### (Method of Measuring Servo Band Pitch)

Next, a method of measuring the servo band pitch of the magnetic recording medium 10 will be described. The servo band pitch is measured in an environment of a temperature of 25° C.±3° C. and a humidity of 50%±5%.

Here, the servo band pitch is an index indicating a distance between two servo bands (servo bands s2 and s3) adjacent to one data band (for example, data band d0). More specifically, the servo band pitch refers to a distance between the center of the servo pattern recorded in one servo band of the two servo bands described above and the center of the servo pattern recorded in the other servo band. Furthermore, in the following description, the servo band pitch may be used as a difference from a servo read head pitch P1 (see FIG. 11).

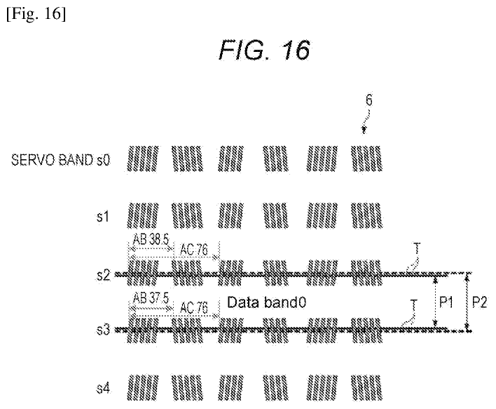

The servo band pitch is measured by the recording and reproducing apparatus 30. Here, as illustrated in FIG. 16, an example in which the drive head 36 tracks the data band d0 interposed between the servo band s2 and the servo band s3 will be described.

As described above, in the method of measuring the servo band pitch using the recording and reproducing apparatus 30, the magnetic recording medium 10 is caused to run by the recording and reproducing apparatus 30, the servo trace line T on each servo band of the two servo read heads 132 is measured, and the servo band pitch is measured from the relative position of each measured servo trace line T with respect to the servo pattern 6.

The interval between the servo trace lines T indicated by a solid line in FIG. 16 indicates a servo band pitch (servo read head pitch P1 which is an arrangement interval of two servo read heads 132 of the drive head 36) when the width of the magnetic recording medium 10 does not change. Furthermore, an interval between the servo trace lines T indicated by a broken line in FIG. 16 corresponds to a servo band pitch P2 when the width of the magnetic recording medium 10 is increased.

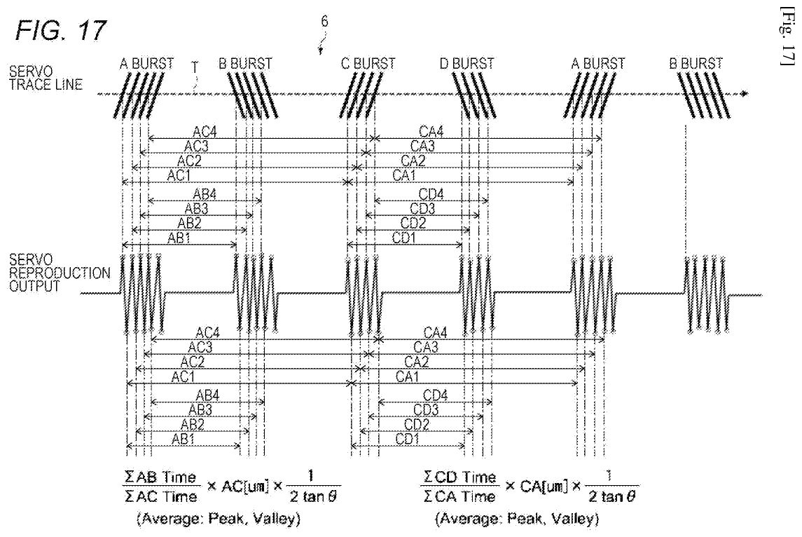

FIG. 17 is a view for explaining a method of measuring the servo trace line T. The recording and reproducing apparatus 30 outputs a servo reproduction signal having a waveform corresponding to the position of the servo trace line T with respect to the servo pattern 6 (see FIGS. 15A and 15B). Typically, a distance AC between the A burst and the C burst that are arrays of the inclined patterns having the same shapes as each other, and a distance AB between the A burst and the B burst that are arrays of the inclined patterns having different shapes from each other are calculated, and the position of the servo trace line T of each servo read head 132 is measured by the following [Math. 2]. Note that 0 is an azimuth angle of each of the inclined patterns described above corresponding to an angle α in FIG. 4, and is 12° in the present example.

$$\frac{Σ AB Time}{Σ AC Time} \times AC [ um ] \times \frac{1}{2 tan θ} \qquad [ Math . 2 ]$$

Here, the distance AC may be a distance AC1 between the first inclined portions of the A burst and the C burst, a distance AC2 between the second inclined portions thereof, a distance AC3 between the third inclined portions thereof, or a distance AC4 between the fourth inclined portions thereof. These distances AC (AC1 to AC4) refer to distances between positions (upper peak positions) indicating a positive maximum value of an amplitude in the servo reproduction waveform.

Similarly, the distance AB also may be a distance AB1 between the first inclined portions of the A burst and the B burst, a distance AB2 between the second inclined portions thereof, a distance AB3 between the third inclined portions thereof, or a distance AB4 between the fourth inclined portions thereof. Typically, the distance AB1 is adopted in a case where the distance AC1 is adopted, the distance AB2 is adopted in a case where the distance AC2 is adopted, the distance AB3 is adopted in a case where the distance AC3 is adopted, and the distance AB4 is adopted in a case where the distance AC4 is adopted.

Then, the servo band pitch is determined from a difference between the numerical values representing the positions of the respective servo trace lines T on the servo pattern obtained from the ratios of the distance AB and the distance AC calculated using the equation [Math. 2]. Here, the difference between the measured value of the servo band (servo band s2) in the tape center and the measured value of the servo band (servo band s3) on the tape edge of the two servo bands to be measured is taken. A positive or negative value thereof means a direction of change in tape width. A case where it is a positive value corresponds to narrowing of the servo band pitch, and a case where it is a negative value corresponds to widening of the servo band pitch. A case where the difference described above is zero means that there is no fluctuation in the tape width.

The servo band pitch is preferably determined from a difference between a large number of servo frames, and may be, for example, an average value of measured values calculated from differences between 100 to 100,000 servo frames. The tape tension at the time of measurement is a tension (reference tension, for example, 0.55 N) at the time of recording of the servo pattern 6, and measurement is performed at a constant tension over the entire length of the magnetic recording medium 10.

Note that the method of measuring the servo trace line T is not limited to the example described above, and for example, the distance CA between the C burst and the A burst and the distance CD between the C burst and the D burst may be calculated, and the position of the servo trace line T may be measured by the following [Math. 3].

$$\frac{Σ CD Time}{Σ CA Time} \times CA [ um ] \times \frac{1}{2 tan θ} \qquad [ Math . 3 ]$$

Here, the distance CA may be a distance CA1 between the first inclined portions of the C burst and the A burst, a distance CA2 between the second inclined portions thereof, a distance CA3 between the third inclined portions thereof, or a distance CA4 between the fourth inclined portions thereof. These distances CA (CA1 to CA4) refer to distances between positions indicating a positive maximum value of an amplitude in the servo reproduction waveform.

Similarly, the distance CD also may be a distance CD1 between the first inclined portions of the C burst and the D burst, a distance CD2 between the second inclined portions thereof, a distance CD3 between the third inclined portions thereof, or a distance CD4 between the fourth inclined portions thereof. Typically, the distance CD1 is adopted in a case where the distance CA1 is adopted, the distance CD2 is adopted in a case where the distance CA2 is adopted, the distance CD3 is adopted in a case where the distance CA3 is adopted, and the distance CD4 is adopted in a case where the distance CA4 is adopted.

Moreover, for the measurement of the servo band pitch, an average value of the measured value using the equation [Math. 2] and the measured value using the equation [Math. 3] may be used. Moreover, as the distances AC and AB in the equation [Math. 2] and the distances CA and CD in the equation [Math. 3], the distances between the positions (lower peak positions) indicating the negative maximum value of the amplitude in the servo reproduction waveform may be adopted. Alternatively, as the distances AC and AB in the equation [Math. 2] and the distances CA and CD in the equation [Math. 3], an average value of the distances between the positions (upper peak positions) indicating the positive maximum value and the distances between the positions (lower peak positions) indicating the negative maximum value of the amplitudes in the servo reproduction waveform may be adopted.

As illustrated in FIG. 16, in a case where the servo trace line T is at a position indicated by a broken line, the distance AB is 38.5 μm and the distance AC is 76 μm in the servo band s2, and the distance AB is 37.5 μm and the distance AC is 76 μm in the servo band s3.

In the servo band s2,

$$( 3 8.5 / 76 ) \times ( 76 / 2 tan 12 ° ) = 90.5641 [ μ m ] ,$$

in the servo band s3,

$$( 3 7.5 / 76 ) \times ( 76 / 2 tan 12 ° ) = 88.2118 [ μ m ] .$$

A difference between these values is

$$88.2118 - 90.5641 = - 2.3 \; 523 [ μm ] .$$

Therefore, the servo band pitch P2 in this case is determined as a value wider than the servo read head pitch P1 by 2.3523 μm.

Note that, as illustrated in FIG. 16, in a case where the servo trace line T is at a position indicated by a broken line, in both the servo band s2 and the servo band s3, the distance AB is 38 μm and the distance AC is 76 μm. In this case, both the servo band s2 and the servo band s3 are 89.3880 [μm], and a difference therebetween is 0 [μm]. That is, the servo band pitch in this case means that it is the same as the servo read head pitch P1.

### (Tension Control)

The recording and reproducing apparatus 30 controls the tension of the magnetic recording medium 10 so that the measured servo pattern pitch is the same as the servo read head pitch P1 based on the servo pattern pitch measured as described above.

In the present embodiment, before recording data on the magnetic recording medium 10 or reproducing data from the magnetic recording medium 10, servo signals are read from two servo bands interposing one data band for recording or reproducing data, and it is determined from each read servo signal whether or not the two servo band pitches are wider or narrower than the servo read head pitch P1. In a case where the servo band pitch is wider than the servo read head pitch P1, the tension is increased, and in a case where the servo band pitch is narrower than the servo read head pitch P1, the tension is decreased. By adjusting a magnitude of the tension according to a magnitude of the servo band pitch in this manner, desired tracking control for the corresponding data band can be stably performed.

The recording and reproducing apparatus 30 acquires the relationship between the servo band pitch and the tension for one data band by one round trip tape running, and records the acquired data in the cartridge memory 9. The recording and reproducing apparatus 30 similarly applies the relationship between the servo band pitch and the tension measured for the one data band described above to the recording and reproducing of data for another data band.

### (6) Example of Servo Pattern Recording Apparatus

### (Configuration of Servo Pattern Recording Apparatus)

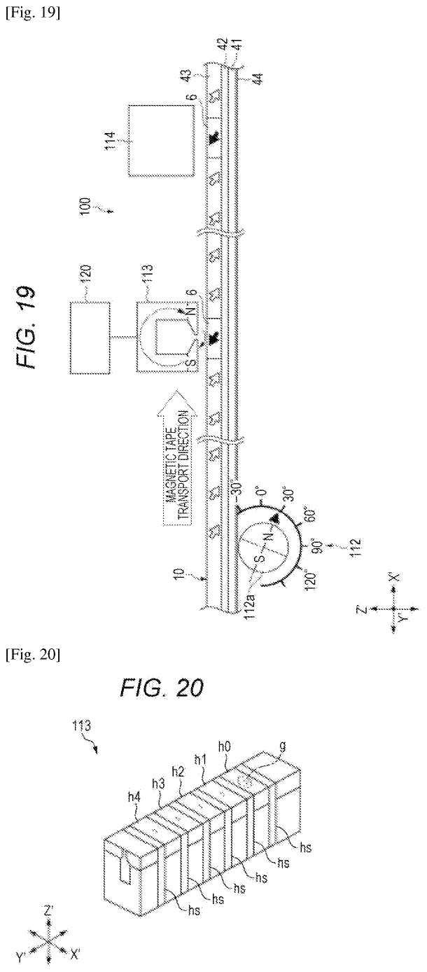

Next, a configuration of an example of a servo pattern recording apparatus that records the servo pattern 6 on the servo band s of the magnetic recording medium 10 will be described. FIG. 18 is a schematic front view illustrating a servo pattern recording apparatus 100 according to an embodiment of the present technology. FIG. 19 is a partially enlarged view of a part of the servo pattern recording apparatus 100.

The servo pattern recording apparatus 100 includes a feed roller 111, a pre-processing unit 112, a servo write head 113, a reproducing head unit 114, and a winding roller 115 in this order from the upstream side in a transport direction of the magnetic recording medium 10. The servo pattern recording apparatus 100 further includes a drive unit 120 and a controller 130. The controller 130 includes a control unit that comprehensively controls the respective units of the servo pattern recording apparatus 100, a storage unit that stores various programs and various types of data required for processing of the control unit, a display unit that displays data, an input unit that inputs data, and the like.

The feed roller 111 can rotatably support the roll-shaped magnetic recording medium 10 (before the servo pattern 6 is recorded). The feed roller 111 is rotated in accordance with driving of a drive source such as a motor or the like, and feeds the magnetic recording medium 10 toward the downstream side in accordance with the rotation.

The winding roller 115 can rotatably support the roll-shaped magnetic recording medium 10 (after the servo pattern 6 is recorded). The winding roller 115 rotates in synchronization with the feed roller 111 in accordance with driving of the drive source such as a motor or the like, and winds the magnetic recording medium 10 in which the servo pattern 6 is recorded in accordance with the rotation. The feed roller 111 and the winding roller 115 can move the magnetic recording medium 10 at a constant speed on the transport path.

The servo write head 113 is arranged, for example, above the magnetic recording medium 10 (magnetic layer 43 side). The servo write head 113 may be arranged below the magnetic recording medium 10 (base layer 41 side). The servo write head 113 generates a magnetic field at a predetermined timing according to a rectangular wave pulse signal, and applies the magnetic field to a part of the magnetic layer 43 (after preprocessing) included in the magnetic recording medium 10.

Therefore, the servo write head 113 magnetizes a part of the magnetic layer 43 in a first direction and records the servo pattern 6 in the magnetic layer 43 (for the magnetization direction, see the black arrow in FIG. 19). When the magnetic layer 43 passes under the servo write head 113, the servo write head 113 can record the servo pattern 6 for each of the five servo bands s0 to s4.

The first direction that is the magnetization direction of the servo pattern 6 includes a component in a direction perpendicular to the upper surface of the magnetic layer 43. That is, in the present embodiment, the magnetic layer 43 contains magnetic powder vertically oriented or not oriented, and thus the servo pattern 6 to be recorded in the magnetic layer 43 includes a magnetization component in the vertical direction.

The pre-processing unit 112 is arranged, for example, below (base layer 41 side) of the magnetic recording medium 10 on the upstream side of the servo write head 113. The pre-processing unit 112 may be arranged above the magnetic recording medium 10 (magnetic layer 43 side). The pre-processing unit 112 includes a permanent magnet 112a rotatable about a center axis of rotation in the Y′-axis direction (the width direction of the magnetic recording medium 10 in FIG. 19. A shape of the permanent magnet 112a is, for example, a cylindrical shape or a polygonal columnar shape, but is not limited thereto.

Before the servo pattern 6 is recorded by the servo write head 113, the permanent magnet 112a applies a magnetic field to the entire magnetic layer 43 by a direct-current magnetic field to demagnetize the entire magnetic layer 43. Therefore, the permanent magnet 112a can magnetize the magnetic layer 43 in advance in the second direction opposite to the magnetization direction of the servo pattern 6 (in FIG. 19, see the white arrow). As described above, the two magnetization directions are set to be opposite directions, respectively, such that the reproduction waveforms of the servo signals obtained by reading the servo pattern 6 can be symmetrical in a vertical direction (±).

Note that, as a method of adjusting the second direction described above, for example, a rotation angle of the permanent magnet 112a may be arbitrary, the servo pattern 6 may be recorded in the magnetic layer 43 after the entire magnetic layer 43 is demagnetized, and the rotation angle of the permanent magnet 112a with the width direction of the magnetic recording medium 10 as a center may be adjusted on the basis of the inclination of the reproduction waveform.

The reproducing head unit 114 is arranged above the magnetic recording medium 10 (magnetic layer 43 side) on the downstream side of the servo write head 113. The reproducing head unit 114 reads the servo pattern 6 described above from the magnetic layer 43 of the magnetic recording medium 10 in which the servo pattern 6 is preprocessed by the pre-processing unit 112 and is recorded by the servo write head 113. The reproduction waveform of the servo pattern 6 read by the reproducing head unit 114 is displayed on a screen of the display unit. Typically, the reproducing head unit 114 detects the magnetic flux generated from the surface of the servo band s when the magnetic layer 43 passes under the reproducing head unit 114. The magnetic flux detected at this time becomes a reproduction waveform of the servo pattern 6 as a servo signal.

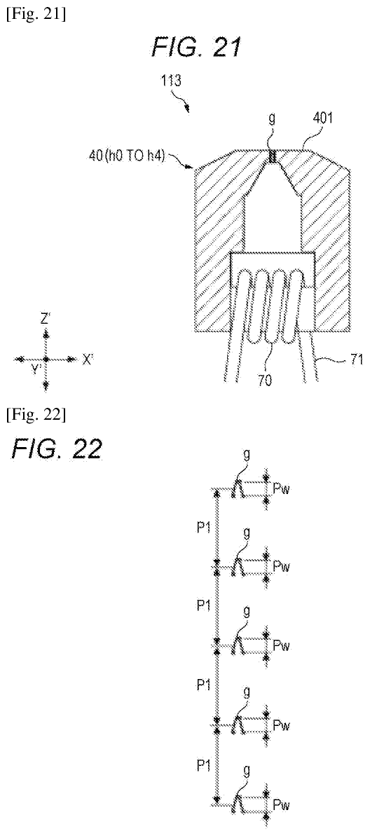

FIG. 20 is a perspective view schematically illustrating a configuration of the servo write head 113, FIG. 21 is a schematic cross-sectional view of a main part of the servo write head 113, and FIG. 22 is a schematic plan view of the main part of the servo write head 113.

As illustrated in FIGS. 20 and 21, the servo write head 113 includes a plurality of magnetic cores h0 to h4 for recording the servo pattern 6 on each of the servo bands s0 to s4 of a magnetic tape 1, and adhesive layers hs joining the magnetic cores h0 to h4.

Each of the magnetic cores h0 to h4 includes a head block 40 including a soft magnetic material such as sendust, permalloy, ferrite, or the like, and a coil 70 wound around a head block 40. Each of the magnetic cores h0 to h4 constitutes a recording unit 401 arranged corresponding to each of the servo bands s0 to s4 of the magnetic recording medium 10, and has a magnetic gap g for recording the servo pattern 6 in each servo band s.

The magnetic gap g is constituted by a pair of straight line portions (“/” and “\”) that are inclined in opposite directions. One straight line portion “/” and the other straight line portion “\” record the A burst 6a and the C burst 6c, and the B burst 6b and the D burst 6d, respectively. The magnetic gaps g of head blocks h1 to h5 are arranged so as to be aligned on an axis parallel to the longitudinal direction (Y′ direction) of the servo write head 113. An arrangement interval of the magnetic gaps g is a distance between the centers in a pattern width Pw in the longitudinal direction of the servo write head 113, and the size thereof is the servo read head pitch P1. The magnetic cores h0 to h4 are magnetically separated from each other, and are configured to be able to simultaneously record different types of servo patterns 6 in two or more servo bands.

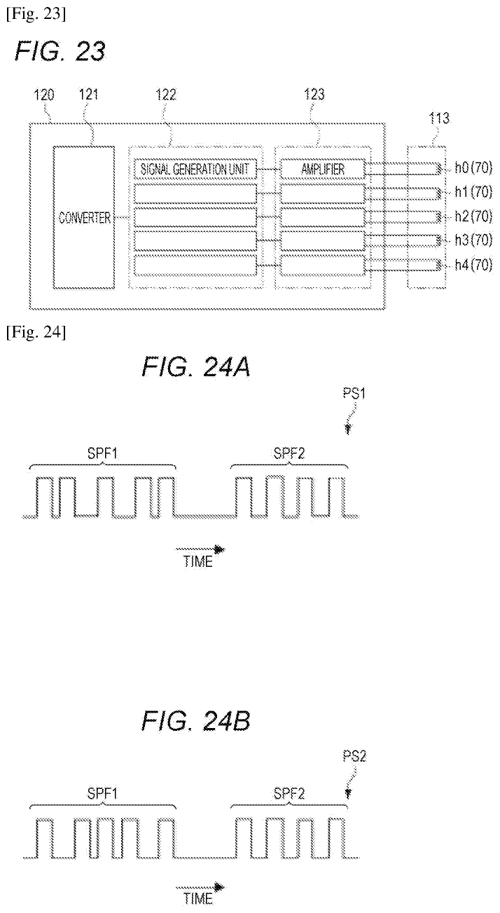

FIG. 23 is a block diagram illustrating a configuration of the drive unit 120. As illustrated in FIG. 23, drive unit 120 includes a converter 121 that converts servo information into pulse information on the basis of an output from the controller 130 (see FIG. 18), a signal generation unit 122 that generates a pulse signal on the basis of an output of the converter 121, and an amplifier 123 that amplifies the generated pulse signal. A plurality of signal generation units 122 and a plurality of amplifiers 123 are provided corresponding to the magnetic cores h0 to h4, respectively, and are configured to be able to output unique pulse signals to the coils 70 wound around the magnetic cores h0 to h4, respectively.

The controller 130 includes a memory that stores data regarding the positions of the servo bands (in this example, the servo bands s0, s1, and s4) in which the first servo band identification information is to be recorded and the positions of the servo bands (in this example, the servo bands s2 and s3) in which the second servo band identification information is to be recorded. The controller 130 controls the drive unit 120 on the basis of the data stored in the memory.

The converter 121 individually outputs pieces of information corresponding to the servo band identification information to be recorded in the respective servo bands s0 to s4 to the signal generation units 122 corresponding to the respective magnetic cores h0 to h4. In the present embodiment, a first pulse signal PS1 for recording the first servo pattern 601 (FIG. 14A) including the first servo band identification information is output to the magnetic cores h0, h1, and h4 corresponding to the servo bands s0, s1, and s4, respectively, and a second pulse signal PS2 for recording the second servo pattern 602 (FIG. 14B) including the second servo band identification information is output to the head blocks h2 and h3 corresponding to the servo bands s2 and s3, respectively.

FIGS. 24A and 24B schematically illustrate the recording signal waveforms of the first servo sub-frames SSF1 in the first pulse signal PS1 and the second pulse signal PS2, respectively. As illustrated in the drawings, the first and second pulse signals PS1 and PS2 include a first pulse group SPF1 including five pulse groups and a second pulse group SPF2 including four pulse groups. The first pulse group SPF1 is a signal for recording each inclined portion of the A burst 6a, and the second pulse group SPF2 is a signal for recording each inclined portion of the B burst 6b.

As illustrated in FIGS. 24A and 24B, second and fourth pulse rise times in the first pulse group SPF1 are different between the first pulse signal PS1 and the second pulse signal PS2, and second pulse rise time of the pulse signal PS2 is later than that of the pulse signal PS1, and is earlier than that of the fourth pulse rise time. Therefore, the first servo sub-frame SSF1 in which the arrangement intervals of the inclined portions of the A burst 6a are partially different from each other as illustrated in FIGS. 14A and 14B is formed.

Moreover, the first pulse signal PS1 and the second pulse signal PS2 are transmitted to the magnetic cores h0 to h4 at the same phase (the same timing). Therefore, in each of the magnetic cores h0 to h4, the first servo pattern 601 (first servo band identification information) is recorded in the servo bands s0, s1, and s4, and the second servo pattern 602 (second servo band identification information) is recorded in the servo bands s2 and s3, in the same phase.

### (7) Other Examples of Recording and Reproducing Apparatus

### (Other Examples of Recording and Reproducing Apparatus)

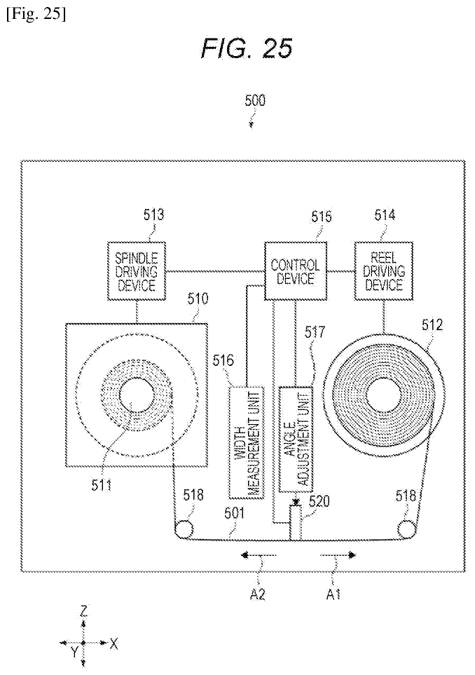

FIG. 25 is a view illustrating a recording and reproducing apparatus 500. The recording and reproducing apparatus 500 can record data on a magnetic recording medium 501 and can reproduce the data recorded on the magnetic recording medium 501.

The recording and reproducing apparatus 500 is configured to be able to load a cartridge 510. The cartridge 510 is configured to be able to rotatably accommodate the wound magnetic recording medium 501 therein. The recording and reproducing apparatus 500 may be configured to be able to load one cartridge 510, and may also be configured to be able to load a plurality of cartridges 510 at the same time.

The recording and reproducing apparatus 500 includes a spindle 511, a winding reel 512, a spindle driving device 513, a reel driving device 514, a data write head 520, a control device 515, a width measurement unit 516, an angle adjustment unit 517, and a plurality of guide rollers 518.

The spindle 511 is configured to be able to rotate the magnetic recording medium 501 accommodated in the cartridge 510 by its rotation. The spindle driving device 513 rotates the spindle 511 according to a command from the control device 515.

The winding reel 512 is configured to be able to fix a tip of the magnetic recording medium 501 pulled out from the cartridge 510 via a tape loading mechanism (not illustrated). The reel driving device 514 rotates the winding reel 512 according to a command from the control device 515.

The plurality of guide rollers 518 guide the running of the magnetic recording medium 501 so that a transport path formed between the cartridge 510 and the winding reel 512 has a predetermined relative positional relationship with respect to the data write head 520.

The data write head 520 is configured to be able to record data in the data band d (recording track 5) of the magnetic recording medium 501 in response to a command from the control device 515 when the magnetic recording medium 501 passes under the data write head 520, and is configured to be able to reproduce the recorded data.

When data is recorded/reproduced on the magnetic recording medium 501 by the data write head 520, the spindle 511 and the winding reel 512 are rotated by the spindle driving device 513 and the reel driving device 514, and the magnetic recording medium 501 runs. As for the running direction of the magnetic recording medium 501, the magnetic recording medium 501 can reciprocate in the forward direction (direction of unwinding from the spindle 511 to the winding reel 512) indicated by the arrow A1 and the reverse direction (direction of rewinding from the winding reel 512 to the spindle 511) indicated by the arrow A2 in FIG. 25.

The data write head 520 can record/reproduce data in both directions of the running in the forward direction and the running in the reverse direction of the magnetic recording medium 501.

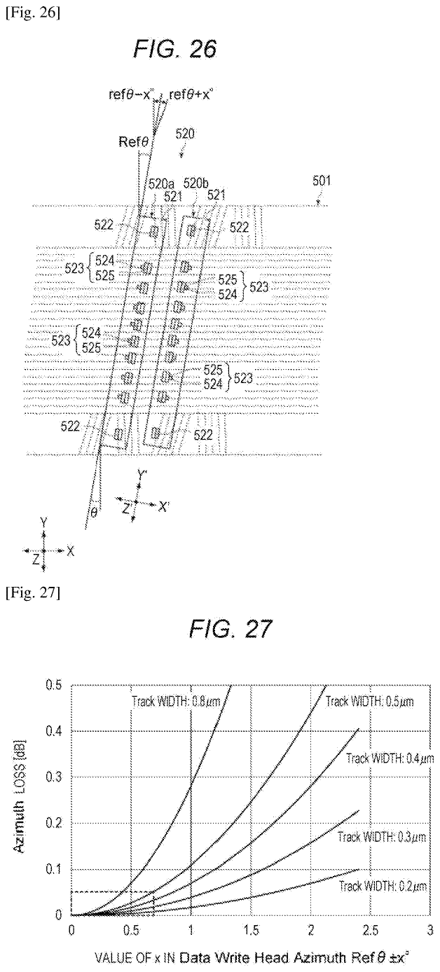

In particular, in the present embodiment, the data write head 520 is arranged so that the longitudinal direction (Y′-axis direction) of the data write head 520 is inclined at a predetermined angle θ (first head azimuth angle θ) with respect to the width direction (Y-axis direction) of the magnetic recording medium 501 (see FIG. 26 described later).

In the description of the present embodiment, an angle at which the longitudinal direction (Y′-axis direction) of the data write head 520 is inclined with respect to the width direction (Y-axis direction) of the magnetic recording medium 501 is referred to as an azimuth angle θ of the data write head 520. Note that details of the configuration of the data write head 520 will be described later with reference to FIG. 26 and the like.

The width measurement unit 516 is configured to be able to measure the width of the magnetic recording medium 501 when the magnetic recording medium 501 passes under the width measurement unit 516. That is, the width measurement unit 516 is configured to be able to measure the width of the magnetic recording medium 501 when the data write head 520 performs recording and reproducing of data on and from the magnetic recording medium 501. The width measurement unit 516 measures the width of the magnetic recording medium 501 and transmits the width to the control device 515.

The width measurement unit 516 includes, for example, various sensors such as an optical sensor and the like. As the width measurement unit 516, any sensor may be used as long as the sensor can measure the width of the magnetic recording medium 501. Note that the width of the magnetic recording medium 501 can also be predicted by reading adjacent servo patterns 6 and obtaining a difference between position signals. In this case, the width measurement unit 516 can be omitted.

The angle adjustment unit 517 is configured to be able to hold the data write head 520 so as to be rotatable about a vertical axis (Z axis). The angle adjustment unit 517 is configured to be able to adjust the azimuth angle θ of the data write head 520 according to a command from the control device 515.

The control device 515 includes, for example, a control unit, a storage unit, a communication unit, and the like. The control unit includes, for example, a central processing unit (CPU) and the like, and comprehensively controls each unit of the recording and reproducing apparatus 500 according to a program stored in the storage unit.

The storage unit includes a nonvolatile memory in which various data or various programs are recorded, and a volatile memory used as a work area of the control unit. The various programs described above may be read from a portable recording medium such as an optical disk, a semiconductor memory, or the like, or may be downloaded from a server device on a network. The communication unit is configured to be able to communicate with other devices such as a personal computer (PC), a server device, and the like.

In particular, in the present embodiment, the control device 515 (control unit) acquires information of the width of the magnetic recording medium 501 from the width measurement unit 516 (alternatively, the width of the magnetic recording medium is predicted from the servo signal), and adjusts the azimuth angle θ (see FIG. 26) of the data write head 520 by the angle adjustment unit 517 on the basis of the information of the width of the magnetic recording medium 501.

In the present embodiment, the azimuth angle θ of the data write head 520 is adjusted to cope with the fluctuation in the width of the magnetic recording medium 501. Typically, when the width of the magnetic recording medium 501 becomes relatively wide, the azimuth angle θ of the data write head 520 is decreased, and conversely, when the width of the magnetic recording medium 501 becomes relatively narrow, the azimuth angle θ of the data write head 520 is increased.

The width of the magnetic recording medium 501 may fluctuate, for example, for various reasons such as the temperature, the humidity, the tension applied to the magnetic recording medium 501 in the longitudinal direction, and the like.

### (Data Write Head 520)

Next, the configuration of the data write head 520 will be described in detail. FIG. 26 is a schematic view of the data write head 520 as viewed from below (back layer side).

In the description of the data write head 520, a longitudinal direction of the data write head 520 is a Y′-axis direction, a width direction of the data write head 520 is an X′-axis direction, and a vertical direction of the data write head 520 is a Z′-axis direction. Furthermore, a longitudinal direction (running direction) of the magnetic recording medium 501 is defined as an X-axis direction, a width direction of the magnetic recording medium 501 is defined as a Y-axis direction, and a thickness direction of the magnetic recording medium 501 is defined as a Z-axis direction. Note that the direction of the magnetic recording medium 501 is based on the direction of the magnetic recording medium 501 when passing under the data write head 520.

As illustrated in FIG. 26, the data write head 520 includes a first data write head 520a and a second data write head 520b. Note that, in the description in the present specification, in a case where the two data write heads 520 are not particularly distinguished, the data write heads are collectively referred to simply as a data write head 520, and in a case where the two data write heads 520 are particularly distinguished, the data write heads are referred to as a first data write head 520a and a second data write head 520b.

The first data write head 520a and the second data write head 520b are configured as targets of the data write head 520 in the width direction (Y′-axis direction), and basically have similar configurations. The first data write head 520a and the second data write head 520b are integrally movable in the width direction (Y-axis direction) of the magnetic recording medium 501, and therefore, data can be written in any data band d of all the data bands d0 to d3.

The first data write head 520a is a head used when the magnetic recording medium 501 runs in the forward direction (A1 direction in FIG. 25). On the other hand, the second data write head 520b is a head used when the magnetic recording medium 501 runs in the reverse direction (A2 direction in FIG. 25).

The data write head 520 has a facing surface 521 facing the magnetic recording medium 501. The facing surface 521 has a shape that is long in the longitudinal direction (Y′-axis direction) of the data write head 520 and is short in the width direction (X′-axis direction) of the data write head 520. The facing surface 521 is provided with two servo read units 522 and a plurality of data write/read units 523.

One servo read unit 522 is provided on each end of the data write head 520 in the longitudinal direction (Y′-axis direction). The servo read unit 522 is configured to be able to reproduce a servo signal by reading a magnetic field by the servo pattern 6 recorded in the servo band s of the magnetic recording medium 501 with a magneto-resistive effect element (MR) or the like.

As the MR element, for example, an anisotropic magneto-resistive effect element (AMR), a giant magneto-resistive effect element (GMR), a tunnel magneto-resistive effect element (TMR), or the like is used.

The data write/read units 523 are arranged at equal intervals in the longitudinal direction (Y′-axis direction) of the data write head 520. Furthermore, the data write/read units 523 are arranged at a position interposed between the two servo read units 522. The number of data write/read units 523 is, for example, about 20 to 40, but the number is not particularly limited.

The data write/read unit 523 includes a data write unit 524 and a data read unit 525. The data write unit 524 is configured to be able to record data in the data band d of the magnetic recording medium 501 by a magnetic field generated from a magnetic gap.

Furthermore, the data read unit 525 is configured to be able to reproduce a data signal by reading a magnetic field by the data recorded in the data band d of the magnetic recording medium 501 with an MR element or the like. As the MR element, an anisotropic magneto resistance effect element (AMR), a giant magneto resistance effect element (GMR), a tunnel magneto resistance effect element (TMR), or the like used.

In the first data write head 520a, the data write unit 524 is arranged on the left side of the data read unit 525 (upstream side in a case where the magnetic recording medium 501 flows in the forward direction).

On the other hand, in the second data write head 520b, the data write unit 524 is arranged on the right side of the data read unit 525 (upstream side in a case where the magnetic recording medium 501 flows in the reverse direction).

The data read unit 525 can reproduce the data signal immediately after the data write unit 524 paired with the data read unit 525 writes the data to the magnetic recording medium 501. Note that, instead of the above, data written by the data write unit 524 of one data write head 520 of the first data write head 520a and the second data write head 520b may be reproduced by the data read unit 525 of the other data write head 520.

In the magnetic recording medium 501, the data is recorded in the recording track 5 by the first data write head 520a and the second data write head 520b while the magnetic recording medium 501 is reciprocated several times by changing the running direction in the forward direction and the reverse direction.

The angle adjustment unit 517 can hold the first data write head 520a and the second data write head 520b rotatably around the vertical axis (Z′-axis). Furthermore, the angle adjustment unit 517 can individually rotate the first data write head 520a and the second data write head 520b around the vertical axis.

The angle adjustment unit 517 adjusts angles of the first data write head 520a and the second data write head 520b so that the longitudinal directions of the first data write head 520a and the second data write head 520b are arranged to be inclined at the azimuth angle θ with respect to the width direction of the magnetic recording medium 501.

Here, the positions of the servo read unit 522 and the data write/read unit 523 of the first data write head 520a in the Y-axis direction (the width direction of the magnetic recording medium 501) are the same as the positions of the servo read unit 522 and the data write/read unit 523 of the second data write head 520b in the Y-axis direction. These positional relationships do not change even when the first data write head 520a and the second data write head 520b rotate about the Z axis.

That is, the angle adjustment unit 517 can individually rotate the first data write head 520a and the second data write head 520b so that the positions of the servo read unit 522 and the data write/read unit 523 of the first data write head 520 in the Y-axis direction (the width direction of the magnetic recording medium 501) are the same as the positions of the servo read unit 522 and the data write/read unit 523 of the second data write head 520b in the Y-axis direction.

In the present embodiment, a reference angle Refθ serving as a reference is set with respect to the azimuth angle θ of the data write head 520, and an angular range represented by the reference angle Refθ±x° is set as the azimuth angle θ of the data write head 520.

In the example illustrated in FIG. 26, an example in a case where the reference angle Refθ is set in the clockwise direction (lower side: viewed from the magnetic recording medium 501 side) with respect to the width direction of the magnetic recording medium 501 is illustrated. On the other hand, the reference angle Refθ may be set in the clockwise direction (lower side: viewed from the magnetic recording medium 501 side) with respect to the width direction of the magnetic recording medium 501.

### (Reference Angle Refθ, Angular Range Refθ±x°, and the Like)

Next, the reference angle Refθ at the azimuth angle θ of the data write head 520 and the angular range Refθ±x° at the azimuth angle θ of the data write head 520 will be described.

FIG. 27 is a view illustrating a relationship between the angular range Refθ±x° of the azimuth angle θ and an azimuth loss Lθ of the data write head 520 (recording wavelength: 0.1 μm). In FIG. 27, the horizontal axis indicates the value of x in the angular range Refθ±x° of the azimuth angle θ of the data write head 520, and the vertical axis indicates the azimuth loss Lθ.

The azimuth loss Lθ [dB] is represented by the following equation.

$$L θ = - 20 Log 10 [ sin \{ ( πW / λ ) tan θ \} / ( πW / λ ) tan θ ]$$

In the equation, W is the reproduction track width, k is the recording wavelength of the data, and θ is the azimuth angle of the data write head 520.

FIG. 27 illustrates five graphs in cases where the reproduction track widths W are 0.8 μm, 0.5 μm, 0.4 μm, 0.3 μm, and 0.2 μm, respectively. In FIG. 27, the recording wavelength λ is set to 0.1 μm. Here, the graph in which the reproduction track width W is 0.8 μm corresponds to LTO-9, and the graphs in which the reproduction track widths W are 0.5 μm, 0.4 μm, 0.3 μm, and 0.2 μm correspond to LTO-10 and later (estimated values).

As can be seen from FIG. 27, in a case where the angular ranges Refθ±x° at the azimuth angle θ of the data write head 520 are the same as each other, the azimuth loss Lθ is smaller when the reproduction track width W is narrower.

This means that, in the case of a mode of coping with the fluctuation in the width of the magnetic recording medium 501 by adjusting the azimuth angle θ of the data write head 520 as in the present embodiment, from the viewpoint of the azimuth loss Lθ, the magnetic recording medium 501 (for example, LTO-10 or later) having a larger number of recording tracks 5 and a narrower reproduction track width W is more advantageous.

Here, it is assumed that a value capable of allowing the azimuth loss Lθ is 0.05 [dB] or less. Furthermore, it is assumed that the reproduction track width W in the magnetic recording medium 501 is 0.5 μm or less (LTO-10 or later (estimated value)).

In this case, as shown in the dotted line in FIG. 27, the angular range at the azimuth angle θ of the data write head 520 is set to Refθ±0.7° at the maximum. Therefore, in the present embodiment, in the angular range at the azimuth angle θ of the data write head 520, the value of x of Refθ±x° is typically 0.7° or less.

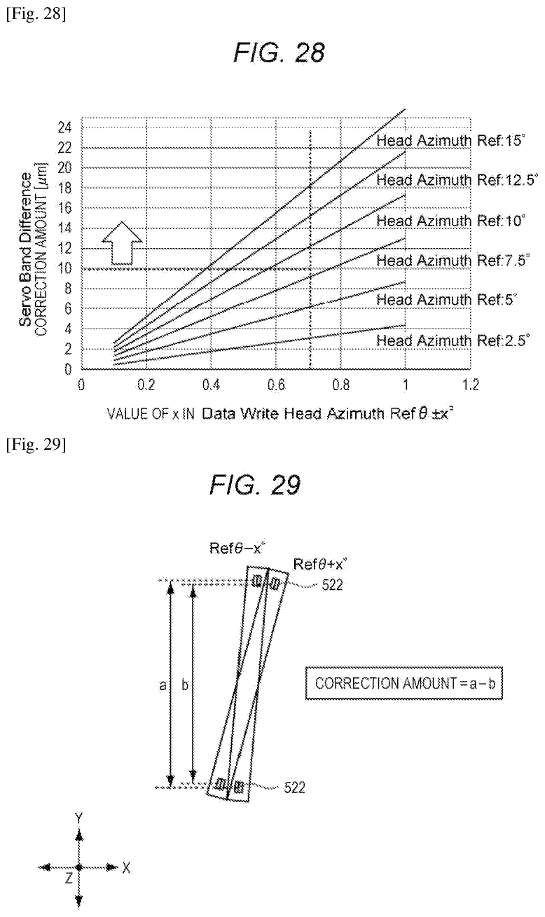

FIG. 28 is a view illustrating a relationship between the angular range Refθ±x° at the azimuth angle θ of the data write head 520 and a correction amount with respect to a servo band pitch difference based on a variation in width of the magnetic recording medium 501.

In FIG. 28, the horizontal axis indicates the value of x in the angular range Refθ±x° of the azimuth angle θ of the data write head 520, and the vertical axis indicates the correction amount with respect to the servo band pitch difference based on the variation in width of the magnetic recording medium 501.

FIG. 29 is a view illustrating the correction amount with respect to the servo band pitch difference based on the variation in width of the magnetic recording medium 501. As illustrated in FIG. 29, the correction amount is represented by a-b.

Here, the value of a is a distance between two servo read units 522 in the width direction (Y-axis direction) of the magnetic recording medium 501 in a case where the azimuth angle θ of the data write head 520 is set to Refθ−x°. On the other hand, the value of b is a distance between two servo read units 522 in the width direction (Y-axis direction) of the magnetic recording medium 501 in a case where the azimuth angle θ of the data write head 520 is set to Refθ+x°.

Returning to FIG. 28, FIG. 28 illustrates six graphs in cases where the reference angle Refθ at the azimuth angle θ of the data write head 520 is changed by 2.5°, 5°, 7.5°, 10°, 12.5°, and 15°.

It can be seen from FIG. 28 that if the angular ranges Refθ±x° are the same as each other, the correction amount is increased as the reference angle Refθ is increased.

Here, as described above, when the azimuth loss Lθ is 0.05 [dB] or less and the reproduction track width W is 0.5 μm or less, the angular range at the azimuth angle θ of the data write head 520 is Refθ±0.7° at the maximum (see the vertical broken line in FIG. 28). In addition to this condition, it is further assumed that the correction amount described above is 10 μm or more (see a horizontal broken line in FIG. 28).

As can be seen from FIG. 28, in order to satisfy these conditions, the reference angle Refθ of the data write head 520 of 7.5° is slightly insufficient, and it is sufficient if the reference angle Refθ is 10°. That is, in order to satisfy the above conditions described above, the reference angle Refθ is 8° or more.

Note that the description here is not intended to indicate that the reference angle Refθ should be 8° or more in the present embodiment. That is, in the present embodiment, the reference angle Refθ can be appropriately set to 2.5° or more, 5° or more, 7.5° or more, 8° or more, 10° or more, 12.5° or more, 15° or more, or the like.

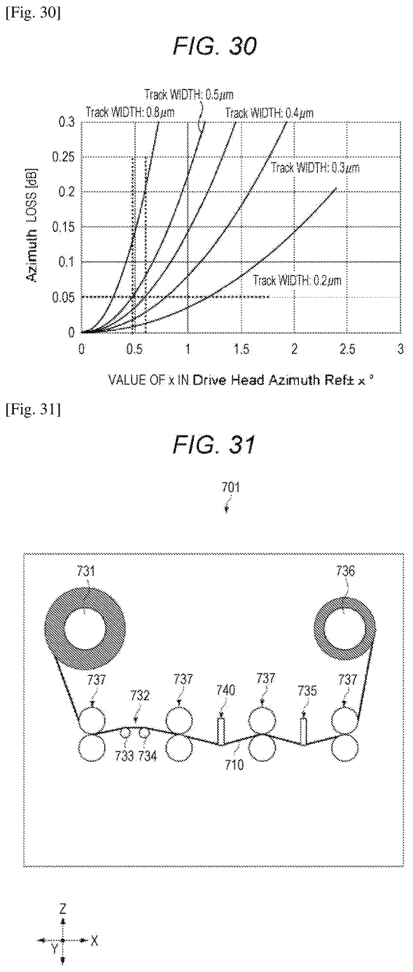

FIG. 30 is a view illustrating the relationship between the angular range Refθ±x° of the azimuth angle θ and an azimuth loss Lθ of the data write head 520 (recording wavelength: 0.07 μm). In FIG. 30, the horizontal axis indicates the value of x in the angular range Refθ±x° of the azimuth angle θ of the data write head 520, and the vertical axis indicates the azimuth loss Lθ. In FIG. 30, the recording wavelength λ of the data is set to 0.07 μm.

The difference between FIGS. 27 and 30 is that the recording wavelength λ of the data is 0.1 μm in FIG. 27, whereas the recording wavelength λ of the data is 0.07 μm in FIG. 30. Note that, in LTO-10 or later, the recording wavelength λ of the data is estimated to be 0.1 μm or less, 0.07 μm or less, or the like.

As can be seen from the comparison between FIGS. 27 and 30, the azimuth loss is increased as the recording wavelength λ of the data is decreased.

In FIG. 30, it will focus on a graph in which the reproduction track width W is 0.5 μm. In a case where the recording wavelength λ of the data is 0.07 μm and the reproduction track width W is 0.5 μm, in order to set the azimuth loss to 0.05 [dB] or less, the value of x in the angular range Refθ±x° of the azimuth angle θ of the data write head 520 is only required to be set to 0.480 or less.

In FIG. 28, it will focus on a location where the value of x is 0.48° in the angular range Refθ±x° of the azimuth angle θ of the data write head 520 (see the horizontal axis in FIG. 28). In a case where the angular range of the azimuth angle θ of the data write head 520 is Refθ±0.48°, if the correction amount described above is 10 μm or more, the reference angle Refθ is only required to be 12.5° or more.

Furthermore, in FIG. 30, it will focus on a graph in which the reproduction track width W is 0.4 μm. In a case where the recording wavelength λ of the data is 0.07 μm and the reproduction track width W is 0.4 μm, in order to set the azimuth loss to 0.05 [dB] or less, the value of x in the angular range Refθ±x° of the azimuth angle θ of the data write head 520 is only required to be set to 0.6° or less.

In FIG. 28, it will focus on a location where the value of x is 0.6° in the angular range Refθ±x° of the azimuth angle θ of the data write head 520 (see the horizontal axis in FIG. 28). In a case where the angular range of the azimuth angle θ of the data write head 520 is Refθ±0.6°, if the correction amount described above is 10 μm or more, the reference angle Refθ is only required to be 100 or more.

Note that, as seen from the description here, the angular range Refθ±x° of the azimuth angle θ of the data write head 520 is decreased as the recording wavelength λ of the data is decreased. Furthermore, the angular range Refθ±x° of the azimuth angle θ of the data write head 520 is increased as the reproduction track width W is decreased (see FIGS. 27 and 30).

Furthermore, the reference angle Refθ at the azimuth angle θ of the data write head 520 is increased as the recording wavelength λ of the data is decreased. Furthermore, the reference angle Refθ at the azimuth angle θ of the data write head 520 is decreased as the reproduction track width W is decreased (see FIG. 28).

Here, as the generation of the LTO standard progresses from LTO-9 to LTO-10, LTO-11, and . . . , the recording wavelength λ of the data is predicted to be sequentially decreased, and the reproduction track width W is also predicted to be sequentially decreased. Accordingly, the value of x in the angular range Refθ±x° of the azimuth angle θ of the data write head 520 may be set to an appropriate value (for example, 0.7° or less, 0.6° or less, 0.5° or less, 0.4° or less, . . . , and the like), and the reference angle Refθ of the azimuth angle θ of the data write head 520 is only required to be set to an appropriate value (for example, 2.5° or more, 5° or more, 7.5° or more, 8° or more, 10° or more, 12.5° or more, 15° or more . . . , and the like).

### (8) Other Examples of Servo Pattern Recording Apparatus

### (Configurations of Other Examples of Servo Pattern Recording Apparatus)

Next, a servo pattern recording apparatus 701 according to an embodiment of the present technology will be described. FIG. 31 is a view illustrating the servo pattern recording apparatus 701.

As illustrated in FIG. 31, the servo pattern recording apparatus 701 includes a feed roller 731, a demagnetization unit 732, a servo write head 740, a servo read head 735, a winding roller 736, and four pairs of capstan rollers 737.

The feed roller 731 can rotatably support the roll-shaped magnetic recording medium 710. The feed roller 731 is rotated in accordance with driving of a motor or the like, and feeds the magnetic recording medium 710 toward the downstream in accordance with the rotation.

The winding roller 736 can rotatably support the roll-shaped magnetic recording medium 710. The winding roller 736 rotates in accordance with driving of a motor or the like, and winds up the magnetic recording medium 710 in accordance with the rotation.

Each of the four pairs of capstan rollers 737 can interpose the magnetic recording medium 710 from both sides in the vertical direction. The four pairs of capstan rollers 737 rotate in accordance with driving of a motor or the like, and transport the magnetic recording medium 710 in the transport path in accordance with the rotation.

The feed roller 731, the winding roller 736, and the four pairs of capstan rollers 737 can transport the magnetic recording medium 710 at a constant speed in the transport path.

The servo write head 740 is arranged, for example, above the magnetic recording medium 710 (magnetic layer 43 side). The servo write head 740 applies a magnetic field to the servo band s at a predetermined timing according to the pulse signal of the rectangular wave, and records the servo pattern 6 on the servo band s.

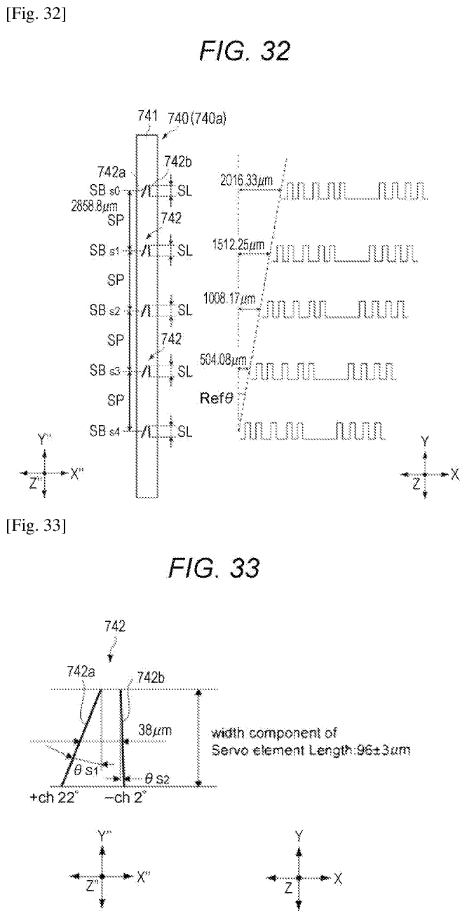

When the servo write head 740 can record the servo patterns 6 on all the servo bands s (s0 to s4), respectively, when the magnetic recording medium 710 passes under the servo write head 740. Note that details of the configuration of the servo write head 740 will be described later with reference to FIGS. 32 to 38.

The demagnetization unit 732 is arranged, for example, below (base layer 41 side) of the magnetic recording medium 710 on the upstream side of the servo write head 740. The demagnetization unit 732 includes, for example, two permanent magnets 733 and 734. Before the servo pattern 6 is recorded by the servo write head 740, the permanent magnets 733 and 734 apply a magnetic field to the entire magnetic layer 43 by a direct-current magnetic field to demagnetize the entire magnetic layer 43.

The servo read head 735 is arranged above the magnetic recording medium 710 (magnetic layer 43 side) on the downstream side of the servo write head 740. The servo read head 735 is configured to be able to reproduce information of the servo pattern 6 by reading a magnetic field generated from the servo pattern 6 recorded on the magnetic recording medium 710.

When the servo read head 735 can read the servo patterns 6 from all the servo bands s (s0 to s4) when the magnetic recording medium 710 passes under the servo read head 735. Information of the servo pattern 6 read by the servo read head 735 is used to confirm whether or not the servo pattern 6 is accurately recorded.

Examples of the type of the servo read head 735 include an inductive type, a magneto-resistive (MR) type, a giant magneto-resistive (GMR) type, a tunnel magneto-resistive (TMR) type, and the like.

Although not illustrated, the servo pattern recording apparatus 701 includes a control device that integrally controls each unit of the servo pattern recording apparatus 701.

The control device includes, for example, a control unit, a storage unit, a communication unit, and the like. The control unit includes, for example, a central processing unit (CPU) and the like, and comprehensively controls each unit of the servo pattern recording apparatus 701 according to a program stored in the storage unit.

The storage unit includes a nonvolatile memory in which various data or various programs are recorded, and a volatile memory used as a work area of the control unit. The various programs described above may be read from a portable recording medium such as an optical disk, a semiconductor memory, or the like, or may be downloaded from a server device on a network. The communication unit is configured to be able to communicate with, for example, other devices such as a PC, a server device, and the like.

### (Servo Write Head 740)

Next, the configuration of the servo write head 740 will be described in detail. As described above, the data write head 520 in the recording and reproducing apparatus 500 is arranged so as to be inclined in the width direction of the magnetic recording medium 501. Accordingly, a first servo pattern 6a (“/”) and a second servo pattern 6b (“\”) are written so as to be asymmetric with each other in the width direction of the magnetic recording medium 501 so that the data write head 520 can accurately read the servo pattern 6. The writing of the asymmetric servo patterns 6 is executed by the servo write head 740 according to the present embodiment.

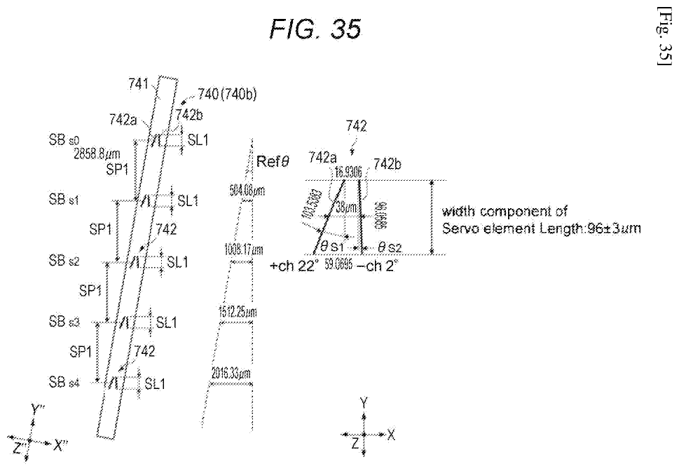

In the present embodiment, there are two types of servo write heads 740 of a first example and a second example. In the first example, a longitudinal direction (Y″-axis direction) of a servo write head 740a is arranged so as to be parallel to the width direction (Y-axis direction) of the magnetic recording medium 501 (see FIGS. 32 to 34 described later). On the other hand, in the second example, a longitudinal direction (Y″-axis direction) of a servo write head 740b is arranged so as to be inclined at a predetermined angle in the width direction (Y-axis direction) of the magnetic recording medium 501 (see FIGS. 35 to 38 described later).

### First Example

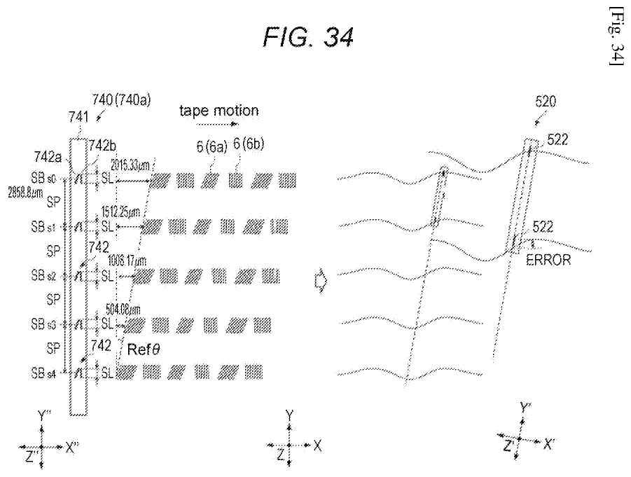

First, the first example of the servo write head 740 will be described. FIG. 32 is a view illustrating the servo write head 740a and pulse signals input to the servo write head 740a. FIG. 33 is an enlarged view of a servo element 742 included in the servo write head 740a. FIG. 34 is a view illustrating a state when the servo patterns 6 are written on the magnetic recording medium 501 by the servo write head 740a. Note that, in FIGS. 32 to 34, a surface of the servo write head 740a facing the magnetic recording medium 501 is illustrated.

As illustrated in these drawings, the servo write head 740a has a shape that is long in the longitudinal direction (Y″-axis direction) and is short in the width direction (X″-axis direction). Note that, in FIGS. 32 to 34, the longitudinal direction of the servo write head 740a is defined as the Y″-axis direction, the width direction of the servo write head 740a is defined as the X″-axis direction, and the vertical direction of the servo write head 740a is defined as the Z″-axis direction. Furthermore, a longitudinal direction (transport direction) of the magnetic recording medium 501 is defined as an X-axis direction, a width direction of the magnetic recording medium 501 is defined as a Y-axis direction, and a thickness direction of the magnetic recording medium 501 is defined as a Z-axis direction. Note that this similarly applies to FIGS. 35 to 38.

In the first example, the longitudinal direction (Y″-axis direction) of the servo write head 740a coincides with the width direction (Y-axis direction) of the magnetic recording medium 501, and the width direction (X″-axis direction) of the servo write head 740a coincides with the longitudinal direction (X-axis direction) of the magnetic recording medium 501.

The servo write head 740a has a facing surface 741 facing the magnetic recording medium 501. The facing surface 741 has a shape that is long in the longitudinal direction (Y″-axis direction) and is short in the width direction (X″-axis direction).

The servo write head 740a has five pairs of servo elements 742 (magnetic gaps) on the facing surface 741. The five pairs of servo elements 742 are arranged at a predetermined interval (servo element pitch: SP) in the longitudinal direction (Y″-axis direction) of the servo write head 740a.

The interval (servo element pitch) between two pairs of servo elements 742 adjacent to each other in the longitudinal direction (Y″-axis direction) of the servo write head 740a (width direction of the magnetic recording medium 501: Y-axis direction) is, for example, 2,858.8±4.6 μm. Note that the value corresponds to an interval (servo band pitch: SP) between two servo bands s adjacent to each other in the width direction (Y-axis direction) of the magnetic recording medium 501 in the magnetic recording medium 501.

The pair of servo elements 742 include a first servo element 742a (“/”) and a second servo element 742b (“\”) configured to be asymmetric with each other in the longitudinal direction (Y″-axis direction) of the servo write head 740a (width direction of the magnetic recording medium 501: Y-axis direction) (in particular, see FIG. 33).

The first servo element 742a (“/”) is inclined at a first angle θs1 with respect to the longitudinal direction (Y″-axis direction of the servo write head 740a (width direction of the magnetic recording medium 501: Y-axis direction). The second servo element 742b (“\”) is inclined at a second angle θs2 opposite to the first angle θs1 with respect to the longitudinal direction (Y″-axis direction of the servo write head 740a (width direction of the magnetic recording medium 501: Y-axis direction).

The first angle θs1 and the second angle θs2 are related to the reference angle Refθ of the data write head 520, and are expressed by the following formulas, respectively.

$$θs1 = Ref θ + θ a$$

$$θs2 = Ref θ - θ a$$

Here, Refθ is the reference angle Refθ of the data write head 520, and θa is the servo azimuth angle.

In a case where the reference angle Refθ of the data write head 520 is 100 and the servo azimuth angle θa is 12°, the first angle θs1 of the first servo element 742a (“/”) is 220 and the second angle θs2 of the second servo element 742b (“\”) is 2°.

In the width direction (X″-axis direction) of the servo write head 740a (longitudinal direction of the magnetic recording medium 501: X-axis direction), the interval between the first servo element 742a (“/”) and the second servo element 742b (“\”) is, for example, 38 μm at a position corresponding to ½ of a width direction component SL of the length of the servo element.

Here, in the first servo element 742a (“/”), a direction along the first angle θs1 (a direction at 220 with respect to the width direction of the magnetic recording medium 501) is defined as a longitudinal direction of the first servo element 742a (“/”). Furthermore, in the second servo element 742b (“\”), a direction along the second angle θs2 (a direction at −2° with respect to the width direction of the magnetic recording medium 501) is defined as a longitudinal direction of the second servo element 742b (“\”).

A length of the first servo element 742a (“/”) in the longitudinal direction is different from a length of the second servo element 742b (“\”) in the longitudinal direction. In the example here, the length of the first servo element 742a (“/”) in the longitudinal direction may be longer than the length of the second servo element 742b (“\”) in the longitudinal direction.

On the other hand, a component in the width direction (Y-axis direction) SL of the magnetic recording medium 501 in the length of the first servo element 742a (“/”) in the longitudinal direction is the same as a component in the width direction (Y-axis direction) SL of the magnetic recording medium 501 in the length of the second servo element 742b (“\”) in the longitudinal direction. The width direction component SL of the length of the servo element 742 is, for example, 96±3 μm.

FIG. 32 illustrates pulse signals input to the five pairs of servo elements 742, respectively. Furthermore, FIG. 34 illustrates the servo pattern 6 written in the servo band s of the magnetic recording medium 501 by inputting the pulse signals to the five pairs of servo elements 742.

Here, as described above, the data write head 520 is arranged so as to be inclined at an azimuth angle θ with respect to the width direction of the magnetic recording medium 501. In this case, it is assumed that pulse signals having the same phases are input to the five pairs of servo elements 742 at the same time, and servo patterns 6 having the same phases are written at positions parallel to the width direction of the magnetic recording medium 501. In this case, the phases of the servo patterns 6 read at the same time by the two servo read units 522 of the data write head 520 arranged in an inclined manner are different.

Therefore, in the first example, servo patterns 6 having the same phases are written non-parallel to the width direction of the magnetic recording medium 501 by making the phases of pulse signals input to the five pairs of servo elements 742 at the same time different.

A difference in phase between the pulse signals input to the two pairs of servo elements 742 adjacent to each other in the longitudinal direction (Y″-axis direction: width direction of the magnetic recording medium 501) of the servo write head 740a corresponds to SP×tan(Refθ). Here, SP (servo band pitch=servo element pitch) is an interval in the width direction of the magnetic recording medium 501 between two servo bands s adjacent to each other, or an interval in the width direction of the magnetic recording medium 501 between two pairs of servo elements 742 adjacent to each other. Furthermore, Refθ is a reference angle in the data write head 520.

It is assumed that the value of SP is 2,858.8 μm and the reference angle Refθ in the data write head 520 is 10°. In this case, the difference in phase between the pulse signals input to the two pairs of servo elements 742 adjacent to each other corresponds to 2,858.8 μm×tan 10°=504.08 μm.

Here, the differences in phases between the input pulses of the servo element 742 of the servo band s3, the servo band s2, the servo band s1, and the servo band s0 based on the input pulse of the servo element 742 of the servo band s4 are set to phases corresponding to 504.08 μm, 1,008.17 μm, 1,512.25 μm, and 2,016.33 μm in order.

Among the five pairs of servo elements 742 corresponding to the five servo bands s, regarding the phases of the pulse signal inputs at the same time, a servo element to which the input pulse having the phase advanced earliest is input is the servo element 742 of the servo band s0. The order of the phases of the input pulses is the order of the servo element 742 of the servo band s1, the servo element 742 of the servo band s2, the servo element 742 of the servo band s3, and the servo element 742 of the servo band s4.

For example, the servo element 742 of the servo band s0 and the servo element 742 of the servo band s1 will be described. At the same time, the servo element 742 of the servo band s0 receives a pulse signal of a phase earlier than the servo element 742 of the servo band s1 by a phase corresponding to 504.08 μm.

Similarly, the phase difference in the width direction (Y-axis direction) of the magnetic recording medium 501 of the servo patterns 6 written in the two servo bands s adjacent to each other in the width direction of the magnetic recording medium 501 is represented by SP×tan(Refθ).

It is assumed that the value of SP is 2,858.8 μm and the reference angle Refθ in the data write head 520 is 10°. In this case, the phase difference in the width direction (Y-axis direction) of the magnetic recording medium 501 in the servo patterns 6 written in the two servo bands s adjacent to each other corresponds to 2,858.8 μm×tan 10°=504.08 μm.

The differences in phases between the servo patterns 6 of the servo band s3, the servo band s2, the servo band s1, and the servo band s0 based on the servo pattern 6 of the servo band s4 are phases corresponding to 504.08 μm, 1,008.17 μm, 1,512.25 μm, and 2,016.33 μm in order.

Regarding the servo patterns 6 written in the five servo bands s, respectively, a servo pattern having the earliest phase in the width direction (Y-axis direction) of the magnetic recording medium 501 is the servo pattern 6 of the servo band s0. The order of the phases is the order of the servo pattern 6 of the servo band s1, the servo pattern 6 of the servo band s2, the servo pattern 6 of the servo band s3, and the servo pattern 6 of the servo band s4.

For example, the servo pattern 6 of the servo band s0 and the servo pattern 6 of the servo band s1 will be described. In the width direction of the magnetic recording medium 501, the phase of the servo pattern 6 of the servo band s0 is set earlier than the servo pattern 6 of the servo band s1 by the phase corresponding to 504.08 μm.

In the magnetic recording medium 501, in the direction of the reference angle Refθ (10°) of the data write head 520 with respect to the width direction (Y-axis direction) of the magnetic recording medium 501, the phases of the servo patterns 6 written in the five servo bands s are the same phases.

### Second Example

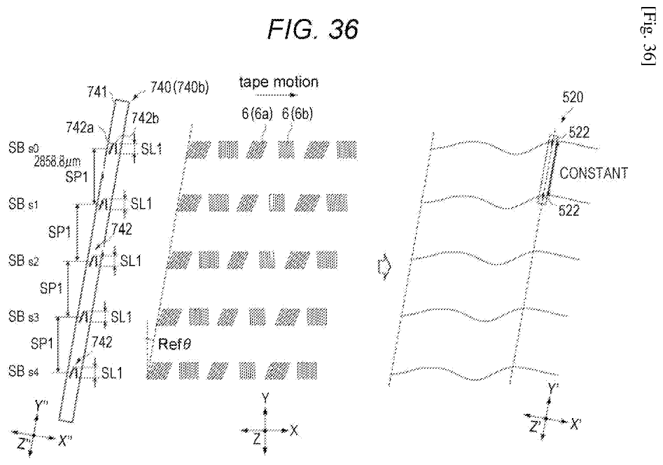

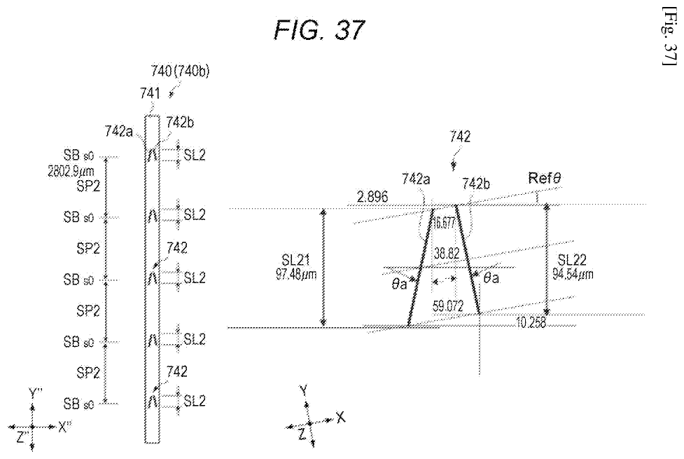

Next, the second example of the servo write head 740 will be described. FIG. 35 is an enlarged view of a servo write head 740b and a servo element 742 included in the servo write head 740b according to the second example. FIG. 36 is a view illustrating a state when the servo patterns 6 are written on the magnetic recording medium 501 by the servo write head 740b according to the second example. In FIGS. 35 and 36, a surface of the servo write head 740b facing the magnetic recording medium 501 is illustrated. Note that, similarly, also in FIGS. 37 to 40 described later, a surface of the servo write head 740 facing the magnetic recording medium 501 is illustrated.

As illustrated in these drawings, the servo write head 740b has a shape that is long in the longitudinal direction (Y″-axis direction) and is short in the width direction (X″-axis direction).

In the second example, the longitudinal direction (Y″-axis direction) of the servo write head 740b is arranged so as to be inclined at a predetermined angle (a second head azimuth angle) with respect to the width direction of the magnetic recording medium 501. The angle at which the longitudinal direction (Y″-axis direction) of the servo write head 740b is inclined with respect to the width direction (Y-axis direction) of the magnetic recording medium 501 is related to the reference angle Refθ of the data write head 520, and coincides with the reference angle Refθ of the data write head 520 (for example, 10°).

The servo write head 740b has a facing surface 741 facing the magnetic recording medium 501. The facing surface 741 has a shape that is long in the longitudinal direction (Y″-axis direction) and is short in the width direction (X″-axis direction).

The servo write head 740b has five pairs of servo elements 742 (magnetic gaps) on the facing surface 741. The five pairs of servo elements 742 are arranged at a predetermined interval (servo element pitch: SP1) in the width direction (Y-axis direction) of the magnetic recording medium 501.

The interval (servo element pitch: SP1) in the width direction (Y-axis direction) of the magnetic recording medium 501 between two pairs of servo elements 742 adjacent to each other is, for example, 2,858.8±4.6 μm. Note that the value corresponds to an interval (servo band pitch: SP1) between two servo bands s adjacent to each other in the width direction (Y-axis direction) of the magnetic recording medium 501 in the magnetic recording medium 501.

Furthermore, in the two pairs of servo elements 742 adjacent to each other, a difference in position in the longitudinal direction (X-axis direction) of the magnetic recording medium is represented by SP1×tan(Refθ). Here, SP1 (servo band pitch=servo element pitch) is an interval in the width direction of the magnetic recording medium 501 between two servo bands s adjacent to each other, or an interval in the width direction of the magnetic recording medium 501 between two pairs of servo elements 742 adjacent to each other. Furthermore, Refθ is a reference angle in the data write head 520.

It is assumed that the value of SP1 is 2,858.8 μm and the reference angle Refθ in the data write head 520 is 10°. In this case, in the two pairs of servo elements 742 adjacent to each other, a difference in position in the longitudinal direction (X-axis direction) of the magnetic recording medium is 2,858.8 μm×tan 10°=504.08 μm.

The pair of servo elements 742 include a first servo element 742a (“/”) and a second servo element 742b (“\”) configured to be asymmetric with each other in the width direction (Y-axis direction) of the magnetic recording medium 501 (in particular, see the right side of FIG. 35).

The first servo element 742a (“/”) is inclined at a first angle θs1 with respect to the width direction (Y-axis direction) of the magnetic recording medium 501. The second servo element 742b (“\”) is inclined at a second angle θs2 opposite to the first angle θs1 with respect to the width direction (Y-axis direction) of the magnetic recording medium 501.

The first angle θs1 and the second angle θs2 are related to the reference angle Refθ of the data write head 520, and are expressed by the following formulas, respectively.

$$θ s 1 = Ref θ + θ a$$

$$θs2 = Ref θ - θ a$$

Here, Refθ is the reference angle Refθ of the data write head 520, and θa is the servo azimuth angle.

In a case where the reference angle Refθ of the data write head 520 is 10° and the servo azimuth angle θa is 12°, the first angle θs1 of the first servo element 742a (“/”) is 22° and the second angle θs2 of the second servo element 742b (“\”) is 2°.

In the longitudinal direction (X-axis direction) of the magnetic recording medium 501, the interval between the first servo element 742a (“/”) and the second servo element 742b (“\”) is, for example, 38 μm at a position corresponding to ½ of a width direction component SL of the length of the servo element 742.

Here, in the first servo element 742a (“/”), a direction along the first angle θs1 (a direction at 220 with respect to the width direction of the magnetic recording medium 501) is defined as a longitudinal direction of the first servo element 742a (“/”). Furthermore, in the second servo element 742b (“\”), a direction along the second angle θs2 (a direction at −2° with respect to the width direction of the magnetic recording medium 501) is defined as a longitudinal direction of the second servo element 742b (“\”).

A length of the first servo element 742a (“/”) in the longitudinal direction is different from a length of the second servo element 742b (“\”) in the longitudinal direction. In the example here, the length of the first servo element 742a (“/”) in the longitudinal direction may be longer than the length of the second servo element 742b (“\”) in the longitudinal direction.

On the other hand, a component in the width direction (Y-axis direction) SL1 of the magnetic recording medium 501 in the length of the first servo element 742a (“/”) in the longitudinal direction is the same as a component in the width direction (Y-axis direction) SL1 of the magnetic recording medium 501 in the length of the second servo element 742b (“\”) in the longitudinal direction. The width direction component SL1 of the length of the servo element 742 is, for example, 96±3 μm.

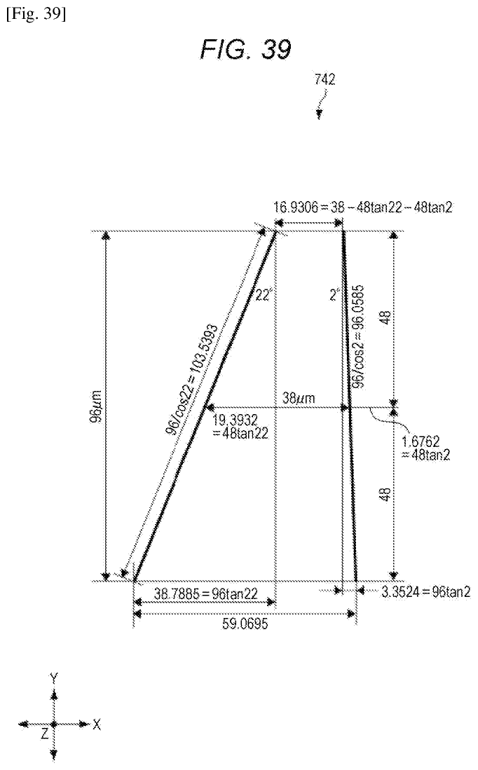

FIG. 39 is an enlarged view of the view of the right side of FIG. 35, and is a view illustrating an example of specific dimensions of the first servo element 742a (“/”) and the second servo element 742b (“\”) (based on an XYZ coordinate system).

As illustrated in FIG. 39, a length of the first servo element 742a (“/”) in the longitudinal direction is 103.5393 μm (=96 μm/cos 22°). Furthermore, a length of the second servo element 742b (“\”) in the longitudinal direction is 96.0585 μm (=96 μm/cos 2°).

Furthermore, an interval (X-axis direction) between an upper end portion of the first servo element 742a and an upper end portion of the second servo element 742b is 16.9306 μm (=38 μm−48 μm×tan 22°−48 μm×tan 2°=38 μm−19.3932 μm−1.6762 μm).

Furthermore, an interval (X-axis direction) between a lower end portion of the first servo element 742a and a lower end portion of the second servo element 742b is 59.0695 μm (=96 μm×tan 22°+16.9306 μm+96 μm×tan 2°=38.7865 μm+16.9306 μm+3.3524 μm).

Here, in the first embodiment described above, the phase difference is set in the pulse signal input to each of the five pairs of servo elements 742. On the other hand, in the second example, since the servo write head 740b is disposed to be inclined, it is not necessary to set the phase difference with respect to the pulse signal. That is, pulse signals corresponding to the same phases at the same time are input to the five pairs of servo elements 742, respectively.

FIG. 36 illustrates the servo patterns 6 written in the five servo bands s by the five servo elements 742, respectively.

The phase difference in the width direction of the magnetic recording medium 501 of the servo patterns 6 written in the two servo bands s adjacent to each other in the width direction (Y-axis direction) of the magnetic recording medium 501 is represented by SP1×tan(Refθ).

It is assumed that the value of SP1 is 2,858.8 μm and the reference angle Refθ in the data write head 520 is 10°. In this case, the phase difference of the servo patterns 6 written in the two servo bands s adjacent to each other is 2,858.8 μm×tan 10°=504.08 μm.

Note that the differences in phases between the servo patterns 6 of the servo band s3, the servo band s2, the servo band s1, and the servo band s0 based on the servo pattern 6 of the servo band s4 are phases corresponding to 504.08 μm, 1,008.17 μm, 1,512.25 μm, and 2,016.33 μm in order.

Regarding the servo patterns 6 written in the five servo bands s, respectively, a servo pattern having the earliest phase in the width direction (Y-axis direction) of the magnetic recording medium 501 is the servo pattern 6 of the servo band s0. The order of the phases is the order of the servo pattern 6 of the servo band s1, the servo pattern 6 of the servo band s2, the servo pattern 6 of the servo band s3, and the servo pattern 6 of the servo band s4.

For example, the servo pattern 6 of the servo band s0 and the servo pattern 6 of the servo band s1 will be described. In the width direction of the magnetic recording medium 501, the phase of the servo pattern 6 of the servo band s0 is set earlier than the servo pattern 6 of the servo band s1 by the phase corresponding to 504.08 μm.

In the magnetic recording medium 501, in the direction of the reference angle Refθ (10°) of the data write head 520 with respect to the width direction (Y-axis direction) of the magnetic recording medium 501, the phases of the servo patterns 6 written in the five servo bands s are the same phases.

In the description described above, a configuration of the servo write head 740b based on the coordinate system (XYZ coordinate system) of the magnetic recording medium 501 has been described. Hereinafter, the configuration of the servo write head 740b based on a coordinate system (X″Y″Z″ coordinate system) of the servo write head 740b will be described.

FIG. 37 is a view illustrating the servo write head 740b based on the coordinate system of the servo write head 740b in the second example.

As illustrated in FIG. 37, the five pairs of servo elements 742 are arranged at a predetermined interval (servo element pitch: SP2) in the longitudinal direction (Y″-axis direction) of the servo write head 740b. The interval (servo element pitch: SP2) between two pairs of servo elements 742 adjacent to each other in the longitudinal direction (Y″-axis direction) of the servo write head 740b is represented by SP1×cos−1(Refθ).

For example, in the width direction (Y-axis direction) of the magnetic recording medium 501, the interval (servo element pitch: SP1) between two pairs of servo elements 742 adjacent to each other is 2,858.8 μm, and the reference angle Refθ of the data write head 520 is 10°. In this case, the interval (servo element pitch: SP2) between two pairs of servo elements 742 adjacent to each other in the longitudinal direction (Y″-axis direction) of the servo write head 740b is by 2,902.9 μm.

Here, in the first example described above, the axes of symmetry of the first servo element 742a (“/”) and the second servo element 742b (“\”) are non-parallel in the width direction (Y-axis direction) of the magnetic recording medium 501, and are also non-parallel in the longitudinal direction (Y″-axis direction) of the servo write head 740b. On the other hand, in the second example, the axes of symmetry of the first servo element 742a (“/”) and the second servo element 742b (“\”) are non-parallel in the width direction (Y-axis direction) of the magnetic recording medium 501, but are parallel in the longitudinal direction (Y″-axis direction) of the servo write head 740b.

The first servo element 742a (“/”) is inclined at a servo azimuth angle θa with respect to the longitudinal direction (Y″-axis direction) of the servo write head 740b. On the other hand, the second servo element 742b “\” is arranged in an opposite direction to the first servo element 742a (“/”) with respect to the longitudinal direction (Y″-axis direction) of the servo write head 740b, and is inclined at the same servo azimuth angle θa as that of the first servo element 742a (“/”).

Here, in the first servo element 742a (“/”), a direction along the servo azimuth angle θa (a direction at +12° with respect to the longitudinal direction of the servo write head 740b) is defined as the longitudinal direction of the first servo element 742a (“/”). Furthermore, in the second servo element 742b (“\”), a direction along the servo azimuth angle θa (a direction at −12° with respect to the longitudinal direction of the servo write head 740b) is defined as the longitudinal direction of the second servo element 742b (“\”).

A length of the first servo element 742a (“/”) in the longitudinal direction is different from a length of the second servo element 742b (“\”) in the longitudinal direction. In the example here, the length of the first servo element 742a (“/”) in the longitudinal direction may be longer than the length of the second servo element 742b (“\”) in the longitudinal direction.

Moreover, a longitudinal direction component SL21 of the servo write head 740b (Y″-axis direction) in the length of the first servo element 742a (“/”) in the longitudinal direction is also different from a longitudinal direction component SL22 of the servo write head 740b (Y″-axis direction) in the length of the second servo element 742b (“\”) in the longitudinal direction.

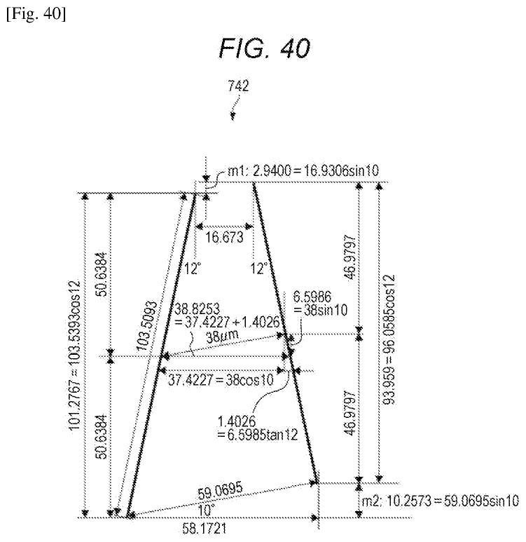

FIG. 40 is an enlarged view of the view of the right side of FIG. 37, and is a view illustrating an example of specific dimensions of the first servo element 742a (“/”) and the second servo element 742b (“\”) (based on an X″Y″Z″ coordinate system).

It is assumed, in the length of the servo element 742, a width direction component SL1 of the magnetic recording medium 501 (Y-axis direction) is 96 μm, the reference angle Refθ of the data write head 520 is 10°, and the servo azimuth angle θa is 12°. In this case, in the length of the first servo element 742a (“/”), a b longitudinal direction component SL21 of the servo write head 740b (Y″-axis direction) is 101.2767 μm (=103.5093 μm×cos 12°). Furthermore, in this case, in the length of the second servo element 742b (“\”), a longitudinal direction component SL22 of the servo write head 740b (Y″-axis direction) is 93.959 μm (=96.0585 μm×cos 12°).

Furthermore, in the width direction (X″-axis direction) of the servo write head 740b, the interval between the upper end portion of the first servo element 742a and the upper end portion of the second servo element 742b is 16.673 μm (=16.9306 μm×cos 10°). Furthermore, in the longitudinal direction (Y″-axis direction) of the servo write head 740b, a difference between a position of the upper end portion of the first servo element 742a (“/”) and a position of the upper end portion of the second servo element 742b (“\”) is 2.94 μm (=16.9306 μm×sin 10°).

Furthermore, in the width direction (X″-axis direction) of the servo write head 740b, the interval between the lower end portion of the first servo element 742a and the lower end portion of the second servo element 742b is 58.1721 μm (=59.0695 μm×cos 10°). Furthermore, in the longitudinal direction (Y″-axis direction) of the servo write head 740b, a difference between a position of the lower end portion of the first servo element 742a (“/”) and a position of the lower end portion of the second servo element 742b (“\”) is 10.2573 μm (=59.0695 μm×sin 10°).

Furthermore, in the width direction (X″-axis direction) of the servo write head 740b, an interval (center) between the first servo element 742a (“/”) and the second servo element 742b (“\”) is, for example, 38.8253 μm (38 μm×cos 10°+(38 μm×sin 10°)×tan 12°=37.4227 μm+6.5986 μm×tan 12°=37.4227 μm+1.4026 μm).

(Comparison Between First Example and Second Example) Next, a comparison between the first example and the second example will be described.

On the right side of FIG. 34, a state when the servo pattern 6 written by the servo write head 740a according to the first example is read by the two servo read units 522 of the data write head 520 is illustrated

As described above, in the servo write head 740a according to the first example, a method is used in which the servo write head 740a is arranged without being inclined with respect to the width direction of the magnetic recording medium 501, and the servo pattern 6 is written by adjusting the phase of the pulse signal input to the servo element 742.

Here, when the servo pattern 6 is written on the magnetic recording medium 501 by the servo write head 740a, the magnetic recording medium 501 may slightly move in the width direction (Y-axis direction).

It is assumed that, in the servo write head 740a of the first example, the servo element 742 of the servo band s0 writes a servo pattern 6 of a certain phase ph1 at a certain time t1 with respect to the servo band s0. It is assumed that the servo element 742 of the servo band s1 writes the servo pattern 6 of the phase ph1 with respect to the servo band s1 at a subsequent time t2 (time when the magnetic recording medium 501 is transported by 504.08 μm in the transport direction).

In this case, it is assumed that the magnetic recording medium 501 slightly moves in the width direction between the time t1 and the time t2. In this case, an interval (a direction of the reference angle Refθ (10°)) between a position of the servo pattern 6 of the phase ph1 in the servo band s0 and a position of the servo pattern 6 of the phase ph1 in the servo band s1 is different from the predetermined value (an interval between two servo read units 522: the direction of the reference angle Refθ (10°).

This causes an error, and the data write head 520 may not be able to accurately servo trace the servo pattern 6.

On the other hand, on the right side of FIG. 36, a state when the servo pattern 6 written by the servo write head 740b according to the second example is read by the two servo read units 522 of the data write head 520 is illustrated

In the servo write head 740b according to the second example, a method is used in which the servo write head 740b is arranged so as to be inclined with respect to the width direction of the magnetic recording medium 501, and the servo pattern 6 is written by adjusting the same phase of the pulse signal input to the servo element 742.

It is assumed that, in the servo write head 740b of the second example, the servo element 742 of the servo band s0 and the servo element 742 of the servo band s1 write the servo patterns 6 of the same phase ph1 at the same time t1 with respect to the servo band s0 and the servo band s1.

Thereafter, the servo element 742 of the servo band s0 and the servo element 742 of the servo band s1 write the servo patterns 6 of the same phase ph2 at the same time t2 with respect to the servo band s0 and the servo band s1.

In this case, it is assumed that the magnetic recording medium 501 slightly moves in the width direction between the time t1 and the time t2. In this case, the interval (the direction of the reference angle Refθ (10°)) between the position of the servo pattern 6 of the phase ph1 in the servo band s0 and the position of the servo pattern 6 of the phase ph1 in the servo band s1 is the same as the interval between the position of the servo pattern 6 of the phase ph2 in the servo band s0 and the position of the servo pattern 6 of the phase ph2 in the servo band s1. These intervals are the same as a predetermined value (interval between two servo read units 522: the direction of the reference angle Refθ (10°)), and are constant.

That is, in the second example, the interval (the direction of the reference angle Refθ) between the servo patterns 6 in the same phases in the servo bands s adjacent to each other can be constant regardless of the fine movement in the width direction of the magnetic recording medium 501 at the time of writing the servo patterns 6. Therefore, this allows the data write head 520 to servo trace the servo pattern 6 accurately.

As can be seen from the description here, the second example is more advantageous than the first example from the viewpoint of fine movement of the magnetic recording medium 501 in the width direction at the time of writing the servo pattern 6. However, this does not mean that the method according to the first example cannot be adopted, and the first example is also included as an example of the present technology. For example, the method according to the first example may be adopted as long as the fine movement of the magnetic recording medium 501 in the width direction at the time of writing the servo pattern 6 is at a negligible level, or the fine movement of the magnetic recording medium 501 in the width direction at the time of writing the servo pattern 6 can be suppressed to a negligible level.

### (Low Friction Processing of Facing Surface 741)

The servo write head 740 may be subjected to low friction processing for intentionally entraining air between the servo write head 740 and the magnetic recording medium 501 and reducing frictional resistance on the facing surface 741.

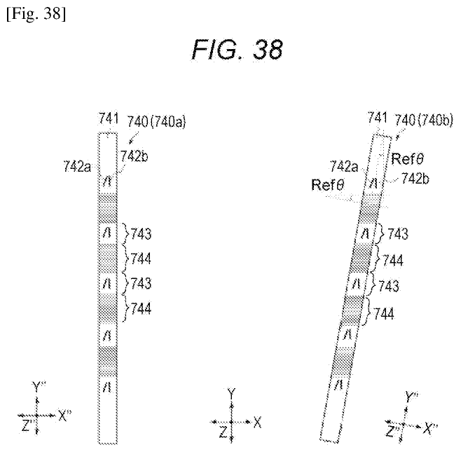

FIG. 38 is a view illustrating a state when the low fraction processing is performed on the facing surface 741 of the servo write head 740. The left side of FIG. 38 illustrates a state where the facing surface 741 of the servo write head 740a according to the first example is subjected to the low friction processing. Furthermore, the right side of FIG. 38 illustrates a state where the facing surface 741 of the servo write head 740b according to the second example is subjected to the low friction processing.

Referring to the left side (first example) of FIG. 38, the facing surface 741 of the servo write head 740a has a first region 743 corresponding to a region where the servo element 742 is provided and a second region 744 corresponding to a region where the servo element 742 is not provided in the longitudinal direction of the servo write head 740 (Y-axis direction: the width direction of the magnetic recording medium 501).

In the second region 744, a plurality of grooves in the width direction of the servo write head 740a (the X-axis direction: the longitudinal direction of the magnetic recording medium 501) extend in the longitudinal direction of the servo write head 740a (the Y-axis direction: the width direction of the magnetic recording medium 501).

Referring to the right side (second example) of FIG. 38, the facing surface 741 of the servo write head 740b has a first region 743 corresponding to a region where the servo element 742 is provided and a second region 744 corresponding to a region where the servo element 742 is not provided in the longitudinal direction of the servo write head 740 (the direction of the reference angle Refθ with respect to the width direction of the magnetic recording medium 501).

In the second region 744, a plurality of grooves in the direction of the reference angle Refθ with respect to the width direction (X″-axis direction) of the servo write head 740b (the X-axis direction: the longitudinal direction of the magnetic recording medium 501) extend in the direction of the reference angle Refθ (Y-axis direction: the width direction of the magnetic recording medium 501) with respect to the longitudinal direction (Y″-axis direction) of the servo write head 740.

Here, in the example on the left side of FIG. 38 (first example), a plurality of grooves in a direction parallel to the width direction of the servo write head 740a are aligned in a direction parallel to the longitudinal direction of the servo write head 740a. On the other hand, in the example on the right side of FIG. 38 (second example), a plurality of grooves in a direction parallel to the width direction of the servo write head 740b are aligned in a direction non-parallel to the longitudinal direction of the servo write head 740.

In the two examples (the first example and the second example) illustrated in FIG. 38, since the facing surface 741 is subjected to the low friction processing, vibration of the magnetic recording medium 501 due to friction can be suppressed, and therefore, the servo pattern 6 can be accurately written.

In particular, in the example of the right side of FIG. 38, a plurality of grooves in the direction of the reference angle Refθ with respect to the width direction (X″-axis direction) of the servo write head 740b (the X-axis direction: the longitudinal direction of the magnetic recording medium 501) extend in the direction of the reference angle Refθ (Y-axis direction: the width direction of the magnetic recording medium 501) with respect to the longitudinal direction (Y″-axis direction) of the servo write head 740. Therefore, even if the servo write head 740 is arranged so as to be inclined at the reference angle Refθ with respect to the width direction of the magnetic recording medium 501, friction with the magnetic recording medium 501 can be appropriately reduced.

### (9) Modified Example

### Modified Example 1

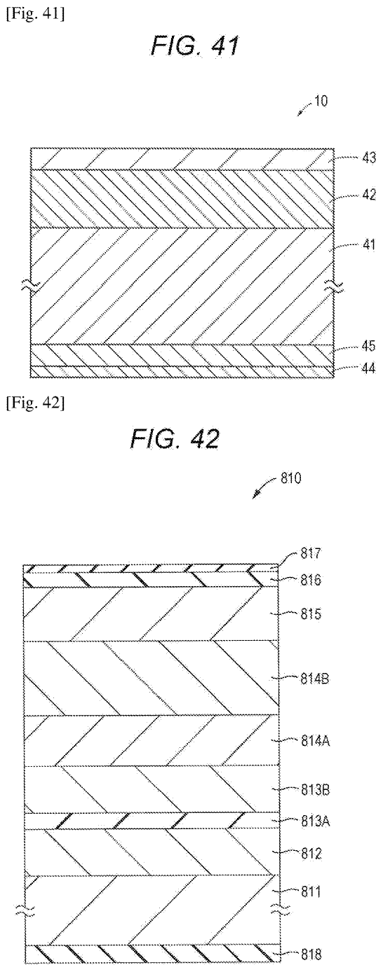

The magnetic recording medium 10 may further include a barrier layer 45 provided on at least one surface of the base layer 41 as illustrated in FIG. 41. The barrier layer 45 is a layer for suppressing dimensional deformation of the base layer 41 according to the environment. For example, the hygroscopicity of the base layer 41 can be exemplified as one of the causes of the dimensional deformation, and the barrier layer 45 can reduce a penetration speed of moisture into the base layer 41. The barrier layer 45 contains, for example, a metal or a metal oxide. As the metal, for example, at least one of Al, Cu, Co, Mg, Si, Ti, V, Cr, Mn, Fe, Ni, Zn, Ga, Ge, Y, Zr, Mo, Ru, Pd, Ag, Ba, Pt, Au, and Ta can be used. As the metal oxide, for example, at least one of Al₂O₃, CuO, CoO, SiO₂, Cr₂O₃, TiO₂, Ta₂O₅, and ZrO₂ can be used, and any of the metal oxides described above can also be used. Furthermore, diamond-like carbon (DLC), diamond, or the like can be used.

An average thickness of the barrier layer 45 is preferably 20 nm or more and 1,000 nm or less, and more preferably 50 nm or more and 1,000 nm or less. The average thickness of the barrier layer 15 is determined in a manner similar to that of the average thickness tₘ of the magnetic layer 43. However, magnification of the TEM image is appropriately adjusted according to the thickness of the barrier layer 45.

### Modified Example 2

The magnetic recording media 10 and 501 may be incorporated in a library apparatus. That is, the present technology also provides a library apparatus including at least one of the magnetic recording media 10 and 501. The library apparatus has a configuration capable of adjusting tension applied in the longitudinal directions of the magnetic recording media 10 and 501, and may include the plurality of recording and reproducing apparatuses 30 and 500 described above.

### Modified Example 3

The magnetic recording media 10 and 501 may be subjected to servo signal write processing by a servo writer. The servo writer can keep the widths of the magnetic recording media 10 and 501 constant or substantially constant by adjusting the tension in the longitudinal directions of the magnetic recording media 10 and 501 at the time of recording a servo signal or the like. In this case, the servo writer can include a detection device that detects the widths of the magnetic recording media 10 and 501. The servo writer can adjust the tension in the longitudinal directions of the magnetic recording media 10 and 501 on the basis of the detection result of the detection device.

### 3. Second Embodiment (Example of Vacuum Thin Film Type Magnetic Recording Medium)

### (1) Configuration of Magnetic Recording Medium

A magnetic recording medium 810 according to a second embodiment is an elongated perpendicular magnetic recording medium, and includes a film-like base layer 811, a soft magnetic underlayer (hereinafter, referred to as “SUL”) 812, a first seed layer 813A, a second seed layer 813B, a first underlayer 814A, a second underlayer 814B, and a magnetic layer 815, as illustrated in FIG. 42. The SUL812, the first and second seed layers 813A and 813B, the first and second underlayers 814A and 814B, and the magnetic layer 815 can be, for example, vacuum thin films such as a layer formed by sputtering (hereinafter, also referred to as a “sputtered layer”) and the like.

The SUL812, the first and second seed layers 813A and 813B, and the first and second underlayers 814A and 814B are provided between one principal plane (hereinafter, referred to as a “front surface”) of the base layer 811 and the magnetic layer 815, and the SUL812, the first seed layer 813A, the second seed layer 813B, the first underlayer 814A, and the second underlayer 814B are laminated in order from the base layer 811 toward the magnetic layer 815. The water vapor transmittance of the base layer itself can be further reduced by providing a vacuum thin film such as a layer formed by sputtering (hereinafter, also referred to as a “sputtered layer”) on the surface of the base layer 811.

The magnetic recording medium 810 may further include a protective layer 816 provided on the magnetic layer 815 and a lubricating layer 817 provided on the protective layer 816 as needed. Furthermore, the magnetic recording medium 810 may further include a back layer 818 provided on the other principal plane (hereinafter referred to as a “back surface”) of the base layer 811 as needed.

Hereinafter, a longitudinal direction of the magnetic recording medium 810 (a longitudinal direction of the base layer 811) is referred to as a machine direction (MD). Here, the machine direction means a relative movement direction of the recording and reproducing head with respect to the magnetic recording medium 810, that is, a direction in which the magnetic recording medium 810 runs at the time of recording and reproducing.

The magnetic recording medium 810 according to the second embodiment is suitable for use as a data archive storage medium, which is expected to increase in demand in the future. The magnetic recording medium 810 can realize, for example, a surface recording density of 10 times or more the current coating type magnetic recording medium for storage, that is, a surface recording density of 50 Gb/in² or more. In a case where a general linear recording type data cartridge is configured using the magnetic recording medium 810 having such a surface recording density, it is possible to perform large-capacity recording of 100 TB or more per data cartridge.

The magnetic recording medium 810 according to the second embodiment is suitable for use in a recording and reproducing apparatus (recording and reproducing apparatus for recording and reproducing data) including a ring-type recording head and a giant magneto-resistive (GMR) type or tunneling magneto-resistive (TMR) type reproducing head. Furthermore, the magnetic recording medium 810 according to the second embodiment preferably uses a ring type recording head as a servo signal writing head. In the magnetic layer 815, a data signal is vertically recorded by, for example, a ring type recording head. Furthermore, in the magnetic layer 815, a servo signal is vertically recorded by, for example, a ring type recording head.

### (2) Description of Each Layer

### (Base Layer)

Since the description of the base layer 41 in the first embodiment applies to the base layer 811, the description of the base layer 811 is omitted.

### (SUL)

The SUL812 contains a soft magnetic material in an amorphous state. The soft magnetic material includes, for example, at least one of a Co-based material and an Fe-based material. The Co-based material includes, for example, CoZrNb, CoZrTa, or CoZrTaNb. The Fe-based material includes, for example, FeCoB, FeCoZr, or FeCoTa.

The SUL812 is a single-layer SUL and is provided directly on the base layer 811. An average thickness of the SUL812 is preferably 10 nm or more and 50 nm or less, and more preferably 20 nm or more and 30 nm or less.

The average thickness of the SUL812 is determined by the same method as the method of measuring the average thickness of the magnetic layer 43 in the first embodiment. Note that an average thickness of the layer other than the SUL812 (that is, an average thickness of each of the first and second seed layers 813A and 813B, the first and second underlayers 814A and 814B, and the magnetic layer 815) described later is also determined by the same method as the method of measuring the average thickness of the magnetic layer 43 in the first embodiment. However, magnification of the TEM image is appropriately adjusted according to the thickness of each layer.

### (First and Second Seed Layers)

The first seed layer 813A contains an alloy containing Ti and Cr, and has an amorphous state. Furthermore, the alloy may further contain oxygen (O). The oxygen may be impurity oxygen contained in a trace amount in the first seed layer 813A when the first seed layer 813A is formed by a film forming method such as a sputtering method or the like.

Here, the “alloy” means at least one of a solid solution containing Ti and Cr, a eutectic material, an intermetallic compound, and the like. The “amorphous state” means that a halo is observed by X-ray diffraction, electron beam diffraction, or the like, and a crystal structure cannot be specified.

An atomic ratio of Ti to the total amount of Ti and Cr contained in the first seed layer 813A is preferably in a range of 30 atomic % or more and 100 atomic % or less, and more preferably in a range of 50 atomic % or more and 100 atomic % or less. When the atomic ratio of Ti is less than 30%, a (100) plane of a body-centered cubic lattice (bec) structure of Cr is oriented, and there is a possibility that the orientation of the first and second underlayers 814A and 814B formed on the first seed layer 813A is deteriorated.

The atomic ratio of Ti described above is determined as follows. Depth direction analysis (depth profile measurement) of the first seed layer 813A by auger electron spectroscopy (hereinafter, referred to as “AES”) is performed while ion-milling the magnetic recording medium 810 from the magnetic layer 815 side. Next, an average composition (average atomic ratio) of Ti and Cr in a film thickness direction is determined from the obtained depth profile. Next, the atomic ratio of Ti described above is determined using the determined average composition of Ti and Cr.

In a case where the first seed layer 813A contains Ti, Cr, and O, an atomic ratio of O to the total amount of Ti, Cr, and O contained in the first seed layer 813A is preferably 15 atomic % or less, and more preferably 10 atomic % or less. When the atomic ratio of O exceeds 15 atomic %, a TiO₂ crystal is generated, such that crystal nucleation formation in the first and second underlayers 814A and 814B formed on the first seed layer 813A is affected, and the orientation of the first and second underlayers 814A and 814B may be deteriorated. The atomic ratio of O described above is determined using the analysis method similar to that of the atomic ratio of Ti described above.

The alloy contained in the first seed layer 813A may further contain elements other than Ti and Cr as additive elements. The additive elements may be, for example, one or more elements selected from the group consisting of Nb, Ni, Mo, Al, and W.

An average thickness of the first seed layer 813A is preferably 2 nm or more and 15 nm or less, and more preferably 3 nm or more and 10 nm or less.

The second seed layer 813B contains, for example, NiW or Ta, and has a crystalline state. An average thickness of the second seed layer 813B is preferably 3 nm or more and 20 nm or less, and more preferably 5 nm or more and 15 nm or less.

The first and second seed layers 813A and 813B have a crystal structure similar to those of the first and second underlayers 814A and 814B, and are not seed layers provided for the purpose of crystal growth, but are seed layers that improve the vertical orientation of the first and second underlayers 814A and 814B by the amorphous state of the first and second seed layers 813A and 813B.

### (First and Second Underlayers)

The first and second underlayer 814A and 814B preferably have a crystal structure similar to that of the magnetic layer 815. In a case where the magnetic layer 815 contains a Co-based alloy, it is preferable that the first and second underlayers 814A and 814B contain a material having a hexagonal close-packed (hcp) structure similar to that of the Co-based alloy, and a c-axis of the structure is oriented in a direction perpendicular to the film surface (that is, a film thickness direction). This is because the orientation of the magnetic layer 815 can be enhanced, and a lattice constant matching between the second underlayer 814B and the magnetic layer 815 can be relatively preferable. As the material having a hexagonal close-packed (hcp) structure, a material containing Ru is preferably used, and specifically, Ru alone or a Ru alloy is preferable. Examples of the Ru alloy include Ru alloy oxides such as Ru—SiO₂, Ru—TiO₂, Ru—ZrO₂, and the like, and the Ru alloy may be any one of these alloy oxides.

As described above, similar materials can be used as the materials of the first and second underlayers 814A and 814B. However, the targeted effects of the first and second underlayers 814A and 814B are different from each other. Specifically, the second underlayer 814B has a film structure that promotes a granular structure of the magnetic layer 815 as an upper layer thereof, and the first underlayer 814A has a film structure with high crystal orientation. In order to obtain such a film structure, it is preferable that film formation conditions such as sputtering conditions and the like of the first and second underlayers 814A and 814B are different from each other.

An average thickness of the first underlayer 814A is preferably 3 nm or more and 15 nm or less, and more preferably 5 nm or more and 10 nm or less. An average thickness of the second underlayer 814B is preferably 7 nm or more and 40 nm or less, and more preferably 10 nm or more and 25 nm or less.

### (Magnetic Layer)

The magnetic layer (also referred to as a recording layer) 815 may be a perpendicular magnetic recording layer in which a magnetic material is vertically oriented. From the viewpoint of improving the recording density, the magnetic layer 815 is preferably a granular magnetic layer containing a Co-based alloy. The granular magnetic layer includes ferromagnetic crystal particles containing a Co-based alloy and a non-magnetic grain boundary (non-magnetic body) surrounding the ferromagnetic crystal particles. More specifically, the granular magnetic layer includes columns (columnar crystals) containing a Co-based alloy, and a non-magnetic grain boundary (for example, an oxide such as SiO₂ or the like) that surrounds the column and magnetically separates each column. In the structure, the magnetic layer 815 having a structure in which the columns are magnetically separated can be configured.

The Co-based alloy has a hexagonal close-packed (hcp) structure, and a c-axis thereof is oriented in a direction perpendicular to the film surface (film thickness direction). As the Co-based alloy, a CoCrPt-based alloy containing at least Co, Cr, and Pt is preferably used. The CoCrPt-based alloy may further contain an additive element. Examples of the additive element include one or more elements selected from the group consisting of Ni, Ta, and the like.

The non-magnetic grain boundary surrounding the ferromagnetic crystal grains contains a non-magnetic metal material. Here, the metal includes a semimetal. As the non-magnetic metal material, for example, at least one of a metal oxide and a metal nitride can be used, and from the viewpoint of more stably maintaining the granular structure, it is preferable to use a metal oxide. Examples of the metal oxide include metal oxides including at least one element selected from the group consisting of Si, Cr, Co, Al, Ti, Ta, Zr, Ce, Y, Hf, and the like, and metal oxides including at least a Si oxide (that is, SiO₂) are preferable. Specific examples of the metal oxide include SiO₂, Cr₂O₃, CoO, Al₂O₃, TiO₂, Ta₂O₅, ZrO₂, HfO₂, and the like. Examples of the metal nitride include metal nitrides including at least one element selected from the group consisting of Si, Cr, Co, Al, Ti, Ta, Zr, Ce, Y, Hf, and the like. Specific examples of the metal nitride include SiN, TiN, AlN, and the like.

It is preferable that the CoCrPt-based alloy contained in the ferromagnetic crystal particles and the Si oxide contained in the non-magnetic grain boundary have an average composition represented by the following Formula (1). This is because it is possible to realize a saturation magnetization amount Ms capable of suppressing the influence of a demagnetizing field and securing a sufficient reproduction output, and therefore, the recording and reproducing characteristics can be further improved.

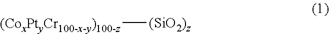

(Here, in Formula (1), x, y, and z are values within the ranges of 69≤x≤75, 10≤y≤16, and 9≤z≤12, respectively.)

Note that the composition described above can be determined as follows. A depth direction of the magnetic layer 815 is analyzed by AES while ion-milling the magnetic recording medium 810 from the magnetic layer 815 side, and an average composition (average atomic ratio) of Co, Pt, Cr, Si, and O in the film thickness direction is determined.

An average thickness tₘ [nm] of the magnetic layer 815 can be preferably 9 nm≤tₘ≤90 nm, more preferably 9 nm≤tₘ≤20 nm, and still more preferably 9 nm≤tₘ≤15 nm.

The average thickness tₘ of the magnetic layer 815 within the numerical range described above can contribute to improvement of the electromagnetic conversion characteristics.

### (Protective Layer)

The protective layer 816 contains, for example, a carbon material or silicon dioxide (SiO₂), and preferably contains a carbon material from the viewpoint of the film strength of the protective layer 816. Examples of the carbon material include graphite, diamond-like carbon (DLC), diamond, and the like.

### (Lubricating Layer)

The lubricating layer 817 contains at least one lubricant. The lubricating layer 817 may further contain various additives, for example, a corrosion inhibitor and the like, as needed. The lubricant has at least two carboxyl groups and one ester bond, and contains at least one carboxylic acid-based compound represented by the following General Formula (1). The lubricant may further a lubricant other than the carboxylic acid-based compound represented by the following General Formula (1).

### General Formula (1):

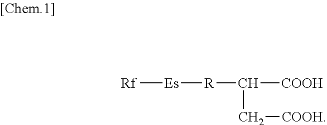

(In the formula, Rf is an unsubstituted or substituted saturated or unsaturated fluorine-containing hydrocarbon group or a hydrocarbon group, Es is an ester bond, and R may be absent, but is an unsubstituted or substituted saturated or unsaturated hydrocarbon group.)

The carboxylic acid-based compound described above is preferably represented by the following General Formula (2) or (3).

### General Formula (2):

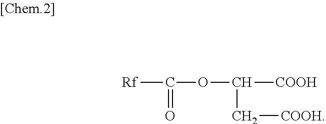

(In the formula, Rf is an unsubstituted or substituted saturated or unsaturated fluorine-containing hydrocarbon group or a hydrocarbon group.)

### General Formula (3):

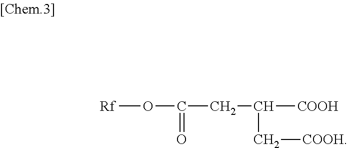

(In the formula, Rf is an unsubstituted or substituted saturated or unsaturated fluorine-containing hydrocarbon group or a hydrocarbon group.)

The lubricant preferably contains one or both of the carboxylic acid-based compounds represented by General Formulas (2) and (3) described above.

When the lubricant containing a carboxylic acid-based compound represented by General Formula (1) is applied to the magnetic layer 815, the protective layer 816, or the like, a lubricating action is exerted by a cohesive force between fluorine-containing hydrocarbon groups or hydrocarbon groups Rf which are hydrophobic groups. In a case where the Rf group is a fluorine-containing hydrocarbon group, the total number of carbon atoms is preferably 6 to 50, and the total number of carbon atoms of the fluorinated hydrocarbon group is preferably 4 to 20. The Rf group may be, for example, a saturated or unsaturated linear, branched, or cyclic hydrocarbon group, but may preferably be a saturated linear hydrocarbon group.

For example, in a case where the Rf group is a hydrocarbon group, the Rf group is desirably a group represented by the following General Formula (4).

### General Formula (4):

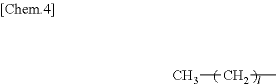

(Here, in General Formula (4), 1 is an integer selected from the range of 8 to 30, and more desirably 12 to 20.)

Furthermore, in a case where the Rf group is a fluorine-containing hydrocarbon group, the Rf group is desirably a group represented by the following General Formula (5).

### General Formula (5):

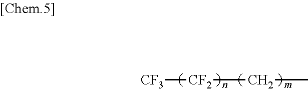

(Here, in General Formula (5), m and n are integers independently selected from the following ranges, respectively, and m=2 to 20 and n=3 to 18, and more desirably m=4 to 13 and n=3 to 10.)

The fluorinated hydrocarbon group may be concentrated at one location in the molecule as described above, or may be dispersed as in the following General Formula (6), and may be not only —CF₃ or —CF₂— but also —CHF₂, —CHF—, or the like.

### General Formula (6):

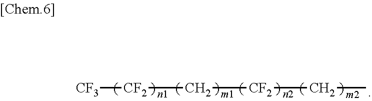

(Here, in General Formulas (5) and (6), n1+n2=n and m1+m2=m.)

The reason why the number of carbon atoms is limited as described above in General Formulas (4), (5), and (6) is that when the number of carbon atoms (1 or sum of m and n) constituting an alkyl group or a fluorine-containing alkyl group is the above lower limit or more, the length thereof becomes an appropriate length, the cohesive force between the hydrophobic groups is effectively exhibited, a preferred lubricating action is exhibited, and friction/wear durability is improved. Furthermore, when the number of carbon atoms is the upper limit described above or less, the solubility of the lubricant composed of the carboxylic acid-based compound in a solvent is kept excellent.

In particular, when the Rf group in each of General Formulas (1), (2), and (3) contains a fluorine atom, the Rf group is effective in reducing the friction coefficient, improving running performance, and the like. However, it is preferable that a hydrocarbon group is provided between the fluorine-containing hydrocarbon group and the ester bond, and hydrolysis is prevented by securing stability of the ester bond by separating the fluorine-containing hydrocarbon group and the ester bond.

Furthermore, the Rf group may have a fluoroalkyl ether group or a perfluoropolyether group.

An R group in General Formula (1) may be absent, but in some cases, a hydrocarbon chain having a relatively small number of carbon atoms is preferable.

Furthermore, the Rf group or the R group contains one or more elements selected from nitrogen, oxygen, sulfur, phosphorus, and halogen as constituent elements, and may further have a hydroxyl group, a carboxyl group, a carbonyl group, an amino group, an ester bond, and the like in addition to the functional group described above.

Specifically, the carboxylic acid-based compound represented by General Formula (1) is preferably at least one of the following compounds. That is, the lubricant preferably contains at least one of the following compounds.

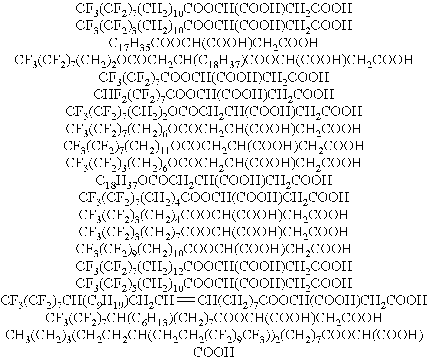

The carboxylic acid-based compound represented by General Formula (1) is soluble in a non-fluorine-based solvent having a small load on the environment, and has, for example, an advantage that operations such as coating, immersion, and spraying can be performed using a general-purpose solvent such as a hydrocarbon-based solvent, a ketone-based solvent, an alcohol-based solvent, an ester-based solvent, or the like. Specifically, examples of the general-purpose solvent can include solvents such as hexane, heptane, octane, decane, dodecane, benzene, toluene, xylene, cyclohexane, methyl ethyl ketone, methyl isobutyl ketone, methanol, ethanol, isopropanol, diethyl ether, tetrahydrofuran, dioxane, cyclohexanone, and the like.

In a case where the protective layer 816 contains a carbon material, when the carboxylic acid-based compound described above is applied as a lubricant onto the protective layer 816, two carboxyl groups and at least one ester bond group, which are polar groups of lubricant molecules, are adsorbed onto the protective layer 816, and the lubricating layer 817 having particularly excellent durability can be formed due to the cohesive force between the hydrophobic groups.

Note that the lubricant is not only held as the lubricating layer 817 on the surface of the magnetic recording medium 810 as described above, but may also be included and held in layers such as the magnetic layer 815, the protective layer 816, and the like constituting the magnetic recording medium 810.

### (Back Layer)

The description regarding the back layer 44 in the first embodiment is applied to the back layer 818.

### (3) Physical Properties and Structure

All of the descriptions regarding the physical properties and the structure described in (3) of 2 above. are also applied to the second embodiment. Therefore, the descriptions of physical properties and the structure of the magnetic recording medium of the second embodiment will be omitted.

### (4) Configuration of Sputtering Apparatus

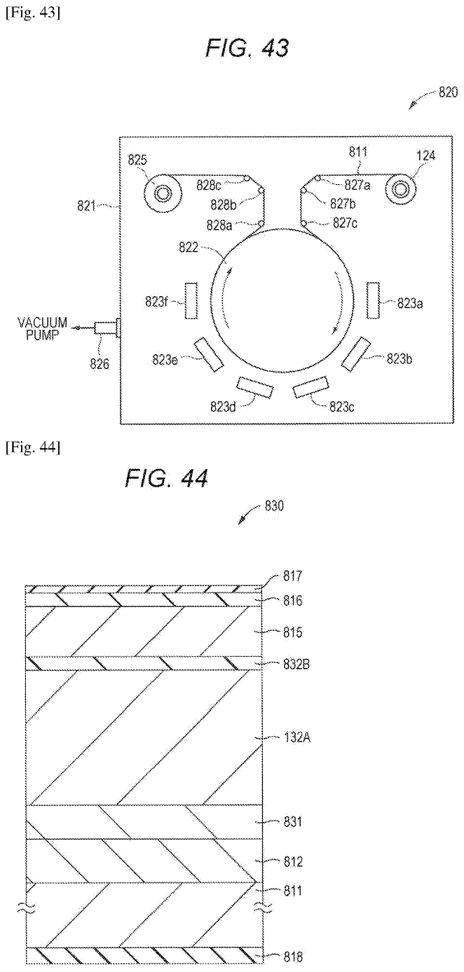

Hereinafter, an example of a configuration of a sputtering apparatus 820 used for manufacturing the magnetic recording medium 810 according to the second embodiment will be described below with reference to FIG. 43. The sputtering apparatus 820 is a continuous winding type sputtering apparatus used for forming a film of the SUL812, the first seed layer 813A, the second seed layer 813B, the first underlayer 814A, the second underlayer 814B, and the magnetic layer 815, and includes a film forming chamber 821, a drum 822 which is a metal can (rotating body), cathodes 823a to 823f, a supply reel 824, a winding reel 825, and a plurality of guide rollers 827a to 827c and 828a to 828c illustrated in FIG. 43. The sputtering apparatus 820 is, for example, a direct current (DC) magnetron sputtering system device, but the sputtering system is not limited to this system.

The film forming chamber 821 is connected to a vacuum pump (not illustrated) via an exhaust port 826, and the atmosphere in the film forming chamber 821 is set to a predetermined degree of vacuum by the vacuum pump. In the inside of the film forming chamber 821, the drum 822 having a rotatable configuration, the supply reel 824, and the winding reel 825 are disposed. The inside of the film forming chamber 821 is provided with the plurality of guide rollers 827a to 827c for guiding the transport of the base layer 811 between the supply reel 824 and the drum 822, and the plurality of guide rollers 828a to 828c for guiding the transport of the base layer 811 between the drum 822 and the winding reel 825. At the time of sputtering, the base layer 811 unwound from the supply reel 824 is wound around the winding reel 825 via the guide rollers 827a to 827c, the drum 822, and the guide rollers 828a to 828c. The drum 822 has a cylindrical shape, and the elongated base layer 811 is transported along a cylindrical circumferential surface of the drum 822. The drum 822 is provided with a cooling mechanism (not illustrated), and is cooled to, for example, about −20° C. during sputtering. In the inside of the film forming chamber 821, the plurality of cathodes 823a to 823f are arranged so as to face the circumferential surface of the drum 822. Targets are set for these cathodes 823a to 823f, respectively. Specifically, targets for forming the SUL812, the first seed layer 813A, the second seed layer 813B, the first underlayer 814A, the second underlayer 814B, and the magnetic layer 815 are set in the cathodes 823a, 823b, 823c, 823d, 823e, and 823f, respectively. These cathodes 823a to 823f simultaneously form a plurality of types of films, that is, the SUL812, the first seed layer 813A, the second seed layer 813B, the first underlayer 814A, the second underlayer 814B, and the magnetic layer 815.

In the sputtering apparatus 820 having the configuration described above, the SUL 812, the first seed layer 813A, the second seed layer 813B, the first underlayer 814A, the second underlayer 814B, and the magnetic layer 815 can be continuously formed by a roll-to-roll method.

### (5) Method of Manufacturing Magnetic Recording Medium

The magnetic recording medium 810 according to the second embodiment can be manufactured, for example, as follows.

First, the SUL812, the first seed layer 813A, the second seed layer 813B, the first underlayer 814A, the second underlayer 814B, and the magnetic layer 815 are sequentially formed on the surface of the base layer 811 using the sputtering apparatus 820 illustrated in FIG. 43. Specifically, the film is formed as follows. First, the film forming chamber 821 is evacuated until a predetermined pressure is reached. Thereafter, the targets set in the cathodes 823a to 823f are sputtered while a process gas such as an Ar gas or the like is introduced into the film forming chamber 821. Therefore, the SUL812, the first seed layer 813A, the second seed layer 813B, the first underlayer 814A, the second underlayer 814B, and the magnetic layer 815 are sequentially formed on the surface of the running base layer 811.

The atmosphere of the film forming chamber 821 during sputtering is set to, for example, about 1×10⁻⁵ Pa to 5×10⁻⁵ Pa. The film thicknesses and characteristics of the SUL812, the first seed layer 813A, the second seed layer 813B, the first underlayer 814A, the second underlayer 814B, and the magnetic layer 815 can be controlled by adjusting the tape line speed at which the base layer 811 is wound up, the pressure (sputtering gas pressure) of a process gas such as an Ar gas or the like introduced during sputtering, the input power, and the like.

Next, the protective layer 816 is formed on the magnetic layer 815. As a method of forming the protective layer 816, for example, a chemical vapor deposition (CVD) method or a physical vapor deposition (PVD) method can be used.

Next, a binder, inorganic particles, a lubricant, and the like are kneaded and dispersed in a solvent to prepare a coating material for forming a back layer. Next, the back layer 818 is deposited on the back surface of the base layer 811 by applying a coating material for deposition of the back layer on the back surface of the base layer 811 and drying the coating material.

Next, for example, a lubricant is applied onto the protective layer 816 to form the lubricating layer 817. As a method of applying the lubricant, for example, various coating methods such as gravure coating, dip coating, and the like can be used. Next, the magnetic recording medium 810 is cut into a predetermined width as needed. Therefore, the magnetic recording medium 810 illustrated in FIG. 42 can be obtained.

### (6) Modified Example

The magnetic recording medium 810 may further include an underlayer between the base layer 811 and the SUL812. Since the SUL812 has an amorphous state, it does not play a role of promoting epitaxial growth of a layer formed on the SUL812, but is required not to disturb the crystal orientation of the first and second underlayers 814A and 814B formed on the SUL812. For this reason, it is preferable that the soft magnetic material has a fine structure that does not form a column, but in a case where the influence of the release of gas such as moisture or the like from the base layer 811 is large, the soft magnetic material becomes coarse, and there is a possibility that the crystal orientation of the first and second underlayers 814A and 814B formed on the SUL812 is disturbed. In order to suppress the influence of the release of gas such as moisture or the like from the base layer 811, it is preferable to provide an underlayer containing an alloy containing Ti and Cr and having an amorphous state between the base layer 811 and the SUL812 as described above. As a specific configuration of the underlayer, a configuration similar to that of the first seed layer 813A of the second embodiment can be adopted.

The magnetic recording medium 810 may not include at least one layer of the second seed layer 813B and the second underlayer 814B. However, from the viewpoint of improving the SNR, it is more preferable to include both the second seed layer 813B and the second underlayer 814B.

The magnetic recording medium 810 may include an antiparallel coupled SUL (APC-SUL) instead of the single-layer SUL.

### 4. Third Embodiment (Example of Vacuum Thin Film Type Magnetic Recording Medium)

### (1) Configuration of Magnetic Recording Medium

As illustrated in FIG. 44, a magnetic recording medium 830 according to a third embodiment includes a base layer 811, an SUL812, a seed layer 831, a first underlayer 832A, a second underlayer 832B, and a magnetic layer 815. Note that, in the third embodiment, a portion similar to that in the second embodiment is assigned with the same reference sign and the description thereof is omitted.

The SUL812, the seed layer 831, and the first and second underlayers 832A and 832B are provided between one principal plane of the base layer 811 and the magnetic layer 815, and the SUL812, the seed layer 831, the first underlayer 832A, and the second underlayer 832B are laminated in order from the base layer 811 toward the magnetic layer 815.

### (Seed Layer)

The seed layer 831 contains Cr, Ni, and Fe and has a face-centered cubic lattice (fcc) structure, and a (111) plane of the face-centered cubic structure is preferentially oriented so as to be parallel to the surface of the base layer 811. Here, the preferential orientation means a state in which a diffraction peak intensity from the (111) plane of the face-centered cubic lattice structure is larger than diffraction peaks from other crystal planes in the θ-2θ scan of an X-ray diffraction method, or a state in which only the diffraction peak intensity from the (111) plane of the face-centered cubic lattice structure is observed in the θ-2θ scan of the X-ray diffraction method.

An intensity ratio of the X-ray diffraction of the seed layer 831 is preferably 60 cps/nm or more, more preferably 70 cps/nm or more, and still more preferably 80 cps/nm or more, from the viewpoint of improving the SNR. Here, the intensity ratio of the X-ray diffraction of the seed layer 831 is a value (I/D (cps/nm)) determined by dividing an intensity I (cps) of the X-ray diffraction of the seed layer 831 by an average thickness D (nm) of the seed layer 131.

Cr, Ni, and Fe contained in the seed layer 831 preferably have an average composition represented by the following Formula (2).

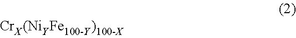

(Here, in Formula (2), X is 10≤X≤45, and Y is within a range of 60≤Y≤90.) When X is within the range described above, the (111) orientation of the face-centered cubic lattice structure of Cr, Ni, and Fe can be improved, and a more excellent SNR can be obtained. Similarly, when Y is within the range described above, the (111) orientation of the face-centered cubic lattice structure of Cr, Ni, and Fe can be improved, and a more excellent SNR can be obtained.

An average thickness of the seed layer 831 is preferably 5 nm or more and 40 nm or less. When the average thickness of the seed layer 831 is within the range, the (111) orientation of the face-centered cubic lattice structure of Cr, Ni, and Fe is improved, and a more excellent SNR can be obtained. Note that the average thickness of the seed layer 831 is determined in a manner similar to that of the magnetic layer 43 in the first embodiment. However, magnification of the TEM image is appropriately adjusted according to the thickness of the seed layer 831.

### (First and Second Underlayers)

The first underlayer 832A contains Co and O having a face-centered cubic lattice structure, and has a column (columnar crystal) structure. In the first underlayer 832A containing Co and O, an effect (function) substantially similar to that of the second underlayer 832B containing Ru can be obtained. A concentration ratio of an average atomic concentration of O to an average atomic concentration of Co ((average atomic concentration of O)/(average atomic concentration of Co)) is 1 or more. When the concentration ratio is 1 or more, the effect of providing the first underlayer 832A can be improved, and a more excellent SNR can be obtained.

The column structure is preferably inclined from the viewpoint of improving the SNR. The direction of the inclination is preferably the longitudinal direction of the elongated magnetic recording medium 830. The reason why the longitudinal direction is preferable is as follows. The magnetic recording medium 830 according to the present embodiment is a so-called magnetic recording medium for linear recording, and a recording track is parallel to the longitudinal direction of the magnetic recording medium 830. Furthermore, the magnetic recording medium 830 according to the present embodiment is also a so-called perpendicular magnetic recording medium, and from the viewpoint of recording characteristics, it is preferable that the crystal orientation axis of the magnetic layer 815 is in the vertical direction. However, there is a case where the crystal orientation axis of the magnetic layer 815 is inclined due to the influence of the inclination of the column structure of the first underlayer 832A. In the magnetic recording medium 830 for linear recording, the configuration in which the crystal orientation axis of the magnetic layer 815 is inclined in the longitudinal direction of the magnetic recording medium 830 due to the head magnetic field at the time of recording can reduce the influence on the recording characteristics due to the inclination of the crystal orientation axis as compared with the configuration in which the crystal orientation axis of the magnetic layer 815 is inclined in the width direction of the magnetic recording medium 830. In order to incline the crystal orientation axis of the magnetic layer 815 in the longitudinal direction of the magnetic recording medium 830, it is preferable to set the inclination direction of the column structure of the first underlayer 832A to the longitudinal direction of the magnetic recording medium 830 as described above.

An inclination angle of the column structure is preferably more than 0° and 60° or less.

If the inclination angle is in a range of more than 0° and 60° or less, the change in the tip shape of the column included in the first underlayer 832A is large and becomes substantially triangular, such that the effect of the granular structure is enhanced, noise is reduced, and the SNR tends to be improved. On the other hand, if the inclination angle exceeds 60°, the change in the tip shape of the column included in the first underlayer 832A is small, and the column hardly has a substantially triangular shape, such that the low noise effect tends to be weakened.

An average particle size of the column structure is 3 nm or more and 13 nm or less. If the average particle size is less than 3 nm, the average particle size of the column structure included in the magnetic layer 815 is small, and thus the ability of the current magnetic material to hold recording may be deteriorated. On the other hand, if the average particle size is 13 nm or less, noise can be suppressed, and a more excellent SNR can be obtained.

An average thickness of the first underlayer 832A is preferably 10 nm or more and 150 nm or less. If the average thickness of the first underlayer 832A is 10 nm or more, the (111) orientation of the face-centered cubic lattice structure of the first underlayer 832A can be improved, and a more excellent SNR can be obtained. On the other hand, if the average thickness of the first underlayer 832A is 150 nm or less, it is possible to suppress an increase in the particle size of the column. Therefore, the noise can be suppressed, and a more excellent SNR can be obtained. Note that the average thickness of the first underlayer 832A is determined in a manner similar to that of the magnetic layer 43 in the first embodiment. However, magnification of the TEM image is appropriately adjusted according to the thickness of the first underlayer 832A.

The second underlayer 832B preferably has a crystal structure similar to that of the magnetic layer 815. In a case where the magnetic layer 815 contains a Co-based alloy, it is preferable that the second underlayer 832B contains a material having a hexagonal close-packed (hcp) structure similar to that of the Co-based alloy, and a c-axis of the structure is oriented in a direction perpendicular to the film surface (that is, a film thickness direction). This is because the orientation of the magnetic layer 815 can be enhanced, and a lattice constant matching between the second underlayer 832B and the magnetic layer 815 can be relatively preferable. As the material having a hexagonal close-packed structure, a material containing Ru is preferably used, and specifically, Ru alone or a Ru alloy is preferable. Examples of the Ru alloy include Ru alloy oxides such as Ru—SiO₂, Ru—TiO₂, Ru—ZrO₂, and the like.

An average thickness of the second underlayer 832B may be thinner than the underlayer (for example, an underlayer containing Ru) in a general magnetic recording medium, and can be, for example, 1 nm or more and 5 nm or less. Since the seed layer 831 and the first underlayer 832A having the configuration described above are provided below the second underlayer 832B, an excellent SNR can be obtained even if the average thickness of the second underlayer 832B is thin as described above. Note that the average thickness of the second underlayer 832B is determined in a manner similar to that of the magnetic layer 43 in the first embodiment. However, magnification of the TEM image is appropriately adjusted according to the thickness of the second underlayer 832B.

### 5. Embodiment of Magnetic Recording Cartridge According to Present Technology

### (Configuration of Cartridge)

The present technology also provides a magnetic recording cartridge (also referred to as a tape cartridge) including the magnetic recording medium according to the present technology. In the magnetic recording cartridge, the magnetic recording medium may be wound around, for example, a reel. The magnetic recording cartridge may include, for example, a communication unit that communicates with a recording and reproducing apparatus, a storage unit, and a control unit that stores information received from the recording and reproducing apparatus via the communication unit in the storage unit, reads the information from the storage unit in response to a request from the recording and reproducing apparatus, and transmits the information to the recording and reproducing apparatus via the communication unit. The information may include adjustment information for adjusting a tension applied to the magnetic recording medium in the longitudinal direction.

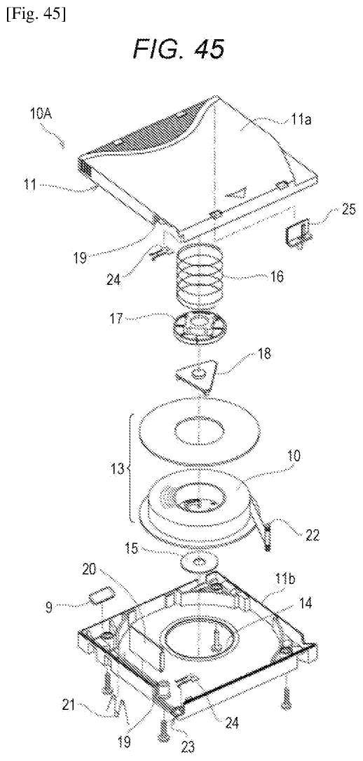

FIG. 45 is an exploded perspective view illustrating the tape cartridge 10A according to an embodiment of the present technology. In the description of the present embodiment, a tape cartridge conforming to the LTO standard will be described as an example of the tape cartridge 10A.

As illustrated in FIG. 45, the tape cartridge 10A includes a cartridge case 11, a tape reel 13, and a magnetic recording medium 10. The cartridge case 11 is configured by coupling an upper shell 11a and a lower shell 11b with a plurality of screw members. A single tape reel 13 around which the magnetic recording medium 10 is wound is rotatably accommodated inside the cartridge case 11.

A chucking gear (not illustrated) to be engaged with a spindle 31 (see FIG. 10) of the recording and reproducing apparatus 30 is annularly formed at a bottom center of the tape reel 13. The chucking gear is exposed to the outside through an opening 14 formed at the center of the lower shell 11b. An annular metal plate 15 magnetically attracted to the spindle 31 is fixed to the inner peripheral side of the chucking gear.

A reel spring 16, a reel lock member 17, and a spider 18 are disposed between an inner surface of the upper shell 11a and the tape reel 13. Therefore, a reel lock mechanism that prevents the tape reel 13 from rotating when the cartridge 10A is not in use is configured.

A tape lead-out port 19 for leading out one end of the magnetic recording medium 10 to the outside is provided in one side wall portion of the cartridge case 11. A slide door 20 for opening and closing the tape lead-out port 19 is arranged inside the side wall portion. The slide door 20 is configured to slide in a direction of opening the tape lead-out port 19 against a biasing force of a torsion spring 21 by engagement with a tape loading mechanism (not illustrated) of the recording and reproducing apparatus 30.

A reader pin 22 is fixed to one end portion of the magnetic recording medium 10. The reader pin 22 is configured to be detachable from a pin holding portion 23 provided on the inner side of the tape lead-out port 19. The pin holding portion 23 includes an elastic holding tool 24 that elastically holds an upper end portion and a lower end portion of the reader pin 22 on the upper wall inner surface (the inner surface of the upper shell 11a) and the bottom wall inner surface (the inner surface of the lower shell 11b) of the cartridge case 11, respectively.

Then, in addition to a safety tab 25 for preventing erroneous erasure of information recorded on the magnetic recording medium 10, a cartridge memory 9 capable of reading and writing contents related to data recorded on the magnetic recording medium 10 and information regarding the magnetic tape 1 in a non-contact manner is arranged inside the other side wall of the cartridge case 11.

### 6. Modified Example of Magnetic Recording Cartridge According to Present Technology

### (Configuration of Cartridge)

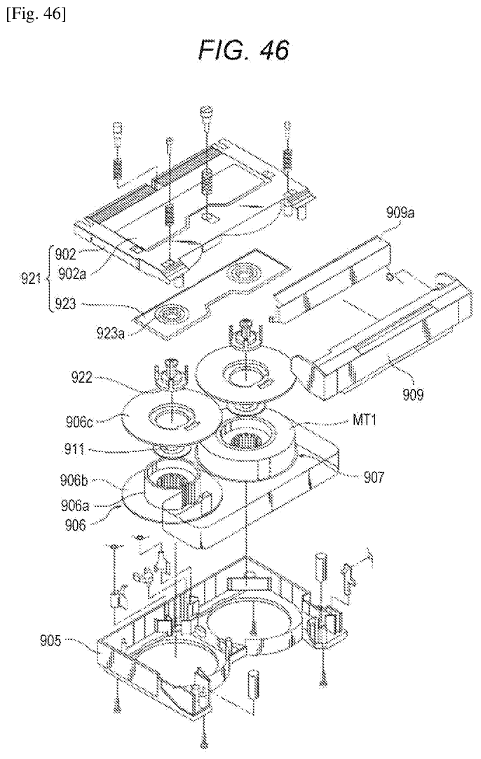

In one embodiment of the magnetic recording cartridge described above, a case where the magnetic tape cartridge is a one-reel type cartridge has been described, but the magnetic recording cartridge of the present technology may be a two-reel type cartridge. That is, the magnetic recording cartridge of the present technology may have one or a plurality of (for example, two) reels around which the magnetic tape is wound. Hereinafter, an example of the magnetic recording cartridge of the present technology having two reels will be described with reference to FIG. 46.

FIG. 46 is an exploded perspective view illustrating an example of a configuration of a two-reel type cartridge 921. The cartridge 921 includes an upper half 902 including a synthetic resin, a transparent window member 923 fitted and fixed to a window portion 902a opened in an upper surface of the upper half 902, a reel holder 922 fixed to an inner side of the upper half 902 and preventing uplift of reels 906 and 907, a lower half 905 corresponding to the upper half 902, the reels 906 and 907 stored in a space formed by combining the upper half 902 and the lower half 905, a magnetic recording medium MT1 wound around the reels 906 and 907, a front lid 909 closing a front side opening formed by combining the upper half 902 and the lower half 905, and a back lid 909A protecting the magnetic recording medium MT1 exposed at the front side opening.

The reel 906 includes a lower flange 906b having a cylindrical hub portion 906a around which the magnetic recording medium MT1 is wound in a central portion, an upper flange 906c having substantially the same size as the lower flange 906b, and a reel plate 911 interposed between the hub portion 906a and the upper flange 906c. The reel 907 has a configuration similar to that of the reel 906.

The window member 923 is provided with attachment holes 923a at positions corresponding to the reels 906 and 907, respectively, for assembling the reel holder 922 as a reel holding unit for preventing the reels from being lifted up. The magnetic recording medium MT1 is similar to the magnetic recording medium T in the first embodiment.

The present technology can also employ the following configurations.

<1>
A magnetic recording medium including a magnetic layer having a plurality of servo bands adjacent to each other in a width direction,
in which in a temperature environment of 60° C., when humidity is increased from 10% RH to 40% RH, a time until a width of the magnetic recording medium is stabilized is within 24 minutes, and
an average thickness (average total thickness) of the magnetic recording medium is 5.3 μm or less.
   <2>
   The magnetic recording medium according to [1], in which in a temperature environment of 35° C., when the humidity is increased from 10% RH to 40% RH, the time until the width of the magnetic recording medium is stabilized is within 24 minutes.
   <3>
   The magnetic recording medium according to [1] or [2], in which in a temperature environment of 10° C., when the humidity is increased from 10% RH to 40% RH, the time until the width of the magnetic recording medium is stabilized is within 24 minutes.
   <4> The magnetic recording medium according to any one of [1] to [3], in which the time until the width of the magnetic recording medium is stabilized is within 22 minutes.
   <5>
   The magnetic recording medium according to any one of [1] to [4], in which in the temperature environment of 60° C., a variation in width ΔW of the magnetic recording medium is 680 ppm or more.
   <6>
   The magnetic recording medium according to any one of [1] to [4], in which in the temperature environment of 60° C., a variation in width ΔW of the magnetic recording medium is 700 ppm or more.
   <7>
   The magnetic recording medium according to any one of [1] to [6], in which a servo pattern written in the servo band includes a plurality of stripes inclined at an azimuth angle of 5 to 20° with respect to the width direction of the magnetic recording medium.
   <8>
   The magnetic recording medium according to any one of [1] to [7], in which a data recording track width is 1,000 nm or less.
   <9>
   The magnetic recording medium according to any one of [1] to [8], in which the magnetic layer contains magnetic powder.
   <10>
   The magnetic recording medium according to any one of [1] to [8], in which the magnetic layer includes a sputtered layer.
   <11>
   A magnetic recording cartridge in which the magnetic recording medium according to any one of [1] to [10] is accommodated in a case in a state of being wound around a reel.
   <12>
   A magnetic recording medium comprising an average thickness of the magnetic recording medium t_{T} is t_{T}≤5.3 μm, and a width of the magnetic recording medium is stabilized in 24 minutes or less at a temperature of 60° C. after a change of a humidity from 10% RH to 40% RH.
   <13>
   The magnetic recording medium according to [12], in which the width of the magnetic recording medium is stabilized in 22 minutes or less after the change of the humidity from 10% RH to 40% RH.
   <14>
   The magnetic recording medium according to any one of [12] to [13], in which the width of the magnetic recording medium is stabilized in 10 minutes or less at a temperature of 35° C. after the change of the humidity from 10% RH to 40% RH.
   <15>
   The magnetic recording medium according to any one of [12] to [14], in which the width of the magnetic recording medium is stabilized in 9 minutes or less at a temperature of 10° C. after the change of the humidity from 10% RH to 40% RH.
   <16>
   The magnetic recording medium according to any one of [12] to [15], in which a change in width ΔW of the magnetic recording medium is 680 ppm or more at the temperature of 60° C.
   <17>
   The magnetic recording medium according to any one of [12] to [16], in which the change in width ΔW of the magnetic recording medium is 700 ppm or more.
   <18>
   The magnetic recording medium according to any one of [12] to [17], in which the change in width ΔW of the magnetic recording medium is 720 ppm or more.
   <19>
   The magnetic recording medium according to any one of [12] to [18], further comprising a substrate, wherein the substrate includes a polyester-based resin.
   <20>
   The magnetic recording medium according to any one of [12] to [19], in which the average thickness of the magnetic recording medium t_{T} is 4.9 μm or less.
   <21>
   The magnetic recording medium according to any one of [12] to [20], in which the average thickness of the magnetic recording medium t_{T} is 4.6 μm or less.
   <22>
   The magnetic recording medium according to any one of [12] to [21] further comprising a magnetic layer, wherein the magnetic layer includes a magnetic powder.
   <23>
   The magnetic recording medium according to any one of [12] to [22], in which the magnetic powder includes at least one of epsilon type iron oxide, gamma hematite, magnetite, chromium dioxide, cobalt-coated iron oxide, hexagonal ferrite, barium ferrite (BaFe), Co ferrite, or strontium ferrite.
   <24>
   The magnetic recording medium according to any one of [12] to [23], in which the magnetic layer includes a plurality of servo bands arranged in a width direction of the magnetic recording medium.
   <25>
   The magnetic recording medium according to any one of [12] to [24], in which the servo bands include a servo pattern, and wherein the servo pattern includes a plurality of stripes inclined at an azimuth angle with respect to the width direction.
   <26>
   The magnetic recording medium according to any one of [12] to [25], in which the azimuth angle with respect to the width direction is from 5° to 20°.
   <27>
   The magnetic recording medium according to any one of [12] to [26], in which a data recording track width of the magnetic layer is 1000 nm or less.
   <28>
   A magnetic recording cartridge comprising a magnetic recording medium, a memory, and a case that accommodates the magnetic recording medium and the memory, wherein the magnetic recording medium includes an average thickness of the magnetic recording medium t_{T} is t_{T}≤5.3 μm, and a width of the magnetic recording medium is stabilized in 24 minutes or less at a temperature of 60° C. after a change of a humidity from 10% RH to 40% RH.
   <29>
   The magnetic recording cartridge according to [28], in which the width of the magnetic recording medium is stabilized in 22 minutes or less after the change of the humidity from 10% RH to 40% RH.
   <30>
   The magnetic recording cartridge according to any one of [28] to [29], in which a change in width ΔW of the magnetic recording medium is 680 ppm or more at the temperature of 60° C.
   <31>
   The magnetic recording cartridge according to any one of [28] to [30], in which the magnetic recording cartridge conforms to a linear tape-open (LTO) standard.

### 7. Example

Hereinafter, the present technology will be described in detail with reference to Examples, but the present technology is not limited only to these Examples.

In the following Examples and Comparative Examples, the variation in width ΔW of the magnetic tape, the time until the width is stabilized (tape following time), the thickness t_{T} of the magnetic tape, the thickness of the non-magnetic layer (underlayer), the thickness of the base layer, the thickness of the back layer, and the thickness tₘ of the magnetic layer are the values determined by the measurement methods described in the first embodiment. Note that the variation in servo track width is a value determined by the following method.

### (Variation in Servo Track Width)

A method of measuring the variation in servo track width will be described. The variation in servo track width is measured in an environment of a temperature of 25° C.±3° C. and a humidity of 50%±5%. When measuring the variation in servo track width, the servo band pitch of the data band 0 is measured by the recording and reproducing apparatus 30.

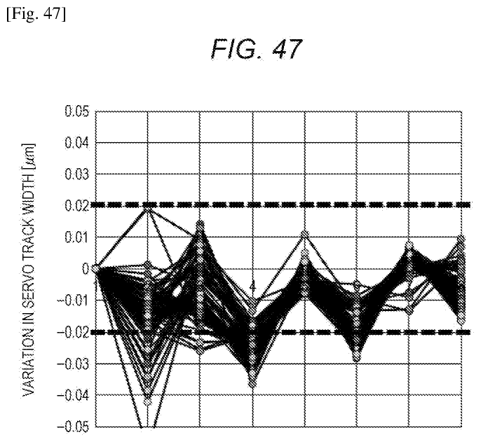

As described in (5) of 2. above, in the method of measuring the variation in servo track width using the recording and reproducing apparatus 30, the magnetic recording medium 10 is caused to run by the recording and reproducing apparatus 30, the servo trace line T on each servo band of the two servo read heads 132 is measured, and the servo band pitch is measured from the relative position of each measured servo trace line T with respect to the servo pattern 6. A difference between the servo band pitch of the entire length of the magnetic recording medium 10 at the time of the first running and the servo band pitch of the entire length at the time of running 7 round trips is determined, and a maximum value thereof is set as a variation in servo track width. FIG. 47 is a view illustrating a variation in servo track width of the magnetic recording medium according to the present technology in which in a temperature environment of 60° C., when humidity is increased from 10% RH % RH to 40% RH % RH, a time until a width of the magnetic recording medium is stabilized is within 24 minutes.

### Example 1

### (Step of Preparing Magnetic Layer Forming Coating Material)

A magnetic layer forming coating material was prepared as follows. First, a first composition having the following formulation was kneaded with an extruder. Next, the kneaded first composition and a second composition having the following formulation were added to a stirring tank equipped with a disperser and premixing was performed. Subsequently, dyno mill mixing was further performed and filter treatment was performed to prepare the magnetic layer forming coating material.

### (First Composition)

Barium ferrite (BaFe₁₂O₁₉) magnetic powder (hexagonal plate shape, average aspect ratio 2.9, average particle volume: 1,400 nm³): 100 parts by mass

Vinyl chloride resin (cyclohexanone solution 30 mass %): 30 parts by mass

(degree of polymerization 300, number average molecular weight Mn=10,000, containing OSO₃K=0.07 mmol/g, and secondary OH=0.3 mmol/g as a polar group)

Polyurethane resin (resin solution: blending amount of polyurethane resin: 30 mass %, blending amount of cyclohexanone: 70 mass %): 22 parts by mass

(polyurethane resin: number average molecular weight Mn=25,000, Tg 110° C.)

Aluminum oxide powder: 4 parts by mass

(α-Al₂O₃, average particle size 0.1 μm)

### (Second Composition)

Carbon black: 3.0 parts by mass

(manufactured by Tokai Carbon Co., Ltd., trade name: SEAST S, arithmetic average particle size 70 nm)

Polyurethane resin (resin solution: blending amount of polyurethane resin: 30 mass %, blending amount of cyclohexanone: 70 mass %): 6.5 parts by mass

(polyurethane resin: number average molecular weight Mn=25,000, Tg 110° C.)

n-Butyl stearate: 2 parts by mass

Methyl ethyl ketone: 121.0 parts by mass

Toluene: 121.0 parts by mass

Cyclohexanone: 116.0 parts by mass

Finally, 3.0 parts by mass of polyisocyanate (trade name: Coronate L, manufactured by Nippon Polyurethane Industry Co., Ltd.) as a curing agent and 2 parts by mass of stearic acid were added to the magnetic layer forming coating material prepared as described above.

### (Step of Preparing Underlayer Forming Coating Material)

An underlayer forming coating material was prepared as follows. First, a third composition having the following formulation was kneaded with an extruder. Next, the kneaded third composition and a fourth composition having the following formulation were added to a stirring tank equipped with a disperser and premixing was performed. Subsequently, dyno mill mixing was further performed and filter treatment was performed to prepare the underlayer forming coating material.

### (Third Composition)

Acicular iron oxide powder: 100 parts by mass
(α-Fe₂O₃, average long axis length 0.11 μm)
Vinyl chloride resin (cyclohexanone solution 30 mass %): 60 parts by mass
(degree of polymerization 300, number average molecular weight Mn=10,000, containing OSO³K=0.07 mmol/g, and secondary OH=0.3 mmol/g as a polar group)
Aluminum oxide powder: 3 parts by mass
(α-Al₂O₃, average particle size 0.1 μm)

### (Fourth Composition)

Carbon black: 30 parts by mass

(manufactured by Asahi Carbon Co., Ltd., trade name: #80)

Polyurethane resin (resin solution: blending amount of polyurethane resin: 30 mass %, blending amount of cyclohexanone: 70 mass %): 55 parts by mass

(polyurethane resin: number average molecular weight Mn=25,000, Tg 70° C.)

n-Butyl stearate: 2.5 parts by mass

Methyl ethyl ketone: 108.2 parts by mass

Toluene: 108.2 parts by mass

Cyclohexanone: 100.0 parts by mass

Finally, 3.5 parts by mass of polyisocyanate (trade name: Coronate L, manufactured by Tosoh Corporation) as a curing agent and 2.0 parts by mass of stearic acid were added to the underlayer forming coating material prepared as described above.

### (Step of Preparing Back Layer Forming Coating Material)

A back layer forming coating material was prepared as follows. The following raw materials were mixed in a stirring tank equipped with a disperser and subjected to filter treatment to prepare the back layer forming coating material.

Carbon black (manufactured by Asahi Carbon Co., Ltd., trade name: #80): 100 parts by mass

Polyester polyurethane: 160 parts by mass

(resin solution: blending amount of polyurethane resin: 30 mass %, blending amount of cyclohexanone: 70 mass %)

(manufactured by Nippon Polyurethane Industry Co., Ltd., trade name: N-2304)

Methyl ethyl ketone: 500 parts by mass

Toluene: 400 parts by mass

Cyclohexanone: 100 parts by mass

Polyisocyanate (trade name: Coronate L, manufactured by Tosoh Corporation): 10 parts by mass

### (Film Forming Step)

A magnetic tape was prepared as described below using the coating material prepared as described above.

First, as a support to be a base layer of a magnetic tape, a polyethylene terephthalate film (hereinafter, referred to as a PET film.) (base film) having an elongated shape and an average thickness of 4.0 μm was prepared. Next, the underlayer forming coating material was applied onto one principal plane of the PET film and the underlayer forming coating material was dried, thereby forming an underlayer on one principal plane of the PET film so that an average thickness thereof when a final product was obtained was 0.75 μm. Next, the magnetic layer forming coating material was applied onto the underlayer and the magnetic layer forming coating material was dried, thereby forming a magnetic layer on the underlayer so that an average thickness thereof when a final product was obtained was 60 nm.

Subsequently, the back layer forming coating material was applied onto the other principal plane of the PET film on which the underlayer and the magnetic layer were formed, and the back layer forming coating material was dried, thereby forming a back layer so that an average thickness thereof when a final product was obtained was 0.35 μm. Then, the PET film on which the underlayer, the magnetic layer, and the back layer were formed was subjected to a curing treatment at 60° C. Thereafter, an annealing treatment was performed at 70° C. for 20 hours, and a calendering treatment was performed to smooth the surface of the magnetic layer.

### (Cutting Step)

The magnetic tape obtained as described above was cut into a width of ½ inch (12.65 mm). Therefore, a magnetic tape having an elongated shape was obtained. In the obtained magnetic tape, a time until a width of the magnetic tape at a temperature of 60° C. was stabilized was 24 minutes, a variation in width ΔW at 60° C. was 750 ppm, a variation in servo track width was 0.016 μm, and an average thickness t_{T} of the magnetic tape was 5.2 μm.

The magnetic tape having a width of ½ inches was wound around a reel provided in a cartridge case to obtain a magnetic recording cartridge. A servo pattern was recorded on the magnetic tape. Rows of V-shaped servo frames were included in the servo pattern, and the servo frames were recorded in advance in two or more rows in parallel in the longitudinal direction at known intervals. In an environment of 25° C.±3° C. and 50% RH % RH±5%, in a state where the magnetic tape was wound around the magnetic recording cartridge at a tension of 0.55 N, the servo band pitch was measured while the magnetic tape accommodated in the magnetic recording cartridge was caused to run so as to be wound around the recording and reproducing apparatus (so-called running in the forward direction). The magnetic tape runs by the recording and reproducing apparatus, each of the servo trace lines on each servo band of the two servo read heads is measured, and the servo band pitch is measured from the relative position of each measured servo trace line to the servo pattern. A difference between the servo band pitch of the entire length of the magnetic tape at the time of the first running and the servo band pitch of the entire length at the time of running 7 round trips was determined, and a maximum value thereof was set as a variation in servo track width.

### Example 2

A magnetic tape was obtained in the same manner as that of Example 1, except that a PEN film having an average thickness of 4.0 μm was used as a base layer in Example 1. A time until a width of the magnetic tape at a temperature of 60° C. was stabilized was 24 minutes, a variation in width ΔW at 60° C. was 780 ppm, a variation in servo track width was 0.015 μm, and an average thickness t_{T} of the magnetic tape was 5.2 μm.

### Example 3

A magnetic tape was obtained in the same manner as in Example 1, except that an annealing treatment was performed at 60° C. for 20 hours before cutting, and a strain relaxation treatment was further performed in a cartridge state at 40° C. for 30 hours in Example 1. A time until a width of the magnetic tape at a temperature of 60° C. was stabilized was 22 minutes, a variation in width ΔW at 60° C. was 730 ppm, a variation in servo track width was 0.012 μm, and an average thickness t_{T} of the magnetic tape was 5.2 μm.

### Example 4

A magnetic tape was obtained in the same manner as in Example 1, except that a PEN film having an average thickness of 4.0 μm was used as a base layer, and a strain relaxation treatment was further performed in a cartridge state at 40° C. for 30 hours in Example 1. A time until a width of the magnetic tape at a temperature of 60° C. was stabilized was 21 minutes, a variation in width ΔW at 60° C. was 760 ppm, a variation in servo track width was 0.011 μm, and an average thickness t_{T} of the magnetic tape was 5.2 μm.

### Example 5

A magnetic tape was obtained in the same manner as in Example 1, except that a PEN film having an average thickness of 4.0 μm was used as a base layer, an annealing treatment at 70° C. for 20 hours was not performed before cutting, and a strain relaxation treatment was further performed in a cartridge state at 40° C. for 30 hours in Example 1. A time until a width of the magnetic tape at a temperature of 60° C. was stabilized was 24 minutes, a variation in width ΔW at 60° C. was 780 ppm, a variation in servo track width was 0.016 μm, and an average thickness t_{T} of the magnetic tape was 5.2 μm.

### Comparative Example 1

A magnetic tape was obtained in the same manner as that of Example 1, except that an annealing treatment was performed at 60° C. for 15 hours before cutting in Example 1. A time until a width of the magnetic tape at a temperature of 60° C. was stabilized was 25 minutes, a variation in width ΔW at 60° C. was 760 ppm, a variation in servo track width was 0.021 μm, and an average thickness t_{T} of the magnetic tape was 5.2 μm.

### Comparative Example 2

A magnetic tape was obtained in the same manner as in Example 1, except that a usual curing treatment was not performed, an annealing treatment at 70° C. for 20 hours was not performed before cutting, and a strain relaxation treatment was performed in a cartridge state at 40° C. for 10 hours in Example 1. A time until a width of the magnetic tape at a temperature of 60° C. was stabilized was 25 minutes, a variation in width ΔW at 60° C. was 755 ppm, a variation in servo track width was 0.023 μm, and an average thickness t_{T} of the magnetic tape was 5.2 μm.

### Comparative Example 3

A magnetic tape was obtained in the same manner as in Example 1, except that a PEN film having an average thickness of 4.0 μm was used as a base layer, a usual curing treatment was not performed, an annealing treatment at 70° C. for 20 hours was not performed before cutting, and a strain relaxation treatment was further performed in a cartridge state at 40° C. for 10 hours in Example 1. A time until a width of the magnetic tape at a temperature of 60° C. was stabilized was 25 minutes, a variation in width ΔW at 60° C. was 755 ppm, a variation in servo track width was 0.023 μm, and an average thickness t_{T} of the magnetic tape was 5.2 μm.

### Comparative Example 4

A magnetic tape was obtained in the same manner as that of Example 1, except that only a usual curing treatment was performed, and an annealing treatment at 70° C. for 20 hours was not performed before cutting in Example 1. A time until a width of the magnetic tape at a temperature of 60° C. was stabilized was 26 minutes, a variation in width ΔW at 60° C. was 750 ppm, a variation in servo track width was 0.041 μm, and an average thickness t_{T} of the magnetic tape was 5.2 μm.

### Comparative Example 5

A magnetic tape was obtained in the same manner as that of Example 1, except that a PEN film having an average thickness of 4.0 μm was used as a base layer, only a usual curing treatment was performed, and an annealing treatment at 70° C. for 20 hours was not performed before cutting in Example 1. A time until a width of the magnetic tape at a temperature of 60° C. was stabilized was 27 minutes, a variation in width ΔW at 60° C. was 820 ppm, a variation in servo track width was 0.042 μm, and an average thickness t_{T} of the magnetic tape was 5.2 μm.

Table 1 shows the configurations and the evaluation results of the magnetic tapes of Examples 1 to 5 and Comparative Examples 1 to 5.

TABLE 1

| | | | | | | Characteristics | | | | |
|---|---|---|---|---|---|---|---|---|---|---|
| | | | | | | Variation | | | | |
| | Magnetic | | Base | Back | | in width | | | | |
| | layer | Underlayer | Layer | layer | Total | ΔW at | Time until width is stabilized (min) | | | Variation in |
| | Thickness | Thickness | Thickness | Thickness | thickness | 60° C. | Temperature | Temperature | Temperature | servo track |
| | (nm) | (μm) | (μm) | (μm) | (μm) | (ppm) | 10° C. | 35° C. | 60° C. | width (μm) |
| Example 1 | 60 | 0.75 | 4.00 | 0.35 | 5.2 | 750 | 8 | 9 | 24 | 0.016 |
| Example 2 | 60 | 0.75 | 4.00 | 0.35 | 5.2 | 780 | 7 | 8 | 24 | 0.015 |
| Example 3 | 60 | 0.75 | 4.00 | 0.35 | 5.2 | 730 | 8 | 8 | 22 | 0.012 |
| Example 4 | 60 | 0.75 | 3.60 | 0.35 | 5.2 | 760 | 7 | 8 | 21 | 0.011 |
| Example 5 | 60 | 0.75 | 3.60 | 0.35 | 5.2 | 780 | 8 | 9 | 24 | 0.016 |
| Comparative | 60 | 0.75 | 3.60 | 0.35 | 5.2 | 760 | 9 | 10 | 25 | 0.021 |
| Example 1 | | | | | | | | | | |
| Comparative | 60 | 0.75 | 4.00 | 0.35 | 5.2 | 755 | 7 | 8 | 25 | 0.023 |
| Example 2 | | | | | | | | | | |
| Comparative | 60 | 0.75 | 4.00 | 0.35 | 5.2 | 800 | 11 | 12 | 26 | 0.039 |
| Example 3 | | | | | | | | | | |
| Comparative | 60 | 0.75 | 4.00 | 0.35 | 5.2 | 750 | 11 | 12 | 26 | 0.041 |
| Example 4 | | | | | | | | | | |
| Comparative | 60 | 0.75 | 4.00 | 0.35 | 5.2 | 820 | 12 | 12 | 27 | 0.042 |
| Example 5 | | | | | | | | | | |

Note that each symbol in Table 1 means the following measured value.
t_{T}: thickness of magnetic tape (unit: μm)
tₘ: average thickness of magnetic layer (unit: nm)
t_{b}: average thickness of back layer (unit: μm)

The following can be seen from the results shown in Table 1.

In each of the magnetic tapes of Examples 1 to 5, when the humidity was increased from 10% RH % RH to 40% RH % RH in a temperature environment of 60° C., the time until the width of the magnetic tape was stabilized was within 25 minutes, the variation in servo track width was 0.02 μm or less in a short time, the tension was not changed, the width was stabilized, and the width could be determined.

Although the embodiments and the Examples of the present technology are specifically described above, the present technology is not limited to the embodiments and Examples described above and various modifications based on the technical idea of the present technology may be made.

For example, configurations, methods, steps, shapes, materials, numerical values, and the like described in the embodiments and Examples described above are merely examples, and different configurations, methods, steps, shapes, materials, numerical values, and the like may be used as needed. Furthermore, the chemical formulae of compounds and the like are representative and are not limited to the listed valences and the like as long as they are common names of the same compound.

Furthermore, the configurations, methods, steps, shapes, materials, numerical values, and the like of the embodiments and Examples described above can be combined with each other without departing from the gist of the present technology.

Furthermore, in the present specification, a numerical value range indicated by using “to” indicates a range including numerical values described before and after “to” as the minimum value and the maximum value, respectively. In the numerical value range described in stages in the present specification, an upper limit value or a lower limit value of a numerical value range of a certain stage may be replaced with the upper limit value or the lower limit value of the numerical value range of another stage. The materials exemplified in the present specification may be used alone or in combination of two or more thereof unless otherwise specified.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

10 Magnetic recording medium
41 Base layer
42 Underlayer
43 Magnetic layer
44 Back layer

1. A magnetic recording medium comprising:
an average thickness of the magnetic recording medium t_{T} is t_{T}≤5.3 μm, and
a width of the magnetic recording medium is stabilized in 24 minutes or less at a temperature of 60° C. after a change of a humidity from 10% RH to 40% RH.

2. The magnetic recording medium according to claim 1, wherein the width of the magnetic recording medium is stabilized in 22 minutes or less after the change of the humidity from 10% RH to 40% RH.

3. The magnetic recording medium according to claim 1, wherein the width of the magnetic recording medium is stabilized in 10 minutes or less at a temperature of 35° C. after the change of the humidity from 10% RH to 40% RH.

4. The magnetic recording medium according to claim 1, wherein the width of the magnetic recording medium is stabilized in 9 minutes or less at a temperature of 10° C. after the change of the humidity from 10% RH to 40% RH.

5. The magnetic recording medium according to claim 1, wherein a change in width ΔW of the magnetic recording medium is 680 ppm or more at the temperature of 60° C.

6. The magnetic recording medium according to claim 5, wherein the change in width ΔW of the magnetic recording medium is 700 ppm or more.

7. The magnetic recording medium according to claim 6, wherein the change in width ΔW of the magnetic recording medium is 720 ppm or more.

8. The magnetic recording medium according to claim 1 further comprising a substrate, wherein the substrate includes a polyester-based resin.

9. The magnetic recording medium according to claim 1, wherein the average thickness of the magnetic recording medium t_{T} is 4.9 μm or less.

10. The magnetic recording medium according to claim 9, wherein the average thickness of the magnetic recording medium t_{T} is 4.6 μm or less.

11. The magnetic recording medium according to claim 1 further comprising a magnetic layer, wherein the magnetic layer includes a magnetic powder.

12. The magnetic recording medium according to claim 11, wherein the magnetic powder includes at least one of epsilon type iron oxide, gamma hematite, magnetite, chromium dioxide, cobalt-coated iron oxide, hexagonal ferrite, barium ferrite (BaFe), Co ferrite, or strontium ferrite.

13. The magnetic recording medium according to claim 11, wherein the magnetic layer includes a plurality of servo bands arranged in a width direction of the magnetic recording medium.

14. The magnetic recording medium according to claim 13, wherein the servo bands include a servo pattern, and wherein the servo pattern includes a plurality of stripes inclined at an azimuth angle with respect to the width direction.

15. The magnetic recording medium according to claim 14, wherein the azimuth angle with respect to the width direction is from 5° to 20°.

16. The magnetic recording medium according to claim 11, wherein a data recording track width of the magnetic layer is 1000 nm or less.

17. A magnetic recording cartridge comprising:
a magnetic recording medium,
a memory, and
a case that accommodates the magnetic recording medium and the memory, wherein
the magnetic recording medium includes:
an average thickness of the magnetic recording medium t_{T} is t_{T}≤5.3 μm, and
a width of the magnetic recording medium is stabilized in 24 minutes or less at a temperature of 60° C. after a change of a humidity from 10% RH to 40% RH.

18. The magnetic recording cartridge according to claim 17, wherein the width of the magnetic recording medium is stabilized in 22 minutes or less after the change of the humidity from 10% RH to 40% RH.

19. The magnetic recording cartridge according to claim 17, wherein a change in width ΔW of the magnetic recording medium is 680 ppm or more at the temperature of 60° C.

20. The magnetic recording cartridge according to claim 17, wherein the magnetic recording cartridge conforms to a linear tape-open (LTO) standard.
